(19) United States
(12) Patent Application Publication
(10) Pub. No.: US 2004/0260709 A1
(43) Pub. Date: Dec. 23, 2004

(54) Merge information provider

(76) Inventors: Yohichiroh Matsuno, Kanagawa (JP); Katsumi Kanasaki, Tokyo (JP); Hiroyasu Kurose, Tokyo (JP); Futoshi Oseto, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/763,182

(22) Filed: Jan. 26, 2004

(30) Foreign Application Priority Data
Jan. 27, 2003 (JP) 2003-017922
Jan. 27, 2003 (JP) 2003-017923
Jan. 19, 2004 (JP) 2004-011068
Jan. 19, 2004 (JP) 2004-011069

(51) Int. Cl. G06F 7/00

(52) U.S. Cl. 707/100

(57) ABSTRACT

A merge information providing apparatus has a merge user information providing function, the merge user information providing function includes plural user information providing functions providing information regarding a user as subordinate user information providing functions, wherein the merge information providing apparatus acquires the information regarding the user from the user information providing function and provides the acquired information regarding the user with merging.

### BACKGROUND OF THE INVENTION

The present invention generally relates to merge information providers and more particularly to a merge information providing apparatus, an information providing apparatus, a managing apparatus, a merge information providing method, an information providing method, a managing method, a merge information providing program, an information providing program, a managing program and a recording medium storing such a merge information providing program, information providing program or managing program.

First, explanation will be made on a conventional example of certifying a user by utilizing an authentication provider and allowing the user to use a service provided by application software with reference to FIG. 1, wherein it should be noted that FIG. 1 is a diagram for explaining such an example of conducting authentication of a user and allowing the user to use a service provided by application software.

The system of FIG. 1 is formed of a Web browser 1, a Web portal 2, an application 3 and an authentication directory provider 4.

Here, the Web browser 1 is the software that browses the Web pages.

The Web portal 2 is a Web site providing entrance of the Internet, and provides various Web services that can be used from the Web browser 1.

The application 3 is one of the services provided by the Web portal 2 to the Web browser 1.

The authentication directory provider 4 is a provider providing authentication of registered users and provides information, and the like, of the group to which the user belongs.

In a step S1, the Web browser 1 transmits the log-in name and the password input by the user to the Web portal 2.

After the step S1, the process proceeds to a next step S2, and the Web portal 2 transmits an issue request of an authentication ticket, which contains the log-in name and password received in the step S1, to the authentication directory provider 4 as will be explained later.

In the authentication directory provider 4, examination is made whether or not the received log-in name and password agree with the correct combination of log-in name and password of the registered user based on the log-in name and password contained in the received issue request of authentication ticket, and in the case it is determined that the combination is correct, an authentication ticket certifying this is issued.

After the step S2, the process proceeds to a next step S3, and the authentication directory provider 4 transmits an issue response of authentication ticket including the ID of the issued authentication ticket to the Web portal 2.

After the step S3, the process proceeds to a next step S4, and the Web portal 2 transmits the information indicating success of authentication to the Web browser 1.

After the step S4, the process proceeds to a next step S5, and the Web browser 1 notifies that the user is going to use the resource provided by the application 3 to the Web portal 2.

After the step S5, the process proceeds to a next step S6, and the Web portal 2 transmits the issue request of a session ticket that includes the ID of the authentication ticket acquired in the step S3 to the application 3 for getting permission to use the service.

After the step S6, the process proceeds to a next step S7, and the application 3 transmits an ID confirmation request including the ID of the above-mentioned authentication ticket to the directory provider 4 for the purpose of confirming that the issue request for the session ticket comes from a valid user permitted to use the application.

After the step S7, the process proceeds to a next step S8, and the authentication directory provider 4 determines whether or not the ID of the given authentication ticket is the ID of a valid authentication ticket. In the case it was determined that the ID is the one of a valid authentication ticket, the authentication directory provider 4 transmits the ID confirmation response including the information of the user to whom the authentication ticket has been issued to the application 3.

After the step S8, the process proceeds to a next step S9, and the application 3 issues the session ticket when it is judged that the issue request of the session ticket acquired in the step S6 is the request from the valid user permitted to use the application, based on the information of the user acquired in step S8. Thereby, an issue response of the session ticket containing the ID of the session ticket is transmitted to the Web portal 2.

After the step S9, the process proceeds to a next step S10, and the Web portal 2 notifies to the Web browser 1 that the application of the service has been permitted.

After the step S10, the process proceeds to a next step S11, and the Web browser 1 notifies to the Web portal 2 that the service provided by the application 3 is going to be used.

After the step S11, the process proceeds to a next step S12, and the Web portal 2 transmits an application request of the service including the ID of the session ticket acquired in the step S9 to the application 3.

After the step S12, the process proceeds to a next step S13, and the application 3 determines the validity of the ID of the session ticket contained in the application request of the service. In the event it is determined that the ID is the ID of a valid session ticket, the application 3 transmits the designated service to the Web portal 2.

After the step S13, the process proceeds to a next step S14, and the Web portal 2 provides the service received in the step S13 to the Web browser 1.

As explained with reference to FIG. 1, the authentication directory provider 4 issues the authentication ticket that certifies the registered user based on the user name and password in the issue request for the authentication ticket received from the Web portal 2 and transmits the issue response of the authentication ticket containing the ID of the authentication ticket to the Web portal 2. Further, the authentication directory provider 4 transmits the confirmation response of the ID of the authentication ticket containing the information of the user to the application 3 based on the ID of the authentication ticket included in the confirmation request of the ID of the authentication ticket received from the application 3.

Generally the Web portal 2 provides plural Web services and thus supports plural applications and plural authentication providers certifying the user of the plural applications.

FIG. 2 is a diagram explaining an example that one Web portal supports plural applications and plural authentication directory providers.

The system of FIG. 2 is formed of a Web browser 1, a Web portal 2, a Windows (trade mark) application 5, a Notes (trade mark) application 6, a Windows (trade mark) authentication directory provider 7, and a Notes (trade mark) authentication directory provider 8.

In FIG. 2, it can be seen that there exist, contrary to FIG. 1, plural applications provided by the Web portal 2 and plural authentication providers for authentication of the user of the applications.

By adopting the construction shown in FIG. 2, a user is certified as the user of Windows (trade mark) in the Windows (trade mark) authentication directory provider 7 upon inputting of the user name and password registered in the Windows (trade mark) authentication directory provider 7 to the Web browser 1, and the user can use the Windows (trade mark) application 5.

Also, when the user inputs the user name and password of the user that is registered in Notes (trade mark) authentication directory provider 8 to the Web browser 1, the user is certified as the user of Notes (trade mark) in the Notes (trade mark) authentication directory provider 8, and the user can use the Notes (trade mark) application 6.

However, in the construction shown in FIG. 2, it has been necessary to develop an access module 101 accessing the Windows (trade mark) authentication directory provider 7 and an access module 102 accessing the Notes (trade mark) authentication directory provider 8 separately for the Web portal 2, and there has been a problem of poor efficiency.

To solve this problem, the construction as shown in FIG. 3 is conceivable.

FIG. 3 is a diagram explaining an example of integrating the access modules of a Web portal to a single module.

The system of FIG. 3 is formed of a Web browser 1, a Web portal 2, a Windows (trade mark) application 5, a Notes (trade mark) application 6, a Windows (trade mark) authentication directory provider 7, a Notes (trade mark) authentication directory provider 8, and a provider 9.

In FIG. 3, it can be seen that the provider 9 is provided in addition to the construction of FIG. 2 for integrating the access modules of the Web portal 2 into a single module 10.

The provider 9 transmits the user name and the password acquired through the Web browser 1 and the Web portal 2 to the Windows (trade mark) authentication directory provider 7 and also to the Notes (trade mark) authentication directory provider 8 and requests the issuance of authentication ticket to each of the providers 7 and 8.

The Provider 9 transmits the ID of the authentication ticket to the Web portal 2 in the case the issue response of the authentication ticket including the ID of the authentication ticket is received from any of the providers.

By using the construction as shown in FIG. 3, it is possible to integrate the access modules access of the Web portal 2 into the single module 10.

However, in the construction shown in FIG. 3, there arises a problem, when a new application is added to the Web portal 2, that it is necessary to distinguish the Windows (trade mark) user registered in the Windows (trade mark) authentication directory provider 7 from the Notes (trade mark) user registered in the Notes (trade mark) authentication directory provider 8 in the application thus added newly.

The example of adding a new application to the construction of FIG. 3 will be explained with reference to FIG. 4.

FIG. 4 is a diagram for explaining an example of adding a new application to the construction of FIG. 3.

The system of FIG. 4 is constructed by the Web browser 1, the Web portal 2, the Windows (trade mark) authentication directory provider 7, the Notes (trade mark) authentication directory provider 8, the provider 9, and an application 11.

In FIG. 4, it can be seen that an application 11 is added newly to the Web portal 2 in the construction of FIG. 3 in place of the Windows (trade mark) application 5 and the Notes (trade mark) application 6.

In such a construction, there arises a problem, in the case the application 11 has authorized both of the Windows (trade mark) user certified by the Windows (trade mark) authentication directory provider 7 and the Notes (trade mark) user certified by the Notes (trade mark) authentication directory provider 8, that the application 11 has to manage the two users by registering the respective user IDs for distinguishing the respective users, and managing becomes complicated.

Consider an example that the user of Notes (trade mark) and the user of Windows (trade mark) are the same person.

In such a case, there has been a problem that it is necessary to manage the user ID of the user using Windows (trade mark) and the user ID of the user using Notes (trade mark) separately in the application 11, even when the user is using the same user ID for Notes (trade mark) and for Windows (trade mark).

On the other hand, it is also conceivable to introduce a Local authentication directory provider 12 in addition to the Windows (trade mark) authentication directory provider 7 and the Notes (trade mark) authentication directory provider 8.

FIG. 5 is a diagram for explaining the example of introducing such a Local authentication directory provider.

The system of FIG. 5 is formed of the Web browser 1, the Web portal 2, the Windows (trade mark) authentication directory provider 7, the Notes (trade mark) authentication directory provider 8, the provider 9, the application 11 and a Local authentication directory provider 12.

As for FIG. 5, it can be seen that the Local authentication directory provider 12 is introduced additionally to the construction of FIG. 4.

As shown in FIG. 5, users Kana, Kurose, Maeda, Aitoh, Ikegami, Rdhguest, are registered in the Windows (trade mark) authentication directory provider 7, while the users Kana, Kurose, Maeda, Aitoh, Ikegami are registered in the Notes (trade mark) authentication directory provider 8.

Further, the users Kana, Kurose, Maeda and also group1 and group2 are registered in the newly introduced Local authentication directory provider 12.

Hereinafter, an example of the group members registered in the Local authentication directory provider 12 shown in FIG. 5 will be explained with reference to FIG. 6.

FIG. 6 is a diagram explaining the example of group members registered in the Local authentication directory provider 12 shown in FIG. 5.

As shown in FIG. 6, the Local authentication directory provider 12 of FIG. 5 holds the users and groups inside the provider as the group members.

However, even in the case such a Local provider 12 is introduced for holding the users and groups inside the provider as the group members, there has been a problem in that the application 11 of FIG. 5 has to manage the users, groups, and the like of the Local provider 12 and further the users and the groups of other providers separately.

Further, in the system explained with reference to the conventional example, there arises a problem, when a user has requested authentication by inputting the log-in name and password through the Web browser 1, in that the user information of the user registered to a provider other than the provider in which the authentication has been made and/or the group information to which the user belongs, cannot be acquired.

FIG. 7 is a diagram for explaining the problem of such a conventional provider.

Consider the case in which authentication of a user has been made for the Windows (trade mark) authentication directory provider 7. It can be seen that, while the information of the user Kana or the information of the group to which Kana belongs and registered in the Windows (trade mark) authentication directory provider 7 may be acquired, the information of the user kana or the information of the group to which Kana belongs and registered in the Notes (trade mark) authentication directory provider 8 is not accessible.

Also, in the conventional example, explanation has been made about the authentication directory provider in which both of the authentication and providing of user information of a user and/or the group information of the group to which the user belongs are conducted by the providers of Windows (trade mark), Notes (trade mark) and Local connected to the provider 9.

However, even in the case these providers are the directory provider that provides the user information of a user and/or the group information to of the groups which the user belongs, there has been a problem in that the user information of a user and/or the group information of the user registered to a directory provider other than the permitted directory provider cannot be acquired based on the log-in name and password input by the user, similarly to the case noted above.

Also, in the conventional example, if the authentication made with the Windows (trade mark) authentication directory provider 7, the user is certified as the user of Windows (trade mark), if the authentication is made with the Notes (trade mark) authentication directory provider 8, the user is certified as the user of Notes (trade mark), and if the authentication is made with the Local authentication directory provider 12, the user is certified as the user of Local. Thus, there has been a problem in that the user is distinguished depending on the authentication directory provider used for user authentication even when the user is the same.

Also, while explanation has been made in the conventional example about the authentication directory provider in which both the authentication and provision of user information of a user and/or the group information to which the user belongs by the providers of Windows (trade mark) and Notes (trade mark) and Local connected in provider 9, there has been a problem in that the user information of the same user and/or the group information to which that user belongs and registered to a directory provider other than the permitted directory provider is inaccessible based on the log-in name and password input by the user, even when these providers are the directory provider which provides user information and/or the group information to which the user belongs.

### SUMMARY OF THE INVENTION

Accordingly, it is a general object of the present invention to provide a novel and useful merge information providing apparatus, information providing apparatus, managing apparatus, merge information providing method, information providing method, managing method, merge information providing program, information providing program, managing program and also recording medium storing such a program wherein the foregoing problems are eliminated.

Another and more specific object of the present invention is to provide a merge information providing apparatus, information providing apparatus, managing apparatus, merge information providing method, information providing method, managing method, merge information providing program, information providing program, managing program and also a recording medium, capable of acquiring not only the user information of a user and/or the group information of the groups to which the user belongs and registered to the provider that has been certified or the use thereof is permitted but also the user information of the user and/or the group information of the groups to which the user belongs and registered to other, different providers.

Another object of the present invention is to provide a merge information providing apparatus having merge user information providing means, said merge user information providing means comprising plural user information providing means providing information regarding a user as subordinate user information providing means, said merge information providing apparatus acquiring information regarding said user from said user information providing means and providing said acquired information regarding to said user with merging.

According to the present invention, it becomes possible to acquire the user information and/or the group information of the group to which the user belongs and registered to the provider not only from the provider of which use is permitted but also from other providers.

Another object of the present invention is to provide a merge information providing apparatus having merge user information providing means, said merge user information providing means comprising plural user information providing means providing information regarding said user and also an authentication service regarding said user, wherein the merge information providing apparatus acquires information regarding said user from said user information providing means and providing said acquired information regarding said user with merging.

According to the present invention, it becomes possible to acquire the user information of the user and/or the group information of the group to which the user belongs not only from the certified provider but also form other providers.

Another object of the present invention is to provide an information providing apparatus having user information providing means providing information regarding a user, said user information providing means providing, in response to a request from a merge provider comprising said user information providing means and other user information providing means as subordinate user information providing means, the information regarding a designated user to said merge user information providing means.

According to the present invention, it becomes possible to provide the information of the designated user and/or the group information of the group to which the designated user belongs.

Another object of the present invention is to provide an information providing apparatus having user information providing means providing information regarding a user and an authentication service regarding the user, said user information providing means comprising user information providing means for providing the information of a designated user in response to a request from a merge user information providing means comprising said user information providing means and other user information providing means to said merge user information providing means.

According to the present invention, it becomes possible to provide the information of the designated user and/or the group information of the group to which the designated user belongs.

Also, the present invention has the feature of providing setup request transmission means for transmitting a request for setting the subordinate user information providing means to the merge information providing apparatus.

According to a preferred embodiment of the present invention, it becomes possible to change or add the setting of the subordinate user information providing means, by providing the setup request transmission means that transmits the request for setting up the subordinate user information providing means to the merge information providing apparatus.

Also the present invention provides a merge information providing method, an information providing method, a managing method, a merge information providing program, an information providing program, a managing program and also a recording medium corresponding to the above-mentioned information providing apparatus.

For example, the first use permission information corresponds to the session ticket 300 of the sub-provider 14 to be described later or a session ticket ID310 of the session ticket 300.

Further, the second use permission information corresponds for example to a session ticket 200 of the Union merging provider 13 to be described later or a session ticket ID210 of session ticket 200.

Further, the first authentication information may corresponds to an authentication ticket 600 of the sub-provider 14 to be described later or an authentication ticket ID610 of the authentication ticket 600.

Further, the second authentication information corresponds to an authentication ticket 500 of the Union merge provider 13 to be described later or an authentication ticket ID510 of the authentication ticket 500.

Further, the user distinction information corresponds to UID to be described later.

Another object of the present invention is to provide a merge information providing apparatus having merge user information providing means, said merge user information providing means comprising plural user information providing means providing information regarding a user as subordinate user information providing means, wherein said merge information providing apparatus acquires the information regarding a user registered to the user information providing means of which use is permitted and also the information of the same user registered to other user information providing means without distinguishing the user by whether or not the user of the user information providing means is permitted, and provides the information thus acquired with merging.

According to the present invention, it becomes possible to acquire the user information of the same user or the group information to which the user belongs without distinguishing the user by the sub provider of which use is permitted, for example from the sub providers different from the sub provider of which use is permitted.

Another object of the present invention is to provide a merge information providing apparatus having merge information providing means, said merge information providing means comprising a plurality of user information providing means providing information regarding a user and also an authentication service of the user, wherein the merge information providing apparatus acquires the information of the user from the user information providing means in which the user is permitted and/or authentication is made and also the information for the same user registered to other user information providing means without distinguishing the user by whether or not the use of the user information providing means is permitted or the authentication is made, and provide the information thus acquired with merging.

According to the present invention, it becomes possible to acquire the user information of a particular user and or group information of the group to which that user belongs not only from the sub provider of which user is permitted or authentication is made but also from other sub providers.

Another object of the present invention is to provide a merge user information providing means having merge user information providing means, said merge user information providing means comprising a main user information providing means and sub provider information provider means for providing information regarding to a user and also an authentication service for the user,

wherein the merge user information providing means acquires the information of the user registered to the user information providing means of which use is permitted and/or the authentication is made and also the information of the same user registered to other sub providers, without distinguishing the user by whether or not the use of the user information providing means is permitted or the authentication is made, and provides the information regarding the user thus acquired with merging.

According to the present invention, acquires the information of the user registered to the user information providing means of which use is permitted and/or the authentication is made and also the information of the same user registered to other sub providers, without distinguishing the user by whether or not the use of the user information providing means is permitted or the authentication is made.

Another object of the present invention is to provide an information providing apparatus having user information providing means for providing information regarding a user, said user information providing means providing, in response to a request from merge user information providing means comprising said user information providing means and other user information providing means as subordinate user information providing means, the information regarding the user corresponding to distinction information distinguishing the user registered to that user information providing means and/or other user information providing means, to said merge user information providing means.

According to the present invention, it becomes possible to provide the information regarding to the user corresponding to the distinction information to the merge user information providing means upon request.

Another object of the present invention is to provide an information providing apparatus having user information providing means providing information regarding a user and also the authentication service regarding to said user, wherein said user information providing means provides, in respons4e to a request from a merge user information providing means comprising said user information providing means and other user information providing means as subordinate user information providing means, the information of the user corresponding to distinction information distinguishing the user registered to that user information providing means or other user information providing means, to the merge user information providing means.

According to the present invention, it becomes possible to provide the information regarding the user corresponding to the distinction information upon request.

In a preferred embodiment of the present invention, there is provided setup request transmission means transmitting the request regarding the setup of the subordinate user information providing means to the merge information providing apparatus. With this, it becomes possible to add or change the setting of the subordinate user information providing means.

For example, the use permission information corresponds to a session ticket 300 or a session ticket ID310 of the session ticket 300 in a sub provider 14 to be described later.

For example, the first authentication information corresponds to an authentication ticket 600 in the main or sub provider or an authentication ticket ID610 of the authentication ticket 600 as will be described later.

Further, the second authentication information may correspond to an authentication ticket 500 of a Join merging provider 13 or an authentication ticket ID510 of the authentication ticket 500 as will be describe later.

Further, the present invention can be implemented in the form of a merge information providing method, an information providing method, a managing method, a merge information providing program, an information providing program, a managing program and also a recording medium storing such a program.

### BRIEF DESCRIPTION OF THE DRAWINGS

FIG. 1 is a diagram explaining an example of using a service provided by an application by conducting authentication of the user by utilizing an authentication provider;

FIG. 2 is a diagram for explaining an example in which a single Web portal supports plural applications and plural authentication directory providers;

FIG. 3 is a diagram explaining an example of integrating access modules of a Web portal into a single module;

FIG. 4 is a diagram for explaining an example of adding a new application to the construction of FIG. 3;

FIG. 5 is a diagram explaining an example of introducing a Local authentication directory provider;

FIG. 6 is a diagram showing an example of the members of a group registered in the Local authentication directory provider 12 shown in FIG. 5;

FIG. 7 is a diagram explaining the problem of a conventional provider;

FIG. 8 is a diagram explaining an example of introducing a Union merge provider according to the present invention;

FIG. 9 is a diagram explaining an example of the members of the group of the Local authentication directory provider shown in FIG. 8;

FIGS. 10A and 10B are diagrams explaining the structure of a user ID of the Local authentication directory provider shown in FIG. 8;

FIG. 11 is a diagram showing the construction a fusion machine according to an embodiment of the present invention;

FIG. 12 is a diagram showing the hardware construction of the fusion machine according to an embodiment of the present invention;

FIG. 13 is a diagram for explaining the construction of a UCS;

FIG. 14 is another diagram for explaining the construction of UCS;

FIG. 15 is another diagram for explaining the construction of the UCS;

FIG. 16 is a functional block diagram of the Union merge provider and the sub provider according to a first embodiment of the present invention;

FIG. 17 is a concept diagram showing the structure of the session ticket of the Union merge provider;

FIGS. 18A and 18B are diagrams explaining an example of modification of the data of directory operation wrapper;

FIG. 19 is a flowchart showing an example of acquisition processing of a group to which the user belongs conducted in a Union merge provider;

FIG. 20 is a flowchart showing an example of the acquisition process of a group to which the user belongs conducted in a sub provider;

FIG. 21 is a diagram showing an example of the XML message the group acquisition request transmitted from a client to the Union merge provider;

FIGS. 22A-22C are diagrams showing examples of the XML message of a group acquisition request transmitted from the Union merge provider to a sub provider;

FIGS. 23A-23C are diagrams showing an example of the XML message of a group acquisition response transmitted to the Union merge provider from the sub provider;

FIG. 24 is a diagram showing an example of the XML message of a group acquisition response transmitted from the Union merge provider to the client;

FIG. 25 is a functional block diagram of a Union merge provider and a sub provider according to a second embodiment of the present invention;

FIG. 26 is a concept diagram for explaining the structure of an authentication ticket of a Union merge provider;

FIG. 27 is a flowchart showing an example of issuing the authentication ticket in the Union merge provider;

FIG. 28 is a flowchart showing an example of issuing the authentication ticket in the sub provider;

FIG. 29 is a diagram showing an example of the XML message of an authentication ticket issue request transmitted from a client to the Union merge provider;

FIG. 30 is a diagram showing an example of the XML message of an authentication ticket issue request transmitted from the Union merge provider to the sub provider;

FIG. 31 is a diagram showing an example of the XML message of an authentication ticket issue response transmitted to the Union merge provider from the sub provider;

FIG. 32 is a diagram showing an example of the XML message of an authentication ticket issue response transmitted from the Union merge provider to the client;

FIG. 33 is a flowchart showing an example of the authentication ticket ID confirmation process conducted in the Union merge provider;

FIG. 34 is a flowchart showing an example of the authentication ticket ID confirmation process conducted in the sub provider;

FIG. 35 is a diagram showing an example of the XML message of an authentication ticket ID confirmation request transmitted from the client to the Union merge provider;

FIG. 36 is a diagram showing an example of the XML message of an authentication ticket ID confirmation request transmitted from the Union merge provider to the sub provider;

FIG. 37 is a diagram showing an example of the XML message of an authentication ticket ID confirmation response transmitted to the Union merge provider from the sub provider;

FIG. 38 is a diagram showing an example of the XML message of an authentication ticket ID confirmation response transmitted from the Union merge provider to the client;

FIG. 39 is a diagram showing an example of acquiring a document stored in a repository service by conducting the authentication of a user by utilizing the Union merge provider;

FIG. 40 is a diagram for explaining an example of integrating Union merge providers existing in plural numbers;

FIG. 41 is another diagram for explaining the construction of an UCS;

FIG. 42 is a diagram for explaining an the example of the sequence for acquiring a provider list;

FIG. 43 is a diagram showing an example of the XML message of the provider list acquisition request transmitted from the client to the dispatcher;

FIG. 44 is a diagram showing an example of the XML message of a provider list acquisition response transmitted from the dispatcher to the client;

FIG. 45 is a diagram for explaining an example of the sequence for adding a sub provider;

FIG. 46 is a diagram showing an example of the XML message of a sub provider addition request transmitted from the client to the dispatcher;

FIG. 47 is a diagram showing an example of the XML message of a sub provider addition response transmitted from the dispatcher to the client;

FIG. 48 is a diagram showing the hardware construction of a client;

FIG. 49 is a functional block diagram of the client;

FIGS. 50A-50C are diagrams showing an example of the GUI for setting the provider in the client;

FIG. 51 is another diagram showing an example of the GUI for setting the provider in the client;

FIG. 52 is another diagram showing an example of the GUI for setting of the provider in the client;

FIG. 53 is another diagram showing an example of the GUI for setting of the provider in the client;

FIG. 54 is a diagram explaining an example of remote provider;

FIG. 55 is a diagram explaining an example of the processing of a remote provider;

FIG. 56 is a diagram showing an example of introducing a join merge provider according to the present invention;

FIG. 57 is a diagram for explaining an example of the group members registered to the Local authentication directory provider shown in FIG. 56;

FIGS. 58A and 58B are diagrams for explaining an example of the structure of the user ID of the Local authentication directory provider shown in FIG. 56;

FIG. 59 is a diagram showing the construction of a fusion machine according to an embodiment of the present invention;

FIG. 60 is a diagram showing the hardware construction of the fusion machine according to an embodiment of the present invention;

FIG. 61 is a diagram for explaining the construction of an UCS;

FIG. 62 is another diagram for explaining the construction of an UCS;

FIG. 63 is another diagram for explaining the construction of an UCS;

FIG. 64 is a functional block diagram of a join merge provider and a sub provider according to a third embodiment of the present invention;

FIG. 65 is a concept diagram explaining the structure of the session ticket of the join merge provider;

FIGS. 66A and 66B are diagrams for explaining an example of modification of the data of the directory operation wrapper;

FIG. 67 is a flowchart of an example of the group acquisition process conducted in the join merge provider;

FIG. 68 is a flowchart showing an example of the group acquisition process conducted in the sub provider;

FIG. 69 is a diagram showing an example of the XML message of a group acquisition request transmitted from the client to the join merge provider;

FIGS. 70A-70C are diagrams showing examples of the XML message of a group acquisition request transmitted to the Local directory provider, which is one of the sub providers, from the join merge provider;

FIG. 71A-71C are diagrams showing examples of the XML message of a group acquisition request transmitted to the WinNT4 directory provider, which is one of the sub providers, from the join merge provider;

FIGS. 72A-72C are diagrams showing examples of the XML message of a group acquisition request transmitted to the Notes (trade mark) R5 directory provider, which is one of the sub providers, from the join merge provider;

FIGS. 73A-73C are diagrams showing examples of the XML message of a group acquisition response transmitted to the join merge provider from the Local directory provider, which is one of the sub providers;

FIGS. 74A-74C are diagrams showing examples of the XML message of a group acquisition response transmitted to the join merge provider from the WinNT4 directory provider, which is one of the sub providers;

FIGS. 75A-75C are diagrams showing examples of the XML message of a group acquisition response transmitted to the join merge provider from the Notes (trade mark) R5 directory provider, which is one of the sub providers;

FIG. 76 is a diagram showing an example of the XML message of a group acquisition response transmitted from the join merge provider to the client;

FIG. 77 is a functional block diagram of the join merge provider and the sub provider according to a fourth embodiment of the present invention;

FIG. 78 is a concept diagram for explaining the structure of an authentication ticket of the join merge provider;

FIG. 79 is a concept diagram showing the data managed in the integrated directory;

FIG. 80 is a flowchart showing an example of authentication ticket issue process conducted in the join merge provider;

FIG. 81 is a flowchart showing an example of authentication ticket issue process in the sub provider;

FIG. 82 is a flowchart showing an example of the authentication ticket ID confirmation process in the sub provider;

FIG. 83 is a diagram showing an example of the XML message of an authentication ticket issue request transmitted from the client to the join merge provider;

FIG. 84 is a diagram showing an example of the XML message of an authentication ticket issue request transmitted from the join merge provider to the sub provider;

FIG. 85 is a diagram showing an example of the XML message of an authentication ticket issue response transmitted to the join merge provider from the sub-sub provider;

FIG. 86 is a diagram showing an example of the XML message of an authentication ticket ID confirmation request transmitted from the join merge provider to the sub-sub provider;

FIG. 87 is a diagram showing an example of the XML message of an authentication ticket ID confirmation response transmitted to the join merge provider from the sub-sub provider;

FIG. 88 is a diagram showing an example of the XML message of an authentication ticket issue request transmitted from a join merge provider to the main sub provider;

FIG. 89 is a diagram showing an example of the XML message of an authentication ticket issue response transmitted to the join merge provider from the main sub provider;

FIG. 90 is a diagram showing an example of the XML message of an authentication ticket issue response transmitted from the join merge provider to the client;

FIG. 91 is a flowchart showing an example of the authentication ticket ID confirmation process in the join merge provider;

FIG. 92 is a diagram showing an example of the XML message of an authentication ticket ID confirmation request transmitted from the client to the join merge provider;

FIG. 93 is a diagram showing an example of the XML message of an authentication ticket ID confirmation request from the join merge provider to the main sub provider;

FIG. 94 is a diagram showing an example of the XML message of an authentication ticket ID confirmation response transmitted to the join merge provider from the main sub provider;

FIG. 95 is a diagram showing an example of the XML message of an authentication ticket ID confirmation response from the join merge provider to the client;

FIG. 96 is another concept diagram of data managed in the integrated directory;

FIG. 97 is a diagram for explaining an example of conducting authentication of the user by reading an IC card by utilizing the join merge provider and acquiring a document accumulated in the repository service;

FIG. 98 is another diagram for explaining the construction of the UCS;

FIG. 99 is a diagram for explaining an example of the provider list acquisition sequence;

FIG. 100 is a diagram showing an example of the XML message of a provider list acquisition request from the client to dispatcher;

FIG. 101 is a diagram showing an example of the XML message of a provider list acquisition response from the dispatcher to the client;

FIG. 102 is a diagram for explaining an example of the sub provider addition sequence;

FIG. 103 is a diagram showing an example of the XML message of a sub provider addition request from the client to the dispatcher;

FIG. 104 is a diagram showing an example of the XML message of a sub provider addition response from the dispatcher to the client;

FIG. 105 is a diagram showing an example of the hardware construction of the client;

FIG. 106 is a functional block diagram of the client;

FIGS. 107A-107C are diagrams showing an example of the GUI for setting provider in the client;

FIG. 108 is a diagram showing an example of the GUI for setting provider in the client;

FIG. 109 is a diagram showing an example of the GUI for setting provider in the client;

FIG. 110 is a diagram showing an example of the GUI for setting provider in the client;

FIG. 111 is a diagram explaining an the example of the remote provider;

FIG. 112 is a diagram for explaining an example of the process regarding the remote provider.

FIG. 113 is a diagram for explaining the construction of the UCS;

FIG. 114 is a diagram explaining an example of the property addition sequence;

FIG. 115 is a diagram explaining an example of the property acquisition sequence;

FIG. 116 is a diagram showing an example of the property acquisition request;

FIG. 117 is a diagram showing an example of the property acquisition response;

FIG. 118 is a diagram explaining an example of the property updating sequence;

FIG. 119 is a diagram explaining an example of the property elimination sequence;

FIGS. 120A and 120B are diagrams showing examples of GUI in the client for the case in which the idJoin merge provider is applied to a fusion machine.

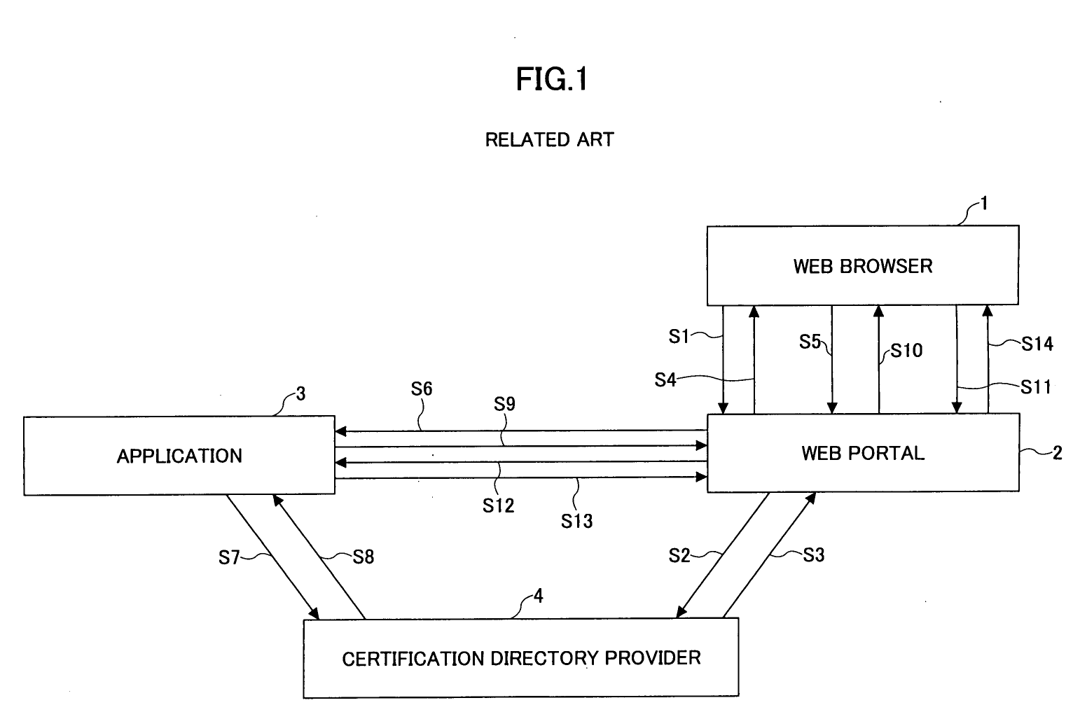

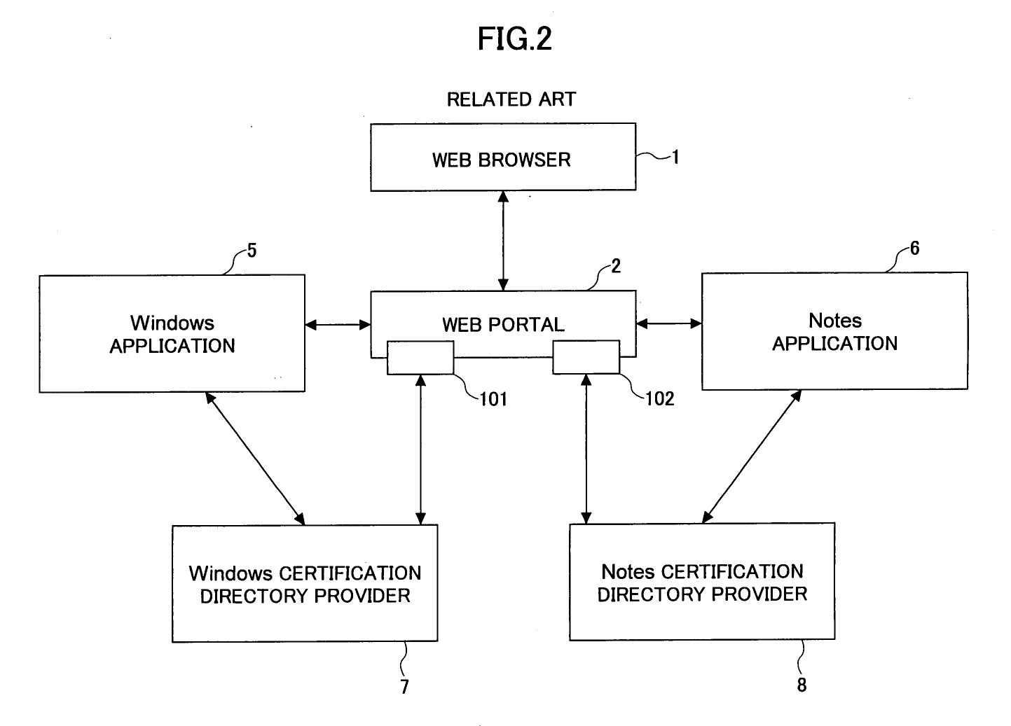

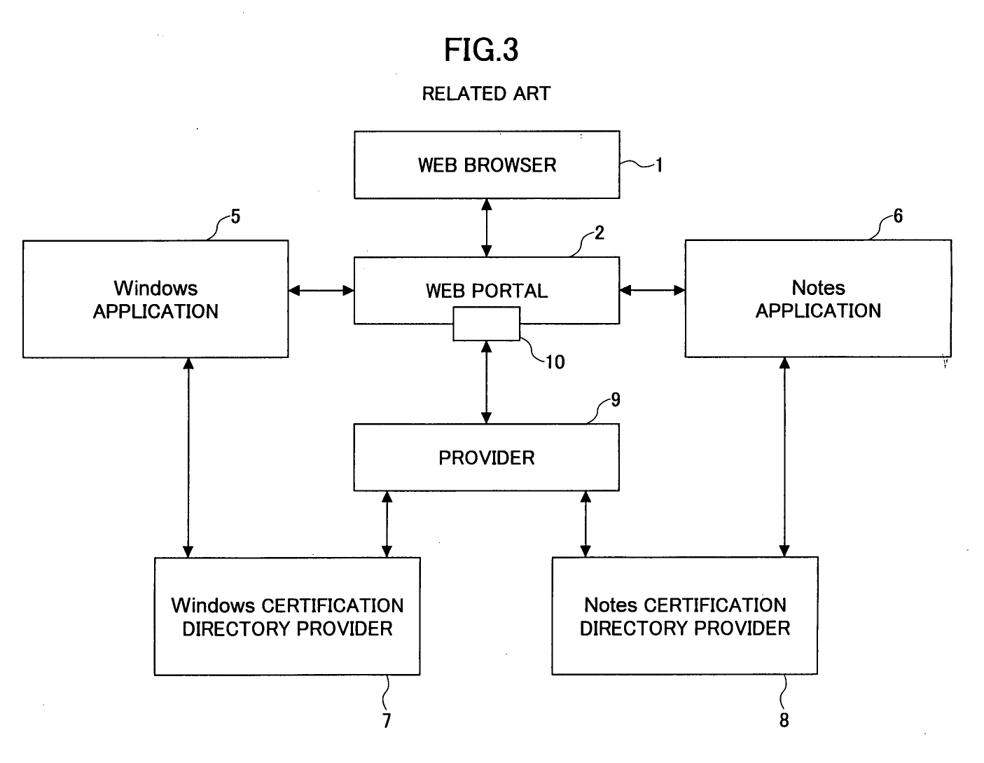

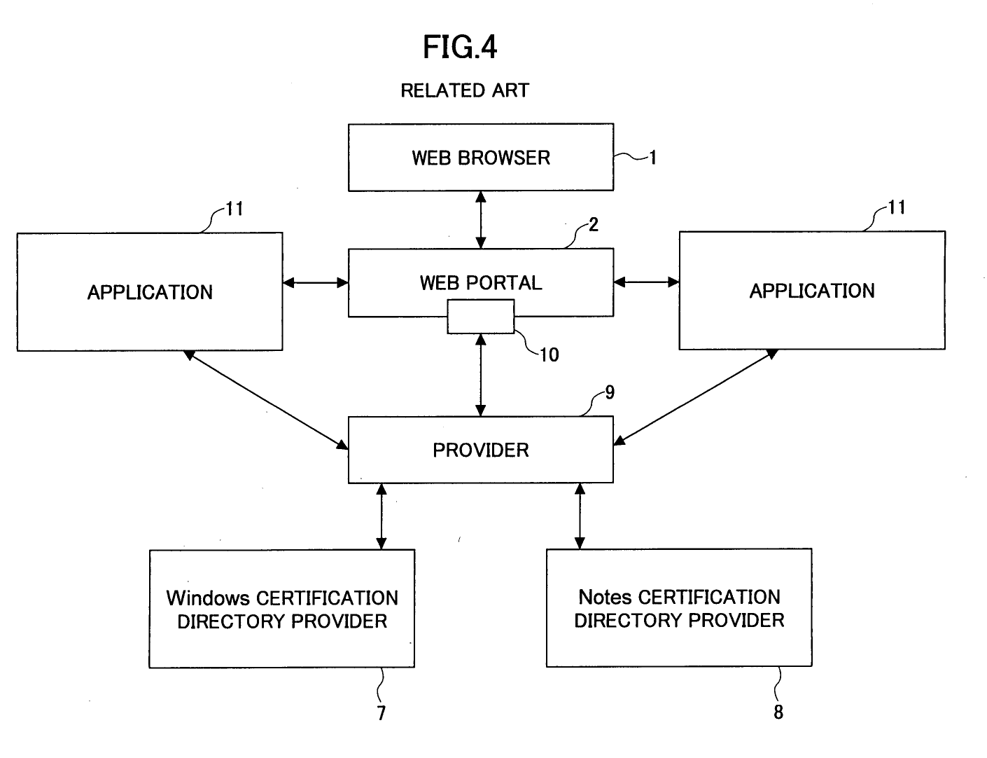

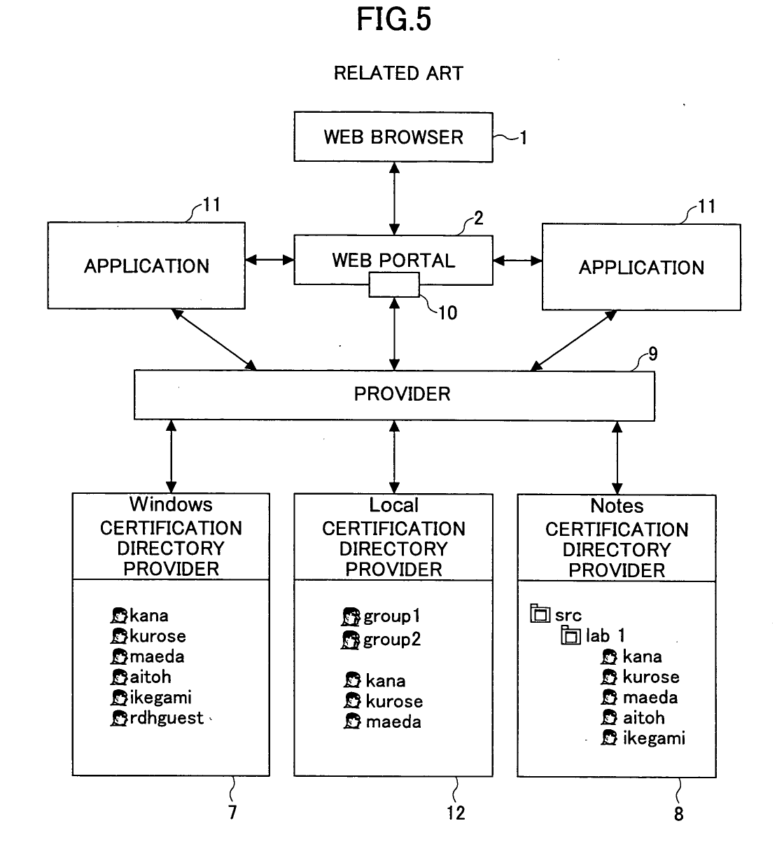

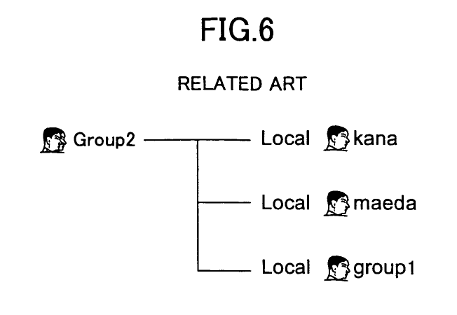

### DETAILED DESCRIPTION OF THE PREFERRED EMBODIMENTS

[First Embodiment]

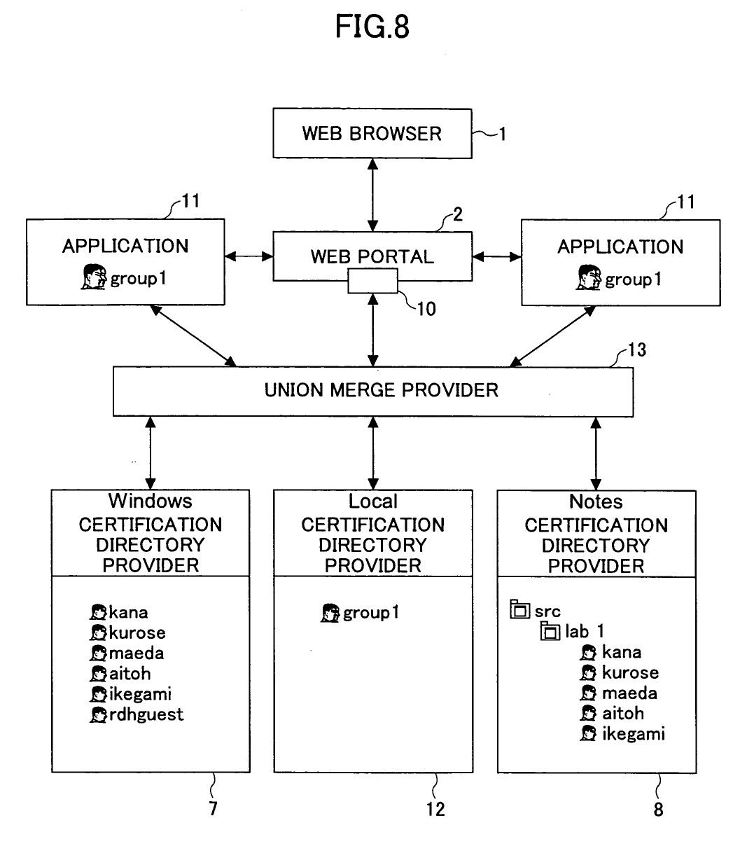

FIG. 8 is a diagram for explaining an example of introducing a Union merge provider according to the present invention.

The system of FIG. 8 includes the Web browser 1, the Web portal 2, the Windows (trade mark) authentication directory provider 7, the Notes (trade mark) authentication directory provider 8, the application 11, the Local authentication directory provider 12, and further a Union merge provider 13.

Thus, in FIG. 8, it can be seen that the Union merge provider 13 is introduced newly in place of the provider 9 explained with reference to FIG. 5 in relation to the conventional technology.

The Union merge provider 13 of the present invention can acquire the user information of a user and/or the group information to which the user belongs and registered even from a sub provider different from the sub provider of which use is permitted based on the log-in name and password input by the user as will be explained later, provided that the provider to be managed (referred to below as sub provider) is the provider providing the registered user information of a user and/or the group information to which the user belongs.

Further, the Union merge provider 13 can acquire the user information of a user and/or the group information of the group to which the user belongs and registered to a sub provider other than the sub provider of which use is certified based on the log-in name and password input by the user also in the case the connected sub provider is a provider that provides the registered user information of a user and/or the group information of the group to which the user belongs and simultaneously a provider providing the authentication service regarding the users.

In the example of FIG. 8, the sub provider may be any of the Windows (trade mark) authentication directory provider 7, the Local authentication directory provider 12, or the Notes (trade mark) authentication directory provider 8.

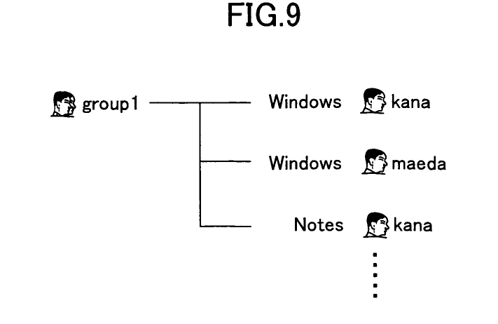

Hereinafter, explanation will be made on the example of group members registered in the Local authentication directory provider 12 shown in FIG. 8 with reference to FIG. 9, wherein FIG. 9 is a diagram for explaining the example of the group members registered to the Local authentication directory provider shown in FIG. 8.

As shown in FIG. 9, the Local authentication directory provider 12 of FIG. 8 holds the users and the groups of other providers as the member of the group of Local authentication directory provider 12.

Thus, the group 1 of the Local authentication directory provider 12 shown in FIG. 8 has the user Kana of the Windows (trade mark) authentication directory provider 7, the user Maeda of the Windows (trade mark) authentication directory provider 7 and the user Kana of the Notes (trade mark) authentication directory provider 8, as the members.

Also, the Local authentication directory provider 12 shown in FIG. 8 holds the user information, and the like, of other providers, in the form of user ID.

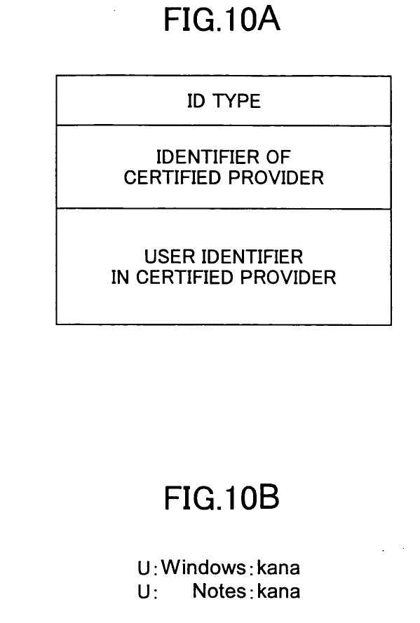

Hereinafter, an example of the structure of the user ID of the Local authentication directory provider 12 shown in FIG. 8 will be explained with reference to FIG. 10, wherein FIG. 10 is a diagram for explaining the example of the structure of the user ID of the Local authentication directory provider shown in FIG. 8.

As shown in FIG. 10A, the user ID of the Local authentication directory provider 12 of FIG. 8 contains the ID type, the identifier of the provider that has made the authentication, and the identifier of the user in the provider that has made the authentication.

For example, the ID type represents whether it is the user or the group, while the identifier of the provider has made the authentication represents whether it is a Windows (trade mark) provider or a Notes (trade mark) provider, or the like. Further, the identifier of the user in the provider that has made the authentication represents individual users such as Kana, Kurose, Maeda, and the like.

FIG. 10B is an example of the user ID of FIG. 10A.

Referring to FIG. 10B, the Local authentication directory provider 12 can register the users of the Windows (trade mark) authentication directory provider 7 and the users of the Notes (trade mark) authentication directory provider 8 in the distinguished state by holding the user ID shown in FIG. 10B.

By introducing the Local provider 12 holding the user ID as such, the application 11 of FIG. 8 can integrate the users without managing the users of different providers separately, by using the user ID of the Local provider 12.

Therefore, the user can use the application 11 irrespective of whether the user is certified by the Windows (trade mark) authentication directory provider 7 or by the Notes (trade mark) authentication directory provider 8.

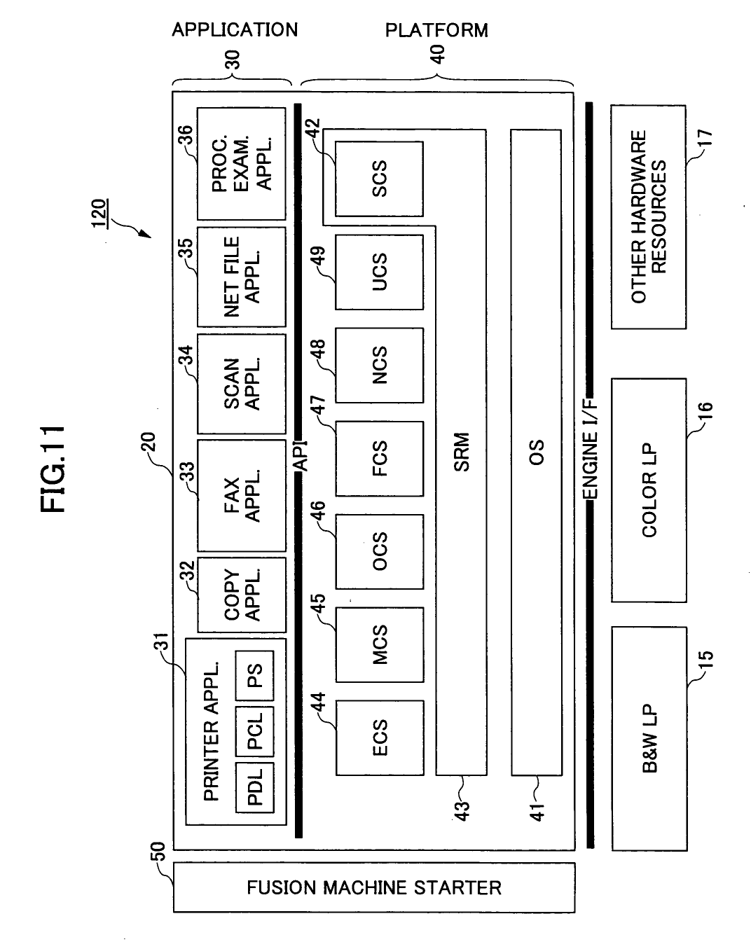

Hereinafter, an example of the apparatus mounted with the Union merge provider 13 and/or the sub providers shown in FIG. 8 will be explained with reference to FIG. 11.

FIG. 11 shows the construction of a fusion machine 120 according to an embodiment of the present invention.

Referring to FIG. 11, the fusion machine 120 includes a black-and-white line printer 15 and a color line printer 16, a hardware resource 17 such as a scanner and facsimile, a software group 20, and a fusion machine starter 50. The software group 20 is formed of an application 30 and a platform 40.

The platform 40 is constructed so as to include a control service that interprets a process request from the application 30 and issues an acquisition request of hardware resources, a system resource manager 43 (referred to hereinafter as with SRM) arbitrating the acquisition requests from the control services by managing one or more hardware resources, and an operating system 41 (referred to hereinafter as OS).

The control service is constructed so as to have one or more service modules such as a system control service (Referred to hereinafter as SCS) 42, an engine control service (Referred to hereinafter as ECS) 44, a memory control service (referred to hereinafter as MCS) 45, an operation panel control service (referred to hereinafter as OCS) 46, a Fax control service (referred to hereinafter as FCS) 47, a network control service (referred to hereinafter as NCS) 48, a user information managing service (referred to hereinafter as UCS) 49, and the like.

Here, the platform 40 is constructed to include an application program interface (referred to hereinafter as API) that enables reception of the process demand from the application 30 by a predefined function.

The OS 41 is an operating system such as UNIX (trade mark) and conducts parallel processing of each of the software in the platform 40 or the application 30 in parallel.

The process of SRM 43 carries out the system control and also the control of the resources together with the SCS 42.

For example, the process of SRM43 arbitrates and control the execution in accordance with the request form an upper layer that uses hardware resources such as the engine, which may be a scanner part or a printer part, a memory, a hard disk device (HDD) file, a host I/O (Centronix interface), a network interface, an IEEE1394 interface, an RS 232C interface, and the like.

For example, the SRM 43 determines whether or not the requested hardware resources is available (not used by other requests), and if it is available,

a notification is made to the upper layer that the requested hardware resources are available. Further, the SRM 43 carries out scheduling of using the hardware resources in response to is the request from the upper class layer. For example, the SRM 43 executes the requests such as paper feeding and picture formation conducted of the printer engine, memory securing, file generation, and the like, directly.

The process of SCS42 executes the application managing such as application control, operation part control, system screen display, LED display, resource managing and an interrupt application control. The process of ECS 44 executes the engine control of the black-and-white line printer 15, color line printer 16, and the hardware resource 17. The process of MCS 45 executes acquisition and release of the image memory, the use of the hard disk devices (HDD), and compression and decompression of image data, and the like. The process of OCS 46 executes control of the operation panel used for the information transmission means between the operator and the main body control.

The process of FCS 47 provides the application for executing: facsimile transmission and reception that uses a PSTN or ISDN network from each of the application layers of the system controller, registration/quotation of various facsimile data managed by the BKM (backup SRAM), reading of facsimile, reception and printing of facsimile, fusion transmission and reception, and the like.

The process of NCS 48 provides the services that we used commonly to the applications that require a network I/O and distribute the data received from the network side by respective protocols to respective applications or provide mediation at the time of transmitting the data from the application to the side of the network.

The UCS 49 manages the user information of the user and/or the group information of the group to which the user belong and determines another device connected thereto via a storage device and/or a network and storing therein the user information corresponding to the request and/or the Group information of the group to which the user belongs. Thereby, the UCS 49 acquires the user information of the user and/or the group information of the group to which the user belongs from the foregoing another device connected via the storage device and/or the network thus determined and supplies the same to each of the applications.

Further, the process of the UCS 49 provides an authentication service of users, in addition to the managing of the user information of the user and/or the group information of the group to which the user belongs.

The Union merge provider 13 and/or the other sub providers explained with reference to FIG. 8 (such as the Local authentication directory provider 12, for example,) are mounted on the UCS 49.

The application 30 carries out processing pertinent to the user service related to image formation processing, such as printer, copier, facsimile, scanner, and the like. The application 30 includes a printer application 31, which is an application for the printer having a page description language (PDL, PCL) and postscript (PS) a copy application 32 for copiers, a fax application 33 for facsimiles, a scanner application 34 for scanners, a net file application 35 for network files and a process inspection application 36 for process inspection, and the like.

The fusion machine starter 50 is the part first executed upon power on of the fusion machine 120 activates the applications 30 or the platform 40. For example, the fusion machine starter 50 reads out the control service or application program from the flash memory as will be described later and transfers the programs thus read out to a memory region that secured on an SRAM or an SDRAM for system activation.

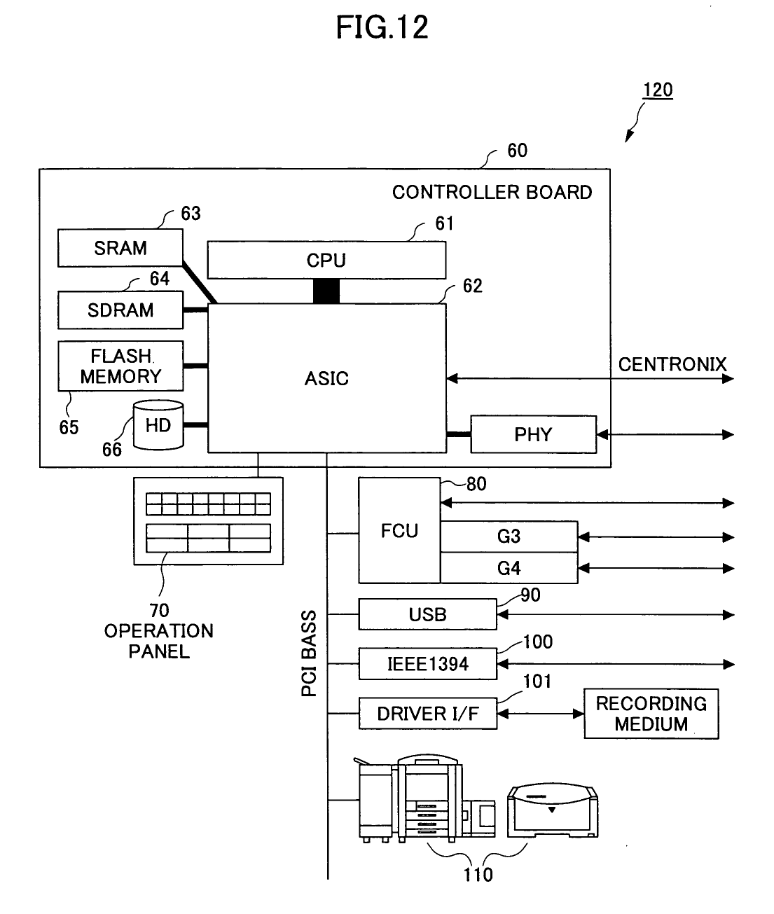

FIG. 12 shows the hardware construction of a fusion machine according to the present invention.

Referring to FIG. 12, the fusion machine 120 of FIG. 12 is constructed so as to include a controller board 60, an operation panel 70, a fax control unit 80 (referred to hereinafter as FCU), a USB device 90, an IEEE1394 device 100, a driver I/F 101, and an engine part 110.

Here, the driver I/F101 is and I/F (interface) used for reading the programs, and the like, corresponding to the Union merge provider 13 and/or the sub provider 14 from an inserted recording medium storing the programs, and the like, corresponding to the Union merge provider 13 and/or the sub provider 14 and for loading to the fusion machine 120. Here, the recording medium may be any of an SD memory card, smart media, a multimedia card, a CompactFlash (trade mark) medium, and the like.

The operation panel 70 is connected to an ASIC62 of the controller board 60 directly. Further, the FCU 80, the USB device 90, the IEEE1394 device 100, the driver I/F 101 and the engine part 110 are connected to the ASIC 62 of the controller board 60 with a PCI bus (Peripheral Component Interconnect bus), and the like.

The controller board 60 is constructed so as to include a CPU 61, the ASIC62, an SRAM (Static RAM) 63, an SDRAM (Synchronous DRAM) 64, a flash memory 65, and a HDD66. Thereby, the controller board 60 is constructed so as to connect the CPU 61, the SRAM63, the SDRAM64, the flash memory 65, the HDD66, and the like. to the ASIC62.

It should be noted that the CPU61 carries out overall control of the fusion machine 120. Thus, the CPU61 activates the process of the SCS 42, the SRM 43, the ECS44, the MCS45, the OCS 46, the FCS 47 and also the NCS48 that form the platform 40 on the OS 41 and activates the printer application 31, the copy application 32, the fax application 33, the scanner application 34, the net file application 35 and also the process inspection application 36 that constitute the application 30.

The ASIC 62 is an IC for image processing and includes a hardware element for image processing. Further, a virtual memory region such as kernel and process are mapped in the physical memory region of the SRAM 63 and the SDRAM 64.

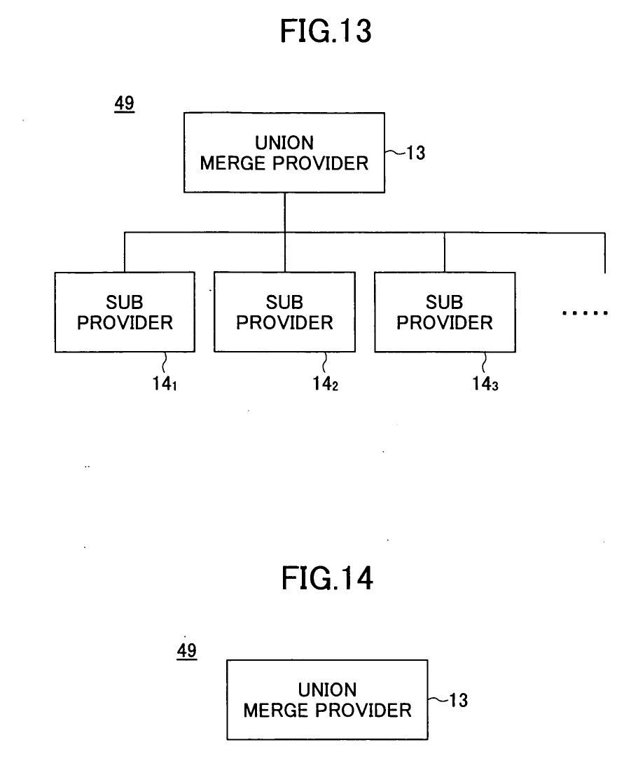

Hereinafter, a construction example of the UCS 49 will be explained with reference to FIGS. 13-15.

FIG. 13 is a diagram for explaining the construction of the UCS.

As shown in FIG. 13, the UCS 49 is formed of the Union merge provider 13 shown in FIG. 8 and one or more sub providers 14.

By adopting the construction of FIG. 13, the UCS49 integrates the user information of the user and/or the group information of the group to which the user belongs provided by the sub providers 14 in the Union merge provider 13, as will be described later. Thereby, it becomes possible to provide the user information of a user and/or the group information of the group to which the user belongs to the applications 30, and the like, of the fusion machine 120 in the merged state.

FIG. 14 is another diagram for explaining the construction of the UCS.

As shown in FIG. 14, the UCS 49 does not include the sub providers 14 and is formed of the Union merge provider 13 of FIG. 8 only.

By taking the construction of FIG. 14, it becomes possible to merge the user information of a user and/or the group information of the group to which the user belongs and provided the sub provider 14 mounted to other device is merged in the Union merge provider 13. Thus, it becomes possible to provide the user information of a user and/or the group information of the group to which the user belongs to the applications 30, and the like, of the fusion machine 120 in the merged state.

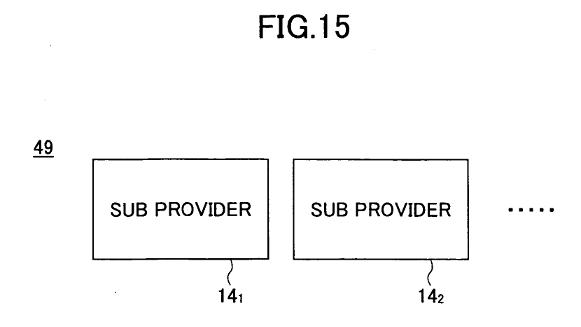

FIG. 15 is another diagram for explaining the construction of the UCS.

As shown in FIG. 15, the UCS49 does not include the Union merge provider 13 of FIG. 8 and is formed of at least one sub provider 14.

By adopting the construction of FIG. 15, it becomes possible to provide the user information of a user and/or the group information of the group to which the user belongs in response to a request from the Union merge provider 13 mounted to other device.

In the following, explanation will be made by using the Union merge provider 13 and the sub provider 14 for simplification of the explanation.

### EXAMPLE 1

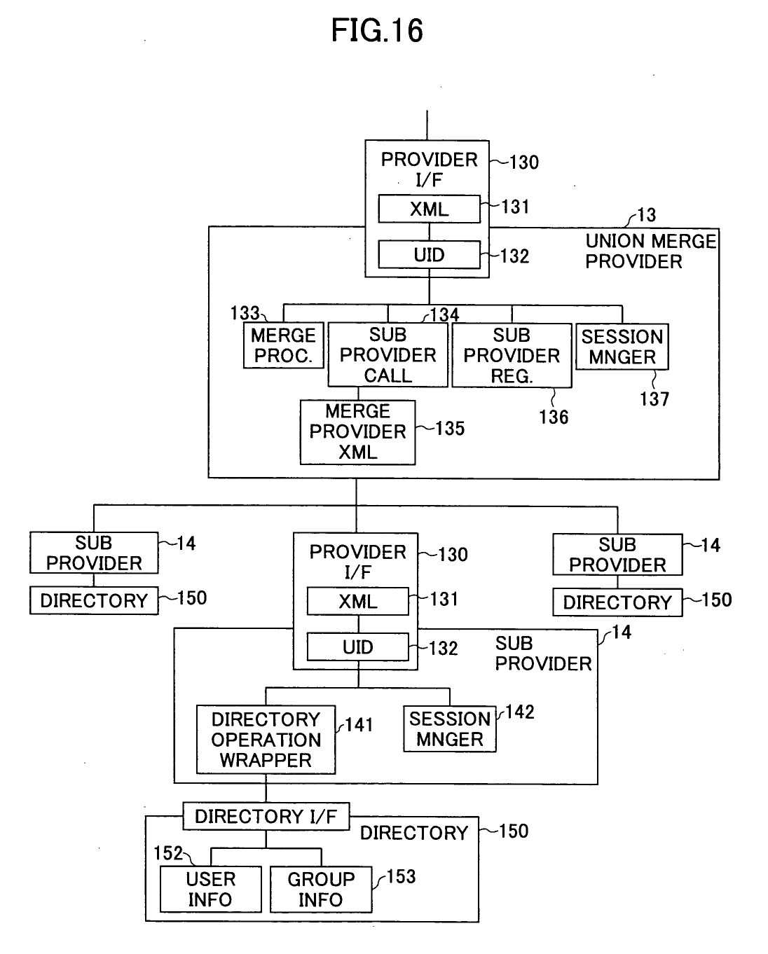

FIG. 16 is a functional block diagram of a Union merge provider and sub providers according to a Example 1 of a present invention.

In the first embodiment, for the sake of simplification of the explanation, it is assumed that the Union merge provider 13 and the sub providers 14 provide the user information of a user and/or the group information of the group to which the user belongs, but not the authentication of the users.

As shown in FIG. 16 the Union merge provider 13 is formed of a provider I/F 130, a merge processing part 133, a sub provider calling part 134, a Merge provider XML processing part 135, a sub provider registration part 136, and a session managing department 137.

Also, the provider I/F 130 is formed of an XML processing part 131 and a UID conversion part 132.

The Provider I/F 130 is an interface that connects the Union merge provider 13 to other providers and/or other applications. As will be explained later, the sub provider 14, too, has a similar provider I/F 130.

The XML processing part 131 analyzes the XML message transmitted from other applications or Web portals, and the like, and converts the same to a form usable by the programs in the Union merge provider 13.

Conversely, the XML processing part 131 creates an XML message from the data, and the like, given from the UID conversion part 132 and transmits the same to the applications, Web portals, and the like.

Furthermore, it should be noted that the applications and the Web portals may be the application 30 explained with reference to FIG. 11, or alternatively an applications of other fusion machine or other device connected to the fusion machine 120 via a network.

The UID conversion part 132 converts the user ID that is contained to the XML message (referred to hereinafter as UID) according to the needs.

In the case the UID contained in the XML message has the construction of U: Windows (trade mark): Kana as explained with reference to FIG. 10 of conventional technology and the construction of UID inside the provider is kana, for example, the UID conversion part 132 converts UID from U: Windows: Kana to Kana. Similarly, in the case the XML message is transmitted from the provider a conversion of UID from Kana to U: Windows (trade mark): kana may be conducted according to the needs.

Further, the merge processing part 133 merges the user information of a user and/or the group information of the group to which the user belongs and registered to the sub providers 14 as will be described later.

The sub provider calling part 134 forwards the data necessary to create the XML message transmitted to the sub provider 14 to the merge provider XML processing part 135 to be described later.

Further, the sub provider calling part 134 forwards the user information of a user and/or the group information of the group to which the user belongs and acquired from the sub provider 14 through the merge provider XML processing part 135 to be described later, to the merge processing part 133.

The merge provider XML processing part 135 creates the XML message on the basis of the data given from the sub provider calling part 134 and transmits the same to a designated sub provider 14.

Further, the merge provider XML processing part 135 receives the XML message transmitted from the sub provider 14 forwards the data contained in the XML message to the sub provider calling part 134.

It should be noted that the data about the sub provider 14 to be managed is registered in the sub provider registration part 136. In the sub provider registration part 136, the identifier of the sub provider 14, the name of the sub provider 14, the managing ID of the sub provider 14, the managing password of the sub provider 14, and the like are registered for each of the sub providers 14.

In the case of registering a new sub provider 14 to the Union merge provider 13, for example, the identifier of the sub provider 14, the name of the sub provider 14, the managing ID of the sub provider 14 and the managing password of the sub provider 14 are registered to the sub provider registration part 136.

The session managing part 137 manages the sessions between the Union merge provider 13 and other sub providers 14 as well as other applications or the Web portal.

For example, analysis is made whether or not the XML message acquired in the XML processing part 131 included the session ticket ID 210 of the valid session ticket 200, which permits the use of the union provider 13.

Further, the session managing part 137 acquires the session ticket ID 310 of the anonymous session ticket 300 from the sub provider 14 by using the managing ID and the managing password of the sub provider 14 registered in the sub provider registration part 136.

Thereby, the session managing part 137 issues the session ticket 200 of the Union merge provider 13 to be described later by using the session ticket ID310, and the like, of the acquired sub provider 14.

Because the session managing part 137 can acquire a session ticket ID 310 of an anonymous session ticket 300 from the sub provider 14, which is a provider different from the sub provider 14 to which the user has requested the issuance of the session ticket 400 by using the UID and the password, for example, the Union merge provider 13 can acquire the user information of a user and/or the group information of the group to which the user belongs from all the sub providers 14 under managing.

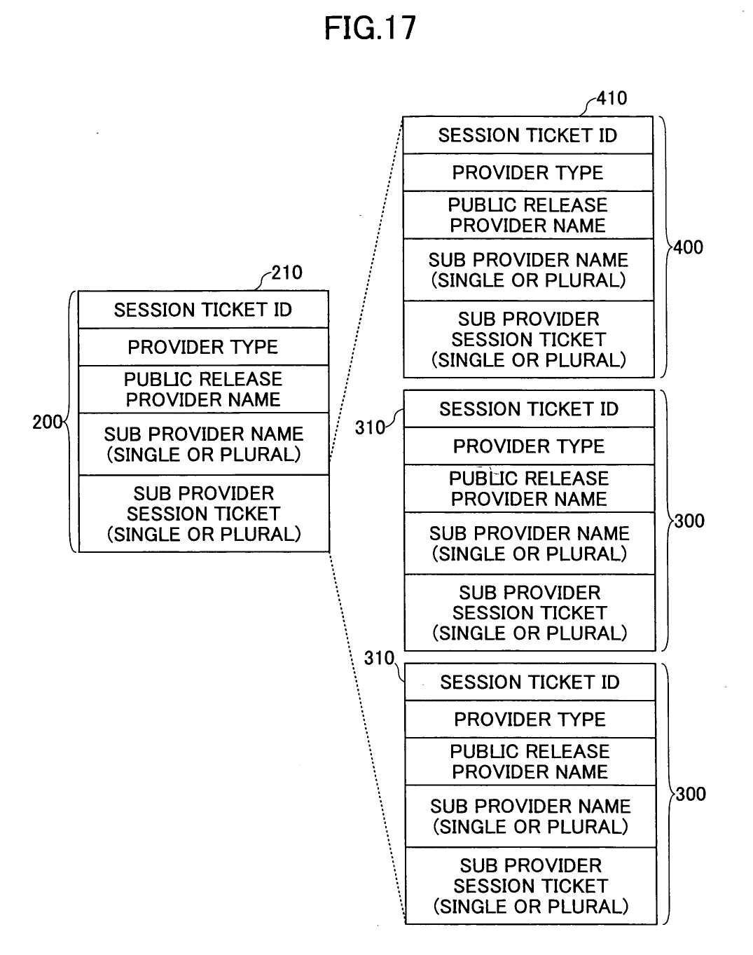

FIG. 17 is a concept diagram for explaining the structure of the session ticket of the Union merge provider.

As shown in FIG. 17, the session ticket 200 of the Union merge provider 13 has the structure including the session ticket ID 210, the provider type, the provider name for public release, one or more sub provider names, the session ticket 300 of one or more sub providers and/or a session ticket 400.

Here, the session ticket ID 210 is the identifier that distinguishes the current session ticket, while the provider type is the type of the providers, which may be “Union Merge”, and the like.

The public released provider name is the name of the public released Union merge provider 13, which may be “Union Merge 1”.

The sub provider name is the names of one or more registered sub providers 14. It should be noted that the session ticket 300 and/or the session ticket 400 of the foregoing one or more registered sub providers 14 and the Union merge provider 13 are stored in the session ticket of the sub provider.

Further, the session ticket 400 is the session ticket of the sub provider 14 issued based on the UID and the password input by the user, while the session ticket 300 is the session ticket of the sub provider 14 issued based on the managing ID and the managing password under authority of the manager and stored in the sub provider registration part 136.

In the description hereinafter, it is assumed for the sake of simplicity of explanation that the anonymous session ticket 300 is the only session ticket of the sub provider 14 contained in the session ticket 200 of the Union merge provider 13.

By providing the hierarchical structure shown in FIG. 17, the sub provider 14 can become the Union merge provider 13.

Further, while explanation has been made in FIG. 17 by using the example in which the session ticket 300 and/or the session ticket 400 for the one or more registered sub providers 14 and the Union merge provider 13 are stored in the session ticket of the sub provider, it is also possible that the session ticket 300 and/or the session ticket 400 are stored in the decoded form.

The sub provider 14 of FIG. 16 is formed of a provider I/F 130, a directory operation wrapper 141 and a session managing part 142.

The directory operation wrapper 141 modifies the data inside the sub provider 14 into the data capable of manipulating the user information held in the user information saving part 152 of the directory 150 or the group information of the group to which the user belongs and held in the group information saving part 153, and acquires the user information or the group information of the group to which the user belongs from the directory 150.

Further, it converts the acquired user information or the group information into the data possible to be processed inside the sub provider 14.

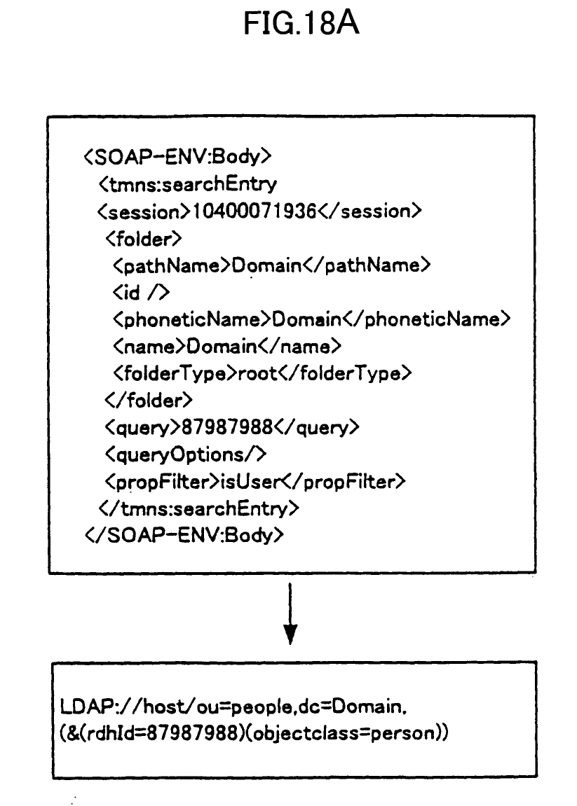

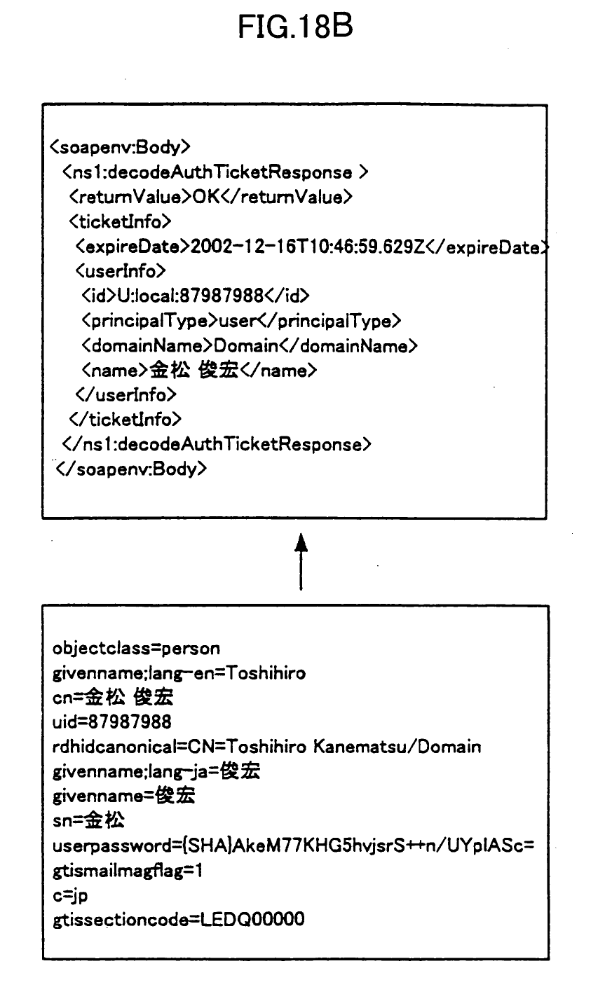

An example of modification of the data of the directory operation wrapper 141 will be explained later by using FIG. 18.

The session managing part 142 manages the sessions between the sub providers 14 and the Union merge provider 13.

For example, it analyzes whether or not session ticket ID 310 of the valid session ticket 300 that permits the use of the sub provider 14 is included in the XML message acquired in the XML processing part 131.

Further, the session managing part 142 issued the is anonymous session ticket 300 when it receives the issue request of the anonymous session ticket 300 that contains the managing ID and the managing password from the Union merge provider 13 via the provider I/F 130.

Further, the session managing part 142 gives the session ticket ID 310 of the anonymous session ticket 300 thus issued to the provider I/F 130, and transmits the issue response of the anonymous session ticket 300 including the session ticket ID 310 to the Union merge provider 13.

Further, the directory 150 of FIG. 16 contains the user information saving part 152 and the group information saving part 153.

The user information saving part 152 holds the user information of the user registered in the sub provider 14. For example, the UID, the user name, the user password, and the like, are held in the user information saving part 152.

Further, the group information registered to the sub provider 14 is held in the group information saving part 153. For example, the group information saving part 153 holds the group ID, the group name, the membership of the group, and the like.

FIGS. 18A and 18B are diagrams explaining modification of data in the directory operation wrapper.

FIG. 18A is an example of modifying the data inside the sub provider 14 to the data capable of manipulating the user information held in the user information saving part 152 and the group information of the group to which the user belongs and held in the information saving part 153 of the directory 150.

FIG. 18B is an example of modifying the date of the user information held in the user information saving part 152 of the directory 150 or the group information of the group to which the user belongs and held in the group information saving part 153 to the data capable of processing in the sub provider 14.

FIG. 19 is a flowchart showing an example of the acquisition processing of the group to which the user belongs in the Union merge provider.

In the following, the application or Web portal that transmits the acquisition request of the group information for the group to which the user belongs to the Union merge provider 13 will be referred to as simply the client for the sake of simplicity of explanation.

In the step S20, the XML processing part 131 of the Union merge provider 13 receives the acquisition request of the group to which the user belongs from the client.

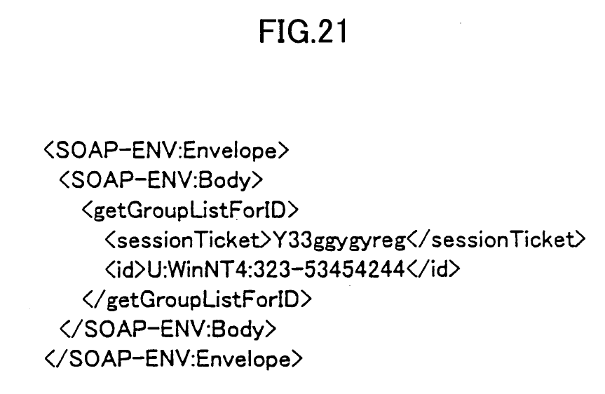

The example of the group acquisition request from the client to the Union merge provider 13 will be describes later with reference to FIG. 21.

After the step S20, the process proceeds to the step S21, and the session managing part 137 determines whether or not the session ticket ID 210 of the session ticket 200 of the Union merge provider 13 contained in the acquisition request of the group to which the user belongs and received in the step S20, is a valid session ticket ID 210.

When it is determined that the session ticket is the session ticket ID210 of the valid session ticket 200 ((YES in step S21), the process proceeds to the step S22, while when it is determined that the session ticket is the session ticket ID 210 of an invalid session ticket 200 (NO in step S21), the process proceeds to the step S26.

In the step S22, the session managing part 137 forwards the session ticket ID310 of the session ticket 300 of all the sub providers 14 contained in the session ticket 200 of the Union merge provider 13 and the sub provider name to the sub provider calling part 134.

After the step S22, the process advances to the step S23, and the merge provider XML processing part 135 issues the acquisition request of the group to which the user belongs, to each of the sub providers 14 including the session ticket ID 310 of the session ticket 300 of the sub providers 14 acquired through the sub provider calling part 134, and transmits the same to each of the sub providers 14.

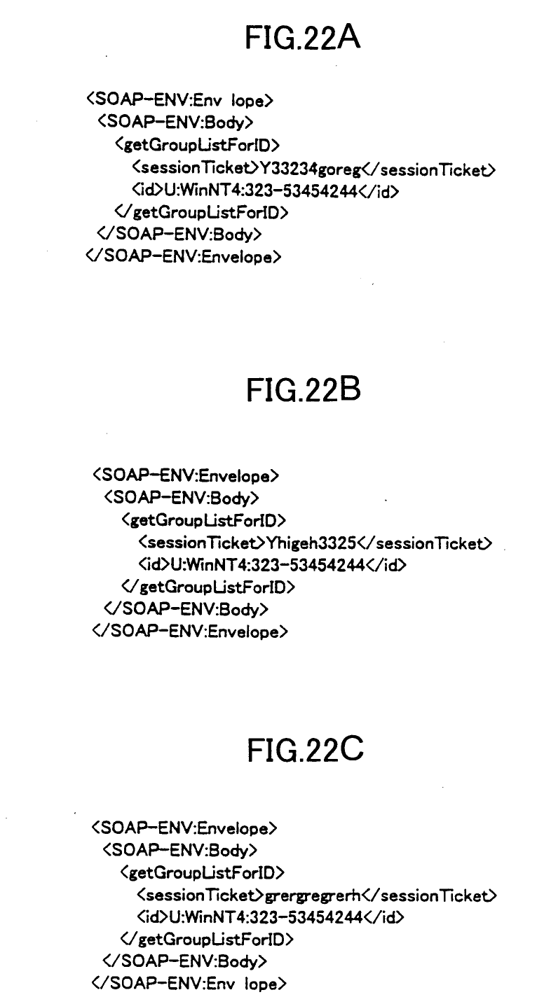

The example of the group acquisition request from the Union merge provider 13 to each of the sub providers 14 will be described later with reference to FIG. 22.

After the step S23, the process proceeds to the step S24 and the sub provider calling part 134 receives the assignment group acquisition response responding to the acquisition request of the groups to which the user belongs, from each of the sub providers 14 via the merge provider XML processing part 135.

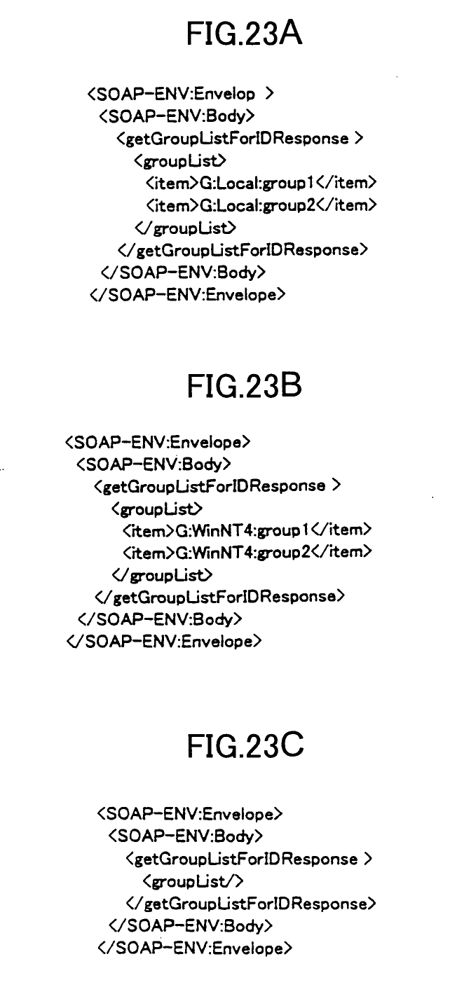

The example of the group acquisition response from the sub providers 14 to the Union merge provider 13 will be described later with reference to FIG. 23.

After the step S24, the process proceeds to the step S25, and the sub provider calling part 134 determines whether or not the group information of the groups to which the designated user belongs is included in the assignment group acquisition responses from the sub providers 14 that have received the response in the step S24.

When it is determined that even one piece of assignment group information of the user is contained (YES in step S25), the process proceeds to the step S27, while when it is determined that there is not even one group to which the user belongs is contained (NO in step S25), the process proceeds to the step S26.

In the step S26, the XML processing part 131 of the Union merge provider 13 issues a response indicating that the acquisition of the groups to which the user belongs has failed, and transmits the same to the client.

In the step S27, the merge processing part 133 merges the groups to which the user belongs and included to the assignment group acquisition response acquired in the step S24 from each of the sub providers 14.

After the step S27, the process proceeds to the step S28, the XML processing part 131 of the Union merge provider 13 issues the assignment group acquisition response including the information of the groups to which the user belongs and merged in the step S27, and transmits the same to the client.

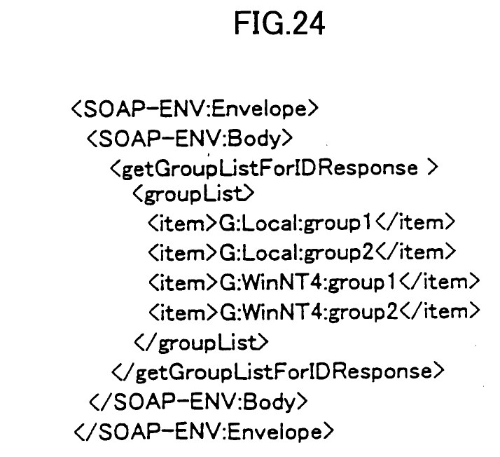

The example of the group acquisition response from the Union merge provider 13 to the client will be described later with reference to FIG. 24.

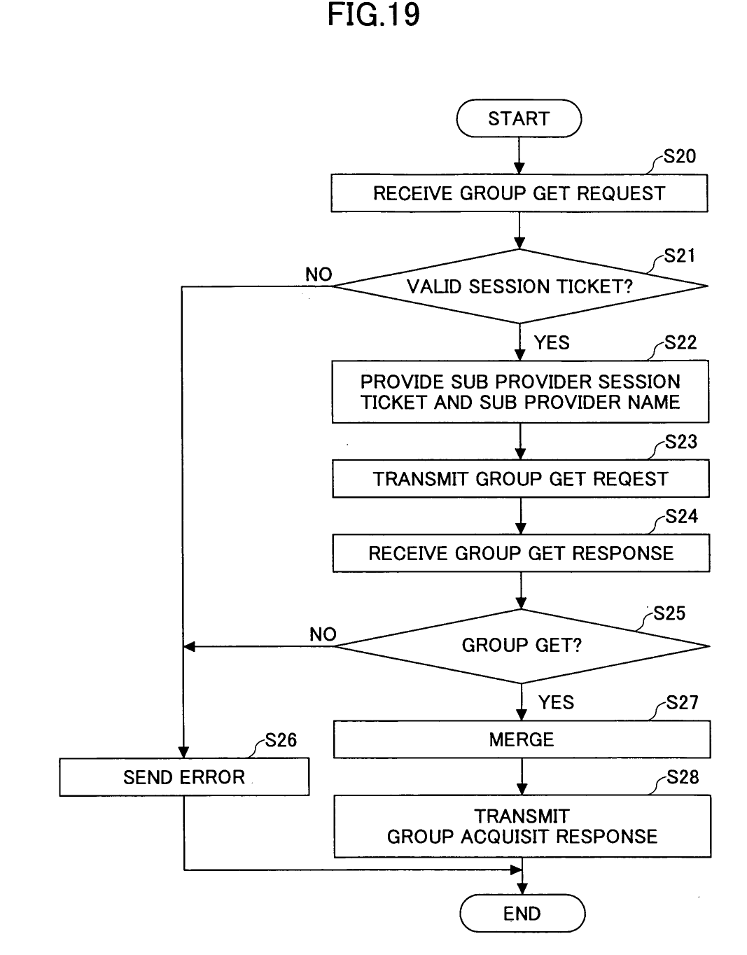

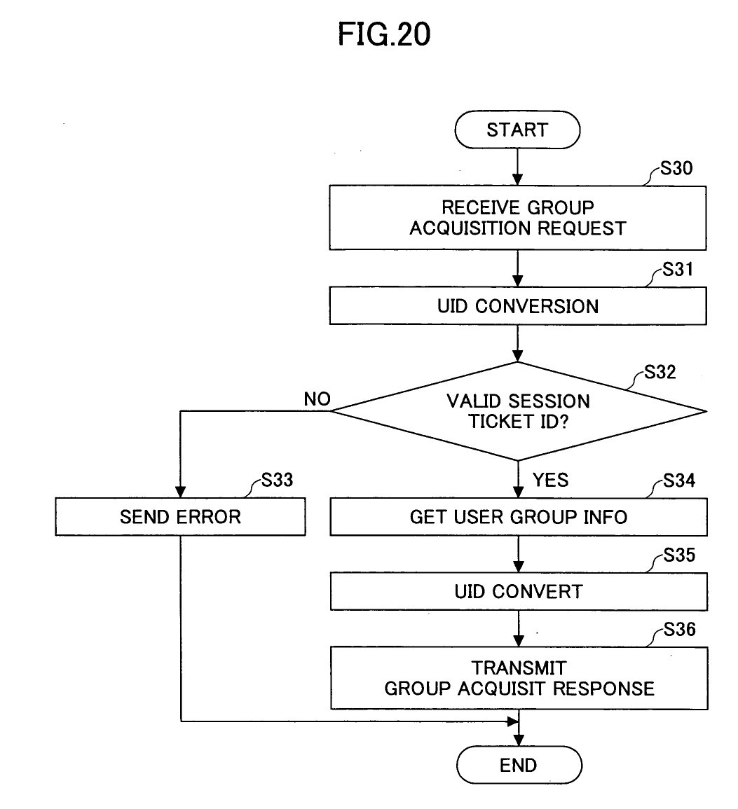

FIG. 20 is a flowchart showing the example of the group acquisition process of the group to which the user belongs conducted in a sub provider.

The sub provider 14 starts the processing of the steps starting from step S30 as will be described below, when the Union merge provider 13 has transmitted the acquisition request of the groups to which the user belongs to each of the sub providers 14 in the step S23 of FIG. 19.

In the step S30, the XML processing part 131 of the sub provider 14 receives the acquisition request of the group to which the user belongs from the Union merge provider 13.

The example of the group acquisition request from the Union merge provider 13 to each of the sub providers 14 will be described later with reference to FIG. 22.

Following the step S30, the process proceeds to the step S31, and the UID conversion part 132 of the sub provider 14 converts the UID included in the acquisition request of the group to which the user belongs and received in the step S30 into the UID peculiar to the directory 150.

Following the step S31, the process advances to the step S32, and the session managing part 142 determines whether or not the session ticket ID310 of the session ticket 300 of sub provider 14 included in the acquisition request of the group to which the user belongs and received in the step S30 is the session ticket ID 310 of a valid session ticket 300.

When it is determined that the session ticket ID 310 is a valid session ticket 300 (YES in step S32), the process proceeds to the step S34, while when it is determined the session ticket ID 310 is an invalid session ticket 300 (NO in step S32), the process proceeds to the step S33.

In the step S33, the XML processing part 131 of the sub provider 14 issues a group acquisition response indicating that the acquisition of the group to which the user belongs has failed, and transmits the same to the Union merge provider 13.

In the step S34, the sub provider 14 acquires the group information of the group to which the user belongs from the directory 150 through the directory operation wrapper 141.

After the step S34, the process proceeds to the step S35, and the UID conversion part 132 of the sub provider 14 converts the UID peculiar to the directory 150 into an UID available in the Union merge provider 13.

Following the step S35, the process proceeds to the step S36, and the XML processing part 131 of the sub provider 14 issues the group acquisition response including the information of the group to which the user belongs and transmits the same to the Union merge provider 13.

The example of the group acquisition response from each sub provider 14 to the Union merge provider 13 will be described later with reference to FIG. 23.

Furthermore, the step S24 of FIG. 19 receives the group acquisition response transmitted in the step S33 or the step S36 of FIG. 20.

FIG. 21 shows an example of the XML message of the group acquisition request from the client to the Union merge provider.

As shown in FIG. 21, the group acquisition request of the group to which the user belongs and sent from the client to the Union merge provider 13 includes the session ticket ID 210 of the session ticket 200 of the Union merge provider 13 in the tag of <session Ticket></session Ticket>. Further, the UID identifying the user is contained in the tag of <Id></id>.

The client transmits the group acquisition request of the group to which the user belongs, which contains the UID of the user and the session ticket ID 210 of the session ticket 200 of the Union merge provider 13, to the Union merge provider 13.

FIGS. 22A-22C show the examples of the XML message of the group acquisition request from the Union merge provider to the sub provider.

FIG. 22A is the XML message of a group acquisition request sent to the Local directory provider 160, which is one of the sub providers 14, from the Union merge provider 13.

As shown in FIG. 22A, the acquisition request of the group to which the user belongs and transmitted from the Union merge provider 13 to the Local directory provider 160 includes, in the tag of <session Ticket></session Ticket>, the session ticket ID 310 of the session ticket 300 of the Local directory provider 160.

Also, in the tag of <Id></id>, the UID that identifies the user is contained. This UID is the one similar to the UID included in the XML message of FIG. 21.

FIG. 22B is the XML message of a group acquisition request transmitted to the WinNT4 directory provider 161, which is one of the sub providers 14, from the Union merge provider 13.

As shown in FIG. 22B, the acquisition request of the group to which the user belongs and transmitted from the Union merge provider 13 to the WinNT4 directory provider 161 includes the session ticket ID 310 of the session ticket 300 of the WinNT4 directory provider 161 in the tag of <Session Ticket></session Ticket>.

Further, in the tag <Id></id>, an UID that identifies the user is included. It should be noted that this UID is the one similar to the UID included in the XML message of FIG. 21.

FIG. 22C is the XML message of a group acquisition 20 request transmitted to the Notes (trade mark) R5 directory provider 162, which is one of the sub providers 14, from the Union merge provider 13.

As shown in FIG. 22C, the acquisition request of the group to which the user belongs and transmitted from the Union merge provider 13 to the Notes (trade mark) R5 directory provider 162 includes the session ticket ID 310 of the session ticket 300 of the Notes (trade mark) R5 directory provider 162 in the tag <session Ticket></session Ticket>.

Further, the UID identifying the user is included in the tag <id></id>. This UID is the one similar to the UID included in the XML message of FIG. 21.

Because the Union merge provider 13 manages the session ticket with the hierarchical structure as explained it in FIG. 17, it becomes possible to acquire the session ticket ID 310 of the session ticket 300 of the Local directory provider 160 or the WinNT4 directory provider 161 or the Notes (trade mark) R5 directory provider 162, which form the sub providers 14, on the basis of the session ticket ID 210 of the session ticket 200 of the Union merge provider 13 contained in the acquisition request of the group to which the user belongs and transmitted from the client, and include the session ticket ID310 in the respective XML messages.

FIGS. 23A-23C show examples of the XML message of a group acquisition response to the Union merge provider from the sub provider.

FIG. 23A is the XML message of a group acquisition response from the Local directory provider 160 to the Union merge provider 13, which is one of the sub providers 14.

As shown in FIG. 23A, the acquisition response of the group to which the user belongs and transmitted from the Local directory provider 160 to the Union merge provider 13 includes the group information of the group to which the designated user belongs in the Local directory provider 160 in each tag <item></item> included in the tag <group List></group List>.

FIG. 23B is the XML message of a group acquisition response transmitted from the WinNT4 directory provider 161, which is one of the sub providers 14, to the Union merge provider 13.

As shown in FIG. 23B, the acquisition response of the group to which the user belongs and transmitted from the WinNT4 directory provider 161 to the Union merge provider 13 contains the group information of the group to which the designated user belongs in the WinNT4 directory provider 161 in each tag <item></item> included in the tag <Group List></group List>.

FIG. 23C is the XML message of a group acquisition response transmitted from the Notes (trade mark) R5 directory provider 162, which is one of the sub providers 14, to the Union merge provider 13.

As shown in FIG. 23C, the Notes (trade mark) R5 directory provider 161 transmits the acquisition response not containing the tag <item></item> to the Union merge provider 13 in the case the group information of the group to which the designated user belongs does not exist.

Each sub provider 14 acquires, in the case there exists the group to which the designated user belongs, the information of the group from the directory 150 and transmits the same to the Union merge provider 13.

FIG. 24 is the XML message of a group acquisition response from the Union merge provider to the client.

As shown in FIG. 24, the Union merge provider 13 merges and stores the <item></item> tag acquired from each of the sub providers 14 and includes the group information, in a single tag <group List></group List>, and transmits the same to the client.

The client can acquire the information about group of the user who is registered in each sub provider 14 that provides the service of the directory 150, from the Union merge provider 13, which manages the information, by transmitting the acquisition request for the group to which the user belongs, the acquisition request containing the session ticket ID 210 of the session ticket 200 of the Union merge provider 13 and also the UID identifying the user, to the Union merge provider 13.

For example, it should be noted that <Item>G: Local: group1</item> and <item>G: Local: group2</item> of FIG. 24 are the information of the group to which the user 323-53454244 registered in the Local directory provider 160 as the user of WinNT4 directory provider 161 belongs, while <item>G: WinNT4: group1</item> and <item>G: WinNT4: group2</item> of FIG. 24 are the information of the group to which the user 323-53454244 registered to the WinNT4 directory provider 161 as the user of the WinNT4 directory provider 161 belongs.

In the first example, explanation has thus been made for the case in which the session ticket ID 210 and/or the session ticket ID 310 are transmitted and received between the Union merge provider 13 and sub provider 14 and between the Union merge provider 13 and the client, while this does not limit the present invention, and it is possible to transmit and receive also the session ticket 200 and/or the session ticket 300.

Thus, in the Example 1, explanation has been made for the case in which the sub provider 14 does not require authentication. In the Example 2 described below, explanation will be made for the case in which the sub provider 14 requires authentication.

### EXAMPLE 2

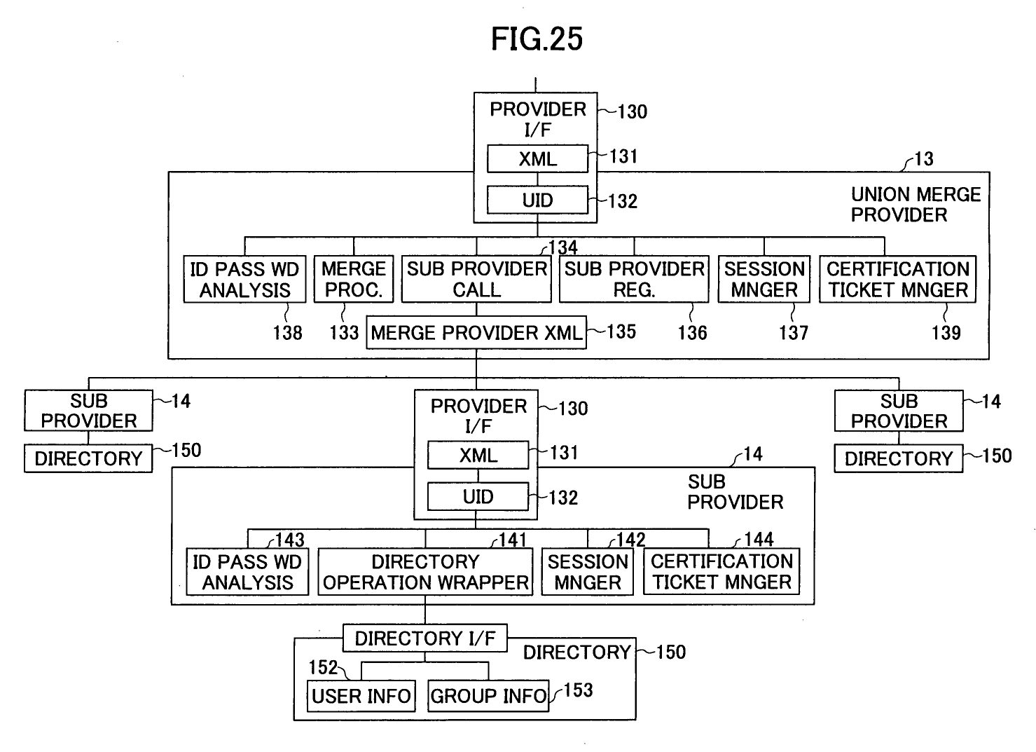

FIG. 25 is a functional block diagram of the Union merge provider and the sub providers according to Example 2 of the present invention.

In the Example 2, it is assumed that the sub providers 14 provide not only the user information and/or group information of the group to which the user belongs but also an authentication service of the user.

As shown in FIG. 25, the Union merge provider 13 includes the provider I/F 130, the merge processing part 133, the sub provider calling part 134, the merge provider XML processing part 135, the sub provider registration department 136, the session managing part 137, an ID password analyzing part 138 and an authentication ticket managing part 139.

Further, the provider I/F 130 is formed of the XML processing part 131 and the UID conversion part 132.

As for the construction of the Union merge provider 13 of Example 2 of FIG. 25, it will be noted that the ID password analyzing part 138 and the authentication ticket managing part 139 are added newly to the construction of the Union merge provider 13 of Example 1 of FIG. 16.

The ID password analyzing part 138 acquires the ID and password contained to the issue request of an authentication ticket 500 for certifying the user in the Union merge provider 13 and transmitted from a client (Web portal, for example), and forwards the same to the sub provider calling part 134.

The sub provider calling part 134 forwards the ID and the password given from the ID password analyzing part 138 to the merge provider XML processing part 135 to be described later.

Further, the sub provider calling part 134 forwards the authentication ticket ID 610 of the authentication ticket 600 acquired it from a sub provider 14 that has succeeded in the authentication and certifying the user in that sub provider 14 to the authentication ticket managing part 139 via the merge provider XML processing part 135 as will be described later.

The merge provider XML processing part 135 creates an XML message based on the data given from the sub provider calling part 134 and transmits the same to all the sub providers 14 registered to the sub provider registration department 136.

Further, the merge provider XML processing part 135 receives the XML message from the sub provider 14 and gives the data to the sub provider calling part 134.

For example, upon reception of the authentication response from a sub provider 14 that has succeeded in the authentication, the authentication ticket ID 610 of the authentication ticket 600 that certifies the user in that sub provider 14 is given to the sub provider calling part 134.

The authentication ticket managing part 139 creates and manages the authentication ticket 500 that certifies the user in the Union merge provider 13 based on the authentication ticket ID 610 of the authentication ticket 600 acquired from the sub provider 14 that has succeeded in the authentication.

Further, the authentication ticket managing part 139 transmits the authentication ticket ID 510 of the authentication ticket 500 thus created certifying the user in the Union merge provider 13 to a client (Web portal for example) requested the authentication via the provider I/F 130 of the Union merge provider 13.

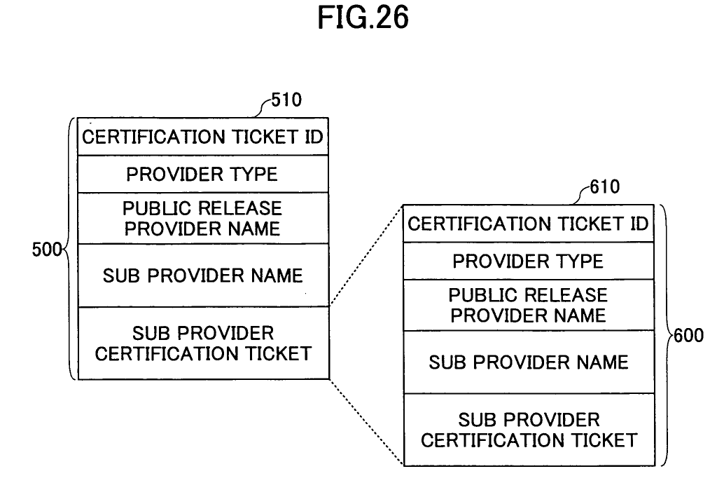

FIG. 26 is a concept diagram for explaining the structure of the authentication ticket of the Union merge provider.

As shown in FIG. 26, the authentication ticket 500 of the Union merge provider 13 includes an authentication ticket ID 510, a provider type, the provider name of the providers for public release, the sub provider name, and an authentication ticket 600 of the sub provider in the structure thereof.

It should be noted that the authentication ticket ID 510 is the identifier that distinguishes the authentication ticket. On the other hand, the provider type represents the type of the provider such as “Union merge”, and the like.

Provider name of the provider for public release is the name of the Union merge provider 13 released to the public such as “Union merging 1”, and the like.

It should be noted that the sub provider name is the name of the sub provider 14 among the registered sub providers 14 in which the authentication has been succeeded and the transmission of the authentication ticket 600 has been made. Further, the authentication ticket of the sub provider is the authentication ticket 600 of that sub provider 14 in which the authentication has been succeeded and the transmission of the authentication ticket 600 has been made.

By having the structure as shown in FIG. 26, the user can finish the authentication process in one time.

Furthermore, it is possible to include the decoded authentication ticket 600 of the sub provider 14 in which the authentication has bee made successfully and the transmission of the authentication ticket 600 has been made, in the authentication ticket of the sub provider.

The sub provider 14 of FIG. 25 is formed of the provider I/F 130, the directory operation wrapper 141, the session managing part 142, the ID password analyzing part 143, and the authentication ticket managing part 144.

As for the construction of the sub provider 14 in the Example 2 of FIG. 25, it will be noted that the ID password analyzing part 143 and the authentication ticket managing part 144 are added newly to the construction of the sub provider 14 of the Example 1 of FIG. 16.

The ID password analyzing part 143 acquires the ID and password included in the issue request for the authentication ticket 600 transmitted from the Union merge provider 13 and confirms whether or not the ID and the password are in a valid combination by referring to the user information saving part 152 of the directory 150 via the directory operation rapper 141.

Further, the ID password analyzing part 143 acquires the user information of the corresponding user from the directory 150 via the directory operation wrapper 141 in the event the ID and password are in the valid combination, and forwards the same to the authentication ticket managing part 144.

The authentication ticket managing part 144 then issues the authentication ticket 600 certifying the user in the sub provider 14 based on the user information that given from the ID password analyzing part 143.

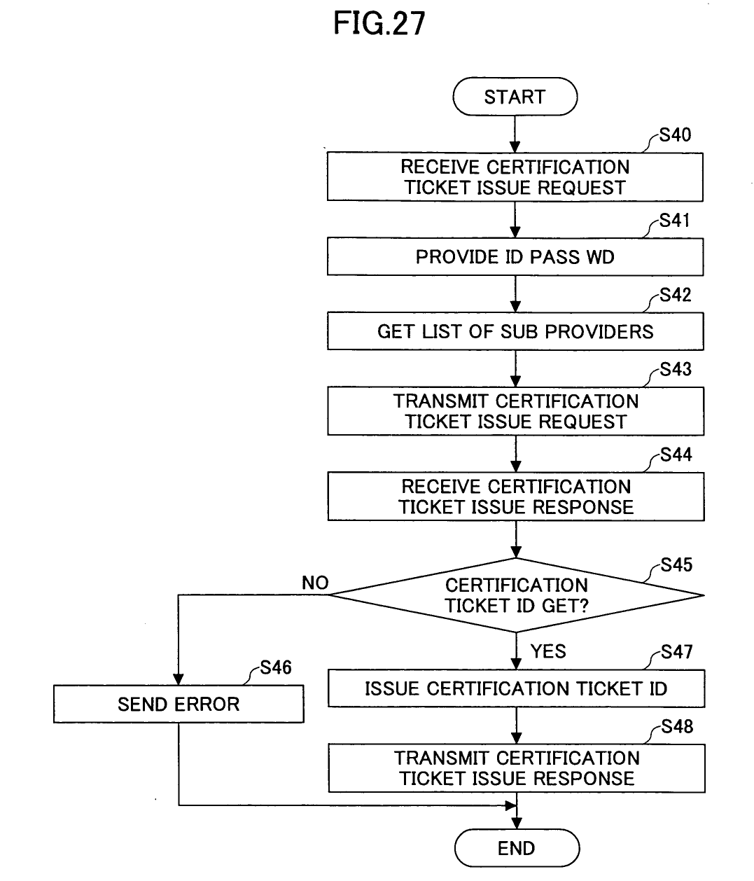

FIG. 27 is a flowchart showing an example of the authentication ticket issue processing in the Union merge provider.

In the step S40, the XML processing part 131 of the Union merge provider 13 receives the issue request of the authentication ticket 500 that certifies the user in the Union merge provider 13 from a client (Web portal for example).

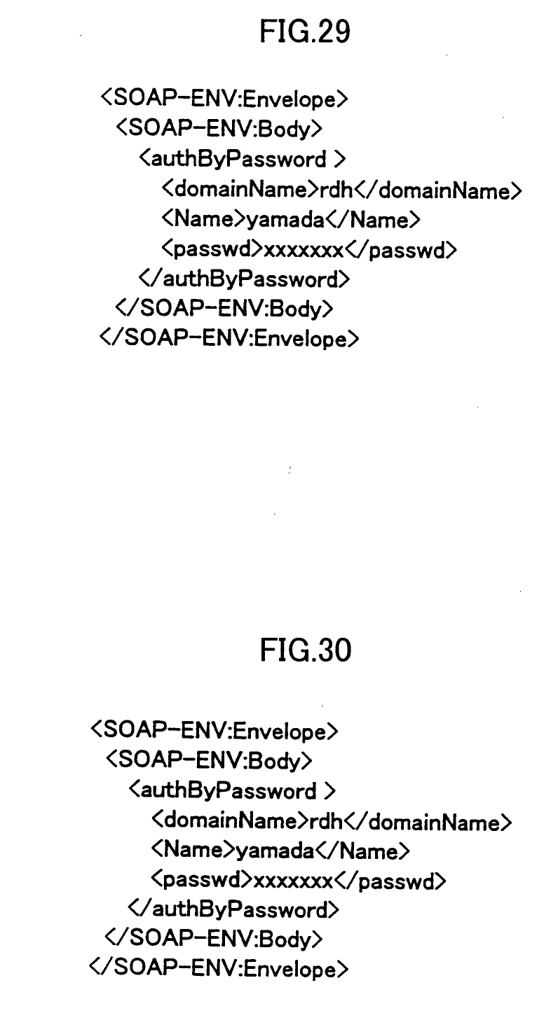

The example of the authentication ticket issue request from the client (Web portal for example) to the Union merge provider 13 will be explained later by using FIG. 29.

Following the step S40, the process proceeds to step S41, the ID password analyzing part 138 forwards the ID and password included in the issue request for the authentication ticket received it from the client (Web portal for example) in step S40 to the sub provider calling part 134.

After the step S41, the process proceeds to step S42, and the sub provider calling part 134 acquires the list of the sub providers 14 registered in the sub provider registration part 136.

Following the step S42, the profess proceeds to the step S43, and the merge provider XML processing part 135 creates the issue request of the authentication ticket 600 for certifying the user in the sub provider 14 and including the ID and password acquired from the sub provider calling part 134, and transmits the same to each of the sub providers 14 registered to the list of sub providers 14.

The example the authentication ticket issue request from the Union merge provider 13 to the sub provider 14 will be described later with reference to FIG. 30.

Following the step S43, the process proceeds to the step S44 and the sub provider calling part 134 receives the authentication ticket issue response for the issue request of authentication ticket 600 from each of the sub providers 14 through the merge provider XML processing part 135.

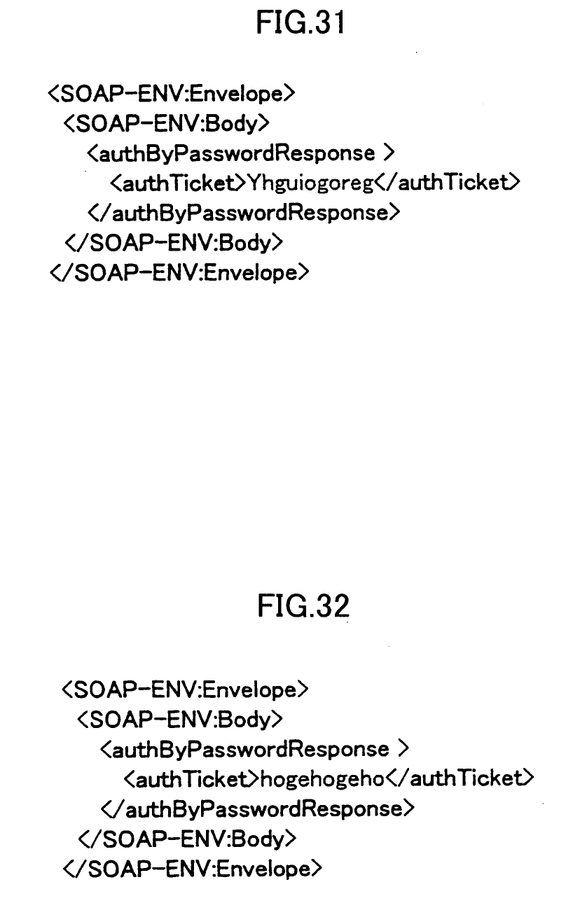

The example of the authentication ticket issue response from the sub provider 14 to the Union merge provider 13 will be described later with reference to FIG. 31.

Following the step S44, the process proceeds to the step S45, and the sub provider calling part 134 determines whether or not the authentication ticket ID 610 that distinguishes the authentication ticket 600 is included in one of the authentication ticket issue responses from the sub providers 14 received in the step S44.

When it is determined that that authentication ticket ID 610 distinguishing the authentication ticket 600 is included in one of the authentication ticket issue responses (YES in step S45), the process proceeds to the step S47, while when it is determined that the authentication ticket ID610 distinguishing the authentication ticket 600 is not included, (NO in step S45), the process proceeds to the step S46.

In the step S46, the XML processing part 131 of the Union merge provider 13 creates the response indicative of failure of the issuing of the authentication ticket 500 and transmits the same to the client (Web portal, for example).

In the step S47, the authentication ticket managing part 139 creates the authentication ticket 500 certifying the user in the Union merge provider 13 as explained with reference to FIG. 26 by using the authentication ticket ID610 of the sub provider 14.

Following the step S47, the process proceeds to the step S48, and the XML processing part 131 of the Union merge provider 13 creates the authentication ticket issue response including the authentication ticket ID 510 of the authentication ticket 500 created in the step S47, and transmits the same to the client (Web portal, for example).

The example of the authentication ticket issue response describes later from the Union merge provider 13 to the client (Web portal, for example) will be explained later with reference to FIG. 32.

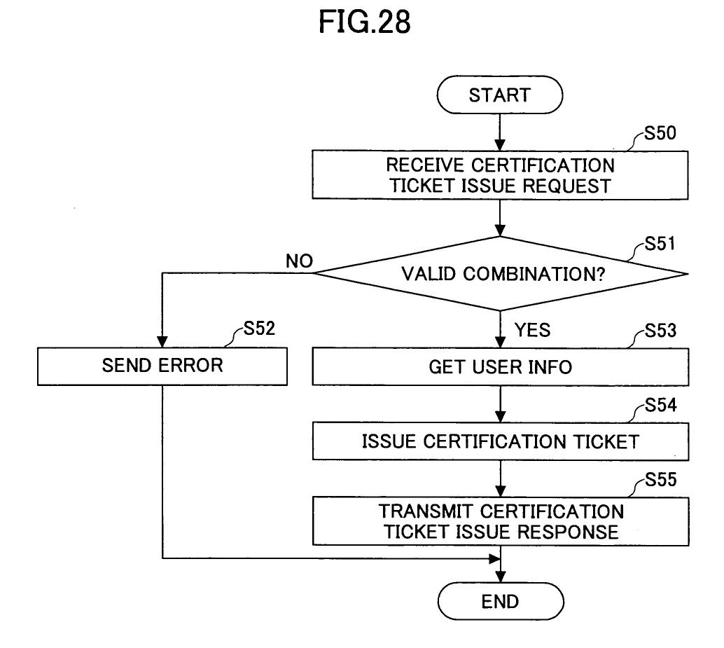

FIG. 28 is the flowchart showing an example of the authentication ticket issuing process in a sub provider.

The sub provider 14 starts the processing from the step S50 as shown below when the Union merge provider 13 has transmitted the issue request of the authentication ticket 600 that certifies the user in the sub provider 14 in the step S43 of FIG. 27 to each of the sub providers 14.

In the step S50, the XML processing part 131 of the sub provider 14 receives the issue request for the authentication ticket 600 that certifies the user in the sub provider 14 from the Union merge provider 13.

The example of the authentication ticket issue request from the Union merge provider 13 to the sub provider 14 will be describes later with reference to FIG. 30.

Following the step S50, the process proceeds to the step S51 and the ID password analyzing part 143 determines whether or not the ID and password included in the issue request of the authentication ticket 600 received in the step S50 are in a valid combination, by confirming with the directory 150 via the directory operation wrapper 141.

When it is determined that the combination is valid combination, (YES in step S51), the process proceeds to the step S53, while when it is determined that the combination is not a valid combination (NO in step S51), the process proceeds to the step S52.

In the step S52, the XML processing part 131 of the sub provider 14 creates the authentication ticket issue response indicating that the creation of the authentication ticket 600 has been failed, and transmits the same to the Union merge provider 13.

In the step S53, the authentication ticket managing part 144 acquires the user information corresponding to the ID from the directory 150 via the directory operation wrapper 141.

Following the step S53, the process proceeds to the step S54, the authentication ticket managing part 144 creates the authentication ticket 600 certifying the user in the sub provider 14.

Following the step S54, the process proceeds to the step S55, and the XML processing part 131 of the sub provider 14 creates the authentication ticket issue response including the authentication ticket ID 610 of the authentication ticket 600 created in the step S54 and transmits the same to the Union merge provider 13.

As we mentioned above, the example of the authentication ticket issue response from the sub provider 14 to the Union merge provider 13 will be described later with reference to FIG. 31.

It should be noted that the step S44 of FIG. 27 receives the authentication ticket issue response transmitted in the step S52 or step S55 of FIG. 28.

FIG. 29 is an example of the XML message of an authentication ticket issue request from the client to the Union merge provider.

As shown in FIG. 29, the issue request of the authentication ticket 500 from the client (Web portal, for example) to the Union merge provider 13 includes the domain name in the tag <domainName></domainName> and the user name in the tag <Name></Name>, and the password in the tag <passwd></passwd>.

The client (Web portal, for example) transmits the issue request of the authentication ticket 500 that contains the domain name, the user name and the password to the Union merge provider 13.

FIG. 30 is an example of the XML message of an authentication ticket issue request from an Union merge provider to sub provider.

As shown in FIG. 30, the Union merge provider 13 transmits the issue request for the authentication ticket 600 certifying the user in the sub provider 14 and containing the domain name and the user name and the password included in the issue request of the authentication ticket 500 transmitted from the client (Web portal, for example) as they are, to the sub provider 14.

FIG. 31 is an example of the XML message of an authentication ticket issue response to the Union merge provider from the sub provider.

As shown in FIG. 31, the authentication ticket issue response from the sub provider 14 to the Union merge provider 13 includes the authentication ticket ID 610 of the authentication ticket 600 created in the sub provider 14 in the tag <authTicket></authTicket>.

The sub provider 14 creates the authentication ticket 600 that certifies the user in the sub provider 14 when the authentication has been succeeded transmits the authentication ticket issue response including the authentication ticket ID 610 of the authentication ticket 600 to the Union merge provider 13.

FIG. 32 is an example of the XML message of an authentication ticket issue response from the Union merge provider to the client.

As shown in FIG. 32 the authentication ticket issue response from the Union merge provider 13 to the client (Web portal, for example) in the tag of <authTicket></authTicket>.

The Union merge provider 13 creates the authentication ticket 500 certifying the user in the Union merge provider explained in FIG. 26 when it has acquired the authentication ticket ID 610 of the authentication ticket 600 crated in the sub provider 14 from sub provider 14 as explained in FIG. 31, the authentication ticket issue response including authentication ticket ID510 of said authentication ticket 500 is transmitted to the client (Web portal, for example).

Hereinafter, the processing of the Union merge provider 13 and the sub provider 14 for the case the confirmation request of the authentication ticket ID 510 transmitted in the above-mentioned authentication ticket issue response has been transmitted from the client (application, for example).

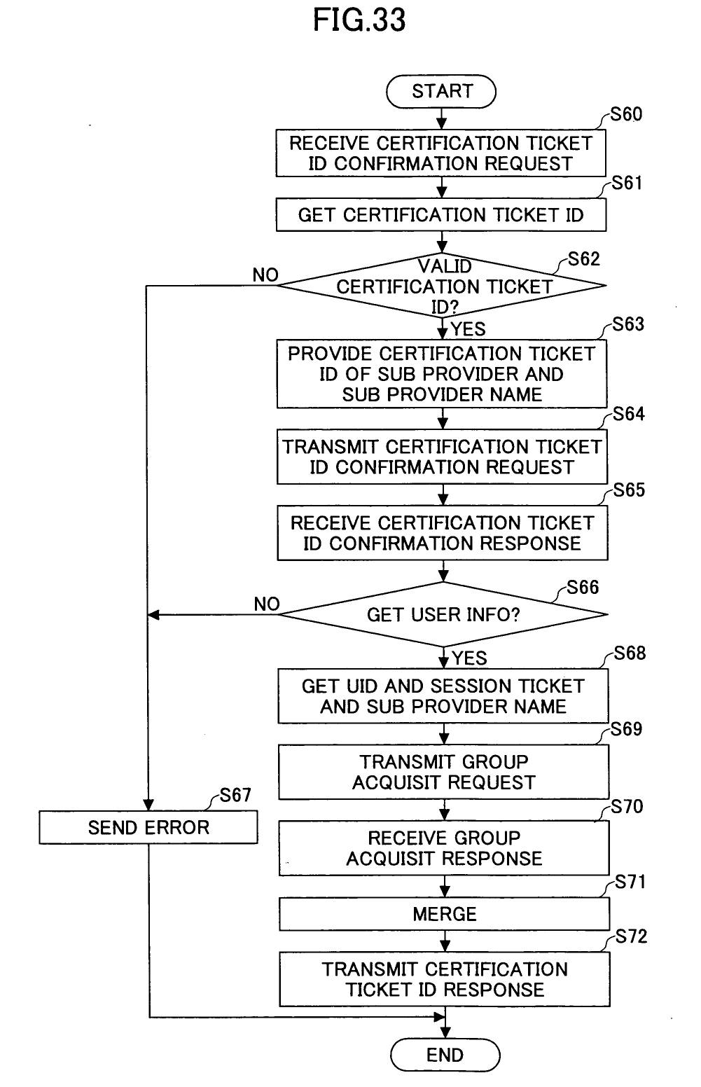

FIG. 33 is the flowchart showing an example of the authentication ticket ID confirmation processing in the Union merge provider.

In the step S60, the XML processing part 131 of the Union merge provider 13 receives the confirmation request of the authentication ticket ID 510 from the client (application, for example).

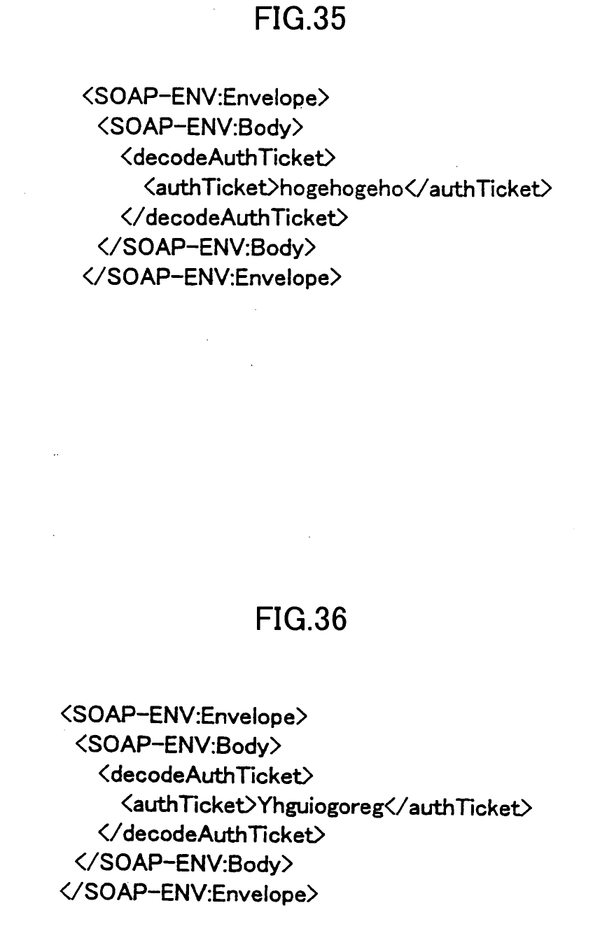

The example of the authentication ticket ID confirmation request from the client (application, for example) to the Union merge provider 13 will be described later with reference to FIG. 35.

Following the step S60, the process proceeds to step S61, and the authentication ticket managing part 139 acquires the authentication ticket ID510 included in the confirmation request of the authentication ticket ID 510 received in the step S60.

Following the step S61, the process proceeds to the step S62, and authentication ticket managing part 139 determines whether or not the authentication ticket ID510 acquired in the step S61 is a valid authentication ticket ID 510.

When it is determined that it is a valid authentication ticket ID510 (YES in step S62), the process proceeds to the step S63, while when it is determined that it is not a valid authentication ticket ID510 (NO in step S62), the process proceeds to the step S67.

In the step S63, the authentication ticket managing part 139 forwards the authentication ticket ID 610 of the authentication ticket 600 of the sub provider 14 included in the authentication ticket 500 of the Union merge provider 13 and the sub provider name to sub provider calling part 134.

Following the step S63, the process proceeds to the step S64, and the merge provider XML processing part 135 creates the authentication ticket ID confirmation request for the sub provider 14 including the authentication ticket ID610, by using the authentication ticket ID610 of the authentication ticket 600 of the sub provider 14 acquired via the sub provider calling part 134, and transmits the same to the sub provider 14.

The example of the authentication ticket ID confirmation request from the Union merge provider 13 to the sub provider 14 will be described later with reference to FIG. 36.

Following the step S64, the process proceeds to the step S65, and the sub provider calling part 134 receives the confirmation response of the authentication ticket ID 610 from the sub provider 14 that has transmitted the above-mentioned authentication ticket ID confirmation request via the merge provider XML processing part 135.

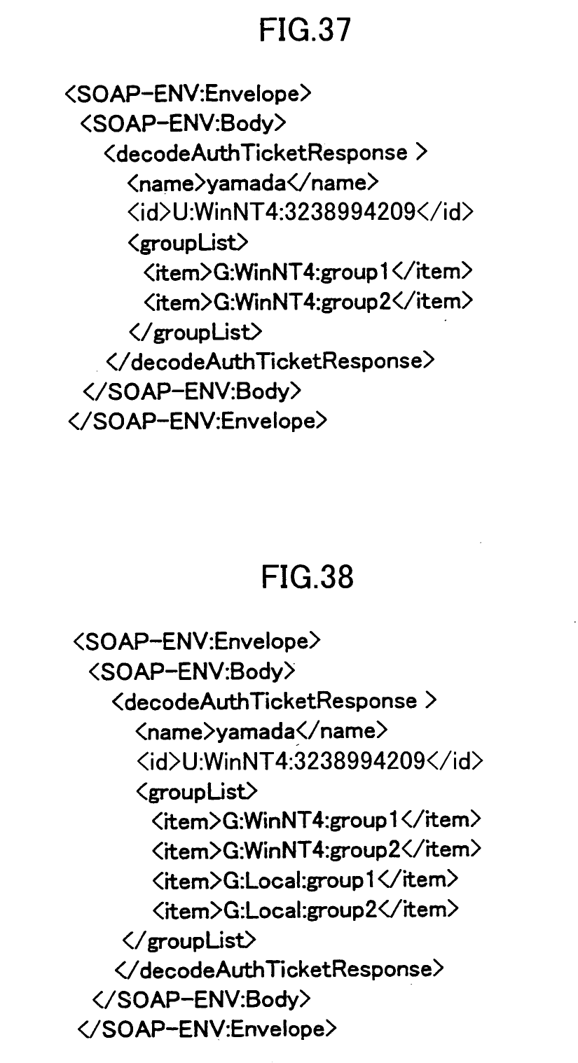

The example of the authentication ticket ID confirmation response from the sub provider 14 to the Union merge provider 13 will be described later with reference to FIG. 37.

Following the step S65, the process proceeds to the step S66, and the sub provider calling part 134 determines whether or not the user information is included in the confirmation response of the authentication ticket ID 610 received in the step S65.

When it is determined that the user information is contained (YES in step S66), the process proceeds to the step S68, while when it is determined that the user information is not contained (NO in step S66), the process proceeds to the step S67.

In the step S67, the XML processing part 131 of the Union merge provider 13 creates the response indicating that the confirmation of authentication ticket ID 510 has failed, and transmits the same to the client (application, for example).

In the step S68, the sub provider calling part 134 acquires the UID included in the user information acquired in the step S66 and the session ticket ID 310 of the session ticket 300 for each of the sub providers 14 and the sub provider name managed in the session managing part 137 and provides the same to the merge provider XML processing part 135.

In the Step S69, the merge provider XML processing part 135 creates the acquisition request of the group to which the user belongs and includes the UID identifying the user and the session ticket ID 310 of the session ticket 300 for each of the sub providers 14, as explained in the Example 1, and transmit the same to each sub provider 14.

Following the step S69, the process proceeds to the step S70, and the sub provider calling part 134 receives the group acquisition response for the group acquisition request from each of the sub providers 14 via the merge provider XML processing part 135.

Following the step S70, the process proceeds to the step S71, and the merge processing part 133 merges the user information acquired in the step S66 and the group information of the group to which the user belongs and contained in the user group acquisition response acquired in the step S70.

Following the step S71, the process proceeds to the step S72, and the XML processing part 131 of the Union merge provider 13 creates the authentication ticket ID confirmation response including the user information and the group information of the group to which the user belongs and merged in the step S71 and transmits to the client (application for example).

The example of the authentication ticket ID confirmation response from the Union merge provider 13 to the client will be described later with reference to FIG. 38.

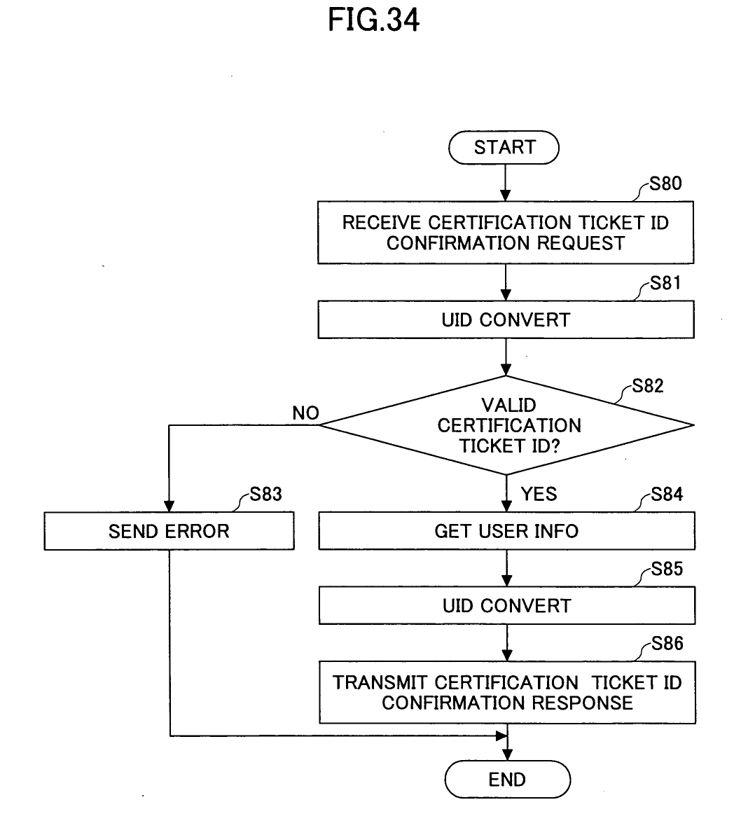

FIG. 34 is a flowchart showing an example of the authentication ticket ID confirmation processing in a sub provider.

The sub provider 14 starts the processing from the step S80 explained below, when the Union merge provider 13 has transmitted the confirmation request for the authentication ticket ID 610 in the sub provider 14 in the step S64 of FIG. 33.

In the step S80, the XML processing part 131 of the sub provider 14 receives the confirmation request of the authentication ticket ID610 from the Union merge provider 13.

As mentioned above the example of the authentication ticket ID confirmation request from the Union merge provider 13 to the sub provider 14 will be described later with reference to FIG. 36.

Following the step S80, the process proceeds to the step S81, and the UID conversion part 132 of the sub provider 14 converts the UID included in the confirmation request of the authentication ticket ID610 received in the step S80 into the UID pertinent to the directory 150.

Following the step S81, the process proceeds to the step S82, and the authentication ticket managing part 144 determines whether or not the authentication ticket ID 610 contained in the confirmation request of the authentication ticket ID610 received in the step S80 is the valid authentication ticket ID 610 of a valid authentication ticket 600.

When it is determined that it is the authentication ticket ID 610 of a valid authentication ticket 600 (YES in step S82), the process proceeds to the step S84, while when it is determined that it is the authentication ticket ID 610 of an invalid authentication ticket 600 (NO in step S82), the process proceeds to the step S83.

In the step S83, the XML processing part 131 of the sub provider 14 creates the authentication ticket ID confirmation response indicating that the confirmation of the authentication ticket ID 610 has failed and transmits the same to the Union merge provider 13.

In the step S84, the sub provider 14 acquires the user information from the directory 150 via the directory operation wrapper 141.

Following the step S84, the process proceeds to the step S85, and the UID conversion part 132 of the sub provider 14 converts the UID peculiar to the directory 150 into an UID available in the Union merge provider 13.

Following the step S85, the process proceeds to the step S86, and the XML processing part 131 of the sub provider 14 creates the authentication ticket ID confirmation response including the user information acquired in the step S84 and transmits the same to the Union merge provider 13.

As we mentioned above, the example of the authentication ticket ID confirmation response from the sub provider 14 to the Union merge provider 13 will be described later with reference to FIG. 37.

It should be noted that the step S65 of FIG. 33 receives the authentication ticket ID confirmation response transmitted in the step S83 or the step S86 of FIG. 34.

FIG. 35 is an example of the XML message of an authentication ticket ID confirmation request from the client to the Union merge provider.

As shown in FIG. 35, the authentication ticket ID confirmation request from the client (application, for example) to the Union merge provider 13 includes, in the tag of <authTicket></authTicket>, the authentication ticket ID 510 of the authentication ticket 500 that certifies the user in the Union merge provider 13.

The client (application, for example) transmits the confirmation request of the authentication ticket ID510 including the authentication ticket ID510 of the authentication ticket 500 certifying the user in the Union merge provider 13, to the Union merge provider 13.

FIG. 36 is an example of the XML message of an authentication ticket ID confirmation request transmitted from the Union merge provider to the sub provider.

As shown in FIG. 36, the authentication ticket ID confirmation request from the Union merge provider 13 to the sub provider 14 includes, in the tag <authTicket></authTicket>, the authentication ticket ID610 of the authentication ticket 600 that certifies the user in the sub provider 14.

Because the Union merge provider 13 manages the authentication ticket 600 of the sub provider 14 succeeded in the authentication in the form included in the authentication ticket 500 of that Union merge provider 13 as explained with reference to FIG. 26, it becomes possible to acquire the authentication ticket ID610 of the authentication ticket 600 of the sub provider 14, which has succeeded in the authentication, and include the authentication ticket ID610 in the XML message based on the authentication ticket ID 510 of the authentication ticket 500 of the Union merge provider 13 included in the authentication ticket confirmation request transmitted from the client (application, for example).

FIG. 37 is an example of the XML message of the authentication ticket ID confirmation response to the Union merge provider from the sub provider.

As shown in FIG. 37, the confirmation response of the authentication ticket ID 610 from the sub provider 14 to the Union merge provider 13 includes the user name in the tag of <Name></name>, the UID of the user in the tag <Id></id>, the group information of the group to which the user belongs in sub provider 14 in each tag of <item></item> included in the tag <groupList></groupList>.

The sub provider 14 acquires the group information of the group to which the user belongs from the directory 150 in the event there exist the user information and the group to which the user belongs, and transmits the same to the Union merge provider 13.

FIG. 38 is an example of the XML message of the authentication ticket ID confirmation response from the Union merge provider to the client.

As shown in FIG. 38, the Union merge provider 13 includes the name of the user in the tag <Name></name>, the UID of the user in the tag <Id></id>, and the group information acquired from each of the sub providers 14 in one or more tags of <item></item> included in a tag <groupList></groupList>, and transmits the same to the client.

As explained in FIG. 37, the Union merge provider 13 can acquire the UID from one of the sub providers 14, and because of this, it becomes possible to acquire the group information of the group to which the user belongs from of the sub providers 14 as explained in Example 1 by using the UID and the session ID 310 of the session ticket 300 of the sub provider 14, to which the registration has been made.

As explained with Example 2, even in the case that sub provider 14 has required the authentication, it is possible to acquire the group information to which the user belongs from all of the sub providers 14, by merely transmitting the user name and the password once to the Union merge provider 13 for authentication.

In the explanation of Example 2, explanation has been made for the case that authentication ticket ID 510 and/or the authentication ticket ID 610 are transmitted and received between the Union merge provider 13 and the sub provider 14 and the Union merge provider 13 and client, this does not limit the invention and it is possible to transmit and receive the authentication ticket 500 and/or the authentication ticket 600 as well. This applied also to the description below.

Also, in both Example 1 and Example 2, explanation has been made for the case the directory 150 is independent from the sub provider 14, it is possible to construct each of the sub providers 14 to include the directory 150 therein.

For the sake of simplicity of explanation, the description hereinafter will be made for the case the directory 150 is included in each of the sub providers 14.

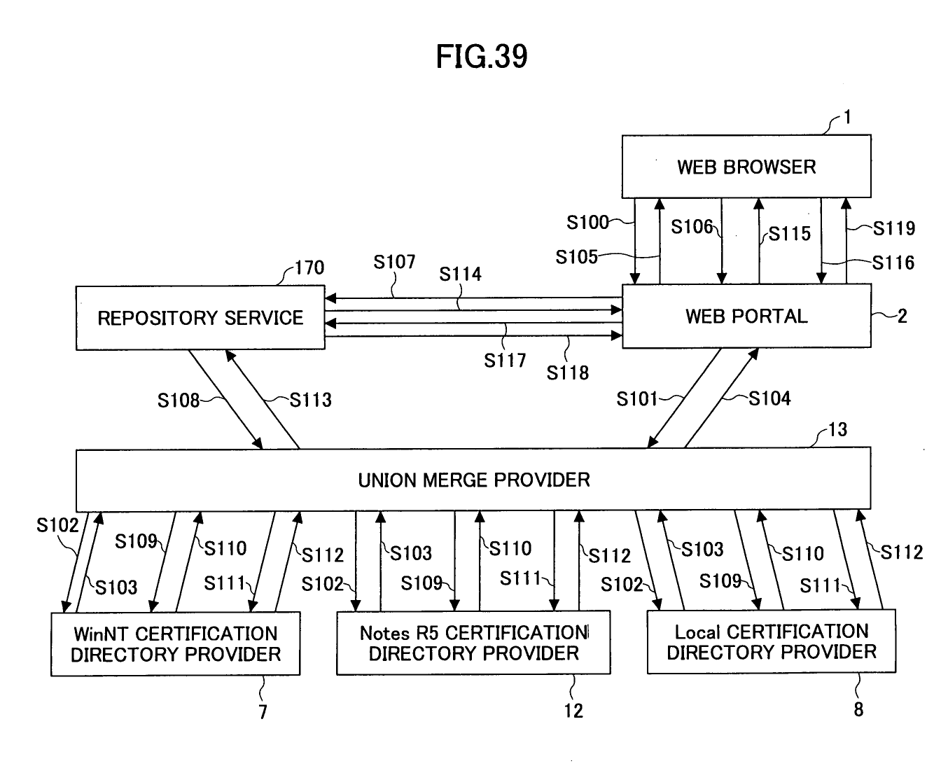

Hereinafter, the example of introducing the Union merge provider 13 will be explained with reference to FIG. 39.

FIG. 39 is a diagram for explaining the example of conducting the authentication of the user by utilizing the Union merge provider and acquiring the accumulation document accumulated in the repository service.

In the step S100, the log-in name and the password input by the user are transmitted from the Web browser 1 to the Web portal 2.

Following the step S100, the process proceeds to the step S101, and the Web portal 2 transmits the issue request of the authentication ticket 500 in the Union merge provider 13 and containing the log-in name and the password received in the step S1 to the Union merge provider 13.

Following the step S101, the process proceeds to the step S102, and the Union merge provider 13 transmits the request of issuing the authentication ticket 600 in the sub provider 14 containing the above-mentioned log-in name and the password to the WinNT authentication directory provider 7, the Notes (trade mark) R5 authentication directory provider 12 and the Local authentication directory provider 8 that constitute the sub providers 14.

The WinNT authentication directory provider 7, the Notes (trade mark) R5 authentication directory provider 12 and the Local authentication directory provider 8 constituting sub providers 14 carries out the authentication by using the log-in name and the password, and issues the authentication ticket 600 in the case the authentication has been succeeded

Following the step S102, the process proceeds to the step S103, and the WinNT authentication directory provider 7, the Notes (trade mark) R5 authentication directory provider 12 and the Local authentication directory provider 8 constituting the sub providers 14 creates the authentication ticket issue response to the authentication ticket issue request and transmits the same to the Union merge provider 13.

For example, in the case the user has input the log-in name and the password of WinNT to the Web browser 1, the authentication succeeds in the WinNT authentication directory provider 7 and the authentication ticket 600 is issued.

In this case, the authentication ticket ID 610 of the authentication ticket 600 thus issued is included in the authentication ticket issue response transmitted to the Union merge provider 13 from the WinNT authentication directory provider 7, while the authentication ticket issue response transmitted to the Union merge provider 13 from other sub providers 14 includes the information indicating that creation of the authentication ticket 600 has failed.

Following the step S103, the process proceeds to the step S104, and the Union merge provider 13 creates the authentication ticket 500 certifying the user in the Union merge provider 13 upon acquisition of the authentication ticket issue response was containing the authentication ticket ID 610 from one of the sub providers 14 and transmits the authentication ticket issue response including the authentication ticket ID 510 of the authentication ticket 500 thus issued to the Web portal 2.

Following the step S104, the process proceeds to the step S105, and the Web portal 2 transmits the information indicating that the authentication has been made successfully to the Web browser 1

Following the step S105, the process proceeds to the step S106, and the Web browser 1 transmits the use start request indicating the use of the services provided by the repository service 170 to the Web portal 2.

Following the step S106, the process proceeds to the step S107, and the Web portal 2 transmits the issue request of the session ticket 700 that permits the use of the services and including the authentication ticket ID 510 of the authentication ticket 500 that certifies the user in the Union merge provider 13 and acquired in the step S104, to the repository service 170.

Following the step S107, the process proceeds to the step S108, and the repository service 170 transmits the authentication ticket ID confirmation request including the authentication ticket ID 510 included in the issue request of the above-mentioned session ticket 700 to the Union merge provider 13, in order to confirm whether or not the issue request of the session ticket 700 received in the step S107 is the request from a valid user.

Following the step S108, the process proceeds to the step S109, and the Union merge provider 13 transmits the confirmation request of the authentication ticket ID 610 acquired from one of the sub providers 14 to the sub provider 14 in the step S103.

Because the Union merge provider 13 holds the information which sub provider 14 has succeeded in the authentication in the step S103, it is possible to construct such that the confirmation request of authentication ticket ID610 is transmitted only to sub provider 14 in which the authentication has been succeeded.

Following the step S109, the process proceeds to the step S110, and the WinNT authentication directory provider 7, the Notes (trade mark) R5 authentication directory provider 12 and the Local authentication directory provider 8 constituting the sub providers 14 transmit the confirmation response of the authentication ticket ID 610 to the Union merge provider 13 in response to the confirmation request of the authentication ticket ID 610.

For example, in the case the sub provider 14 that has succeeded in the authentication is the WinNT authentication directory provider 7, the WinNT authentication directory provider 7 transmits the confirmation response of the authentication ticket ID 610 including the UID of the user corresponding to the authentication ticket ID 610 to the Union merge provider 13.

Following the step S110, the process proceeds to the step S111, and the Union merge provider 13 transmits the acquisition request of the group information of the group to which the user corresponding to the UID belongs and containing the UID acquired in the step S110 and the session ticket ID 310 of the session ticket 300 for each of the sub providers 14, to each of the sub providers 14.

Following the step S111, the process proceeds to the step S112, and each sub provider 14 creates the acquisition response including the group information of the group to which the user corresponding to the acquired UID belongs and transmits the same to the Union merge provider 13.

Following the step S112, the process proceeds to the step S113, and the Union merge provider 13 merges the user information acquired in step S110 and the group information of the group to which the user belongs and acquired in the step S112 and creates the authentication ticket ID confirmation response including the merged information, and transmits the same to the repository service 170.

Following the step S113, the process proceeds to the step S114, and the repository service 170 creates, when there exists a group in the groups acquired in the step S113 permitting the use of the service provided by that repository service 170, for example, the session ticket 700 that permits the use of the service, and transmits the issue response of the session ticket including the session ticket ID 710 of the session ticket 700 to the Web portal 2.

Following the step S114, the process proceeds to the step S115, and the Web portal 2 transmits the response indicating that the use start of the service has been permitted to the Web browser 1.

Following the step S115, the process proceeds to the step S116, and the Web browser 1 transmits the request indicating that the accumulation document that the repository service 170 has accumulated is going to be acquired to the Web portal 2.

Following the step S116, the process proceeds to the step S117, and the Web portal 2 transmits the acquisition request of the accumulation document including the session ticket ID 710 of the session ticket 700 acquired in the step S114 to the repository service 170.

Following the step S117, the process proceeds to the step S118, and the repository service 170 determines whether or not the session ticket ID 710 included in the acquisition request for the accumulation document acquired in the step S117 is the session ticket ID 710 of a valid session ticket 700, and when it is determined that it a valid session ticket ID 710, the repository service 170 transmits the acquisition response of the accumulation document including the designated accumulation document, to the Web portal 2.

Following the step S118, the process proceeds to the step S119, and the Web portal 2 transmits the accumulation document that has been acquired in the step S118 to the Web browser 1.

As mentioned above, even in the case that the authority for acquiring the document accumulated in the repository service 170 is given only to the group registered to the Local authentication directory provider 8, it becomes possible, by introducing the Union merge provider 13, that a the user certified with the WinNT authentication directory provider 7 can acquire the document accumulated in the repository service 170 in the case the same user belongs the group of the l authentication directory provider 8 because of the fact that the Union merge provider 13 can manage the information of the group of other sub providers 14 to which the same user belongs in the merged state.

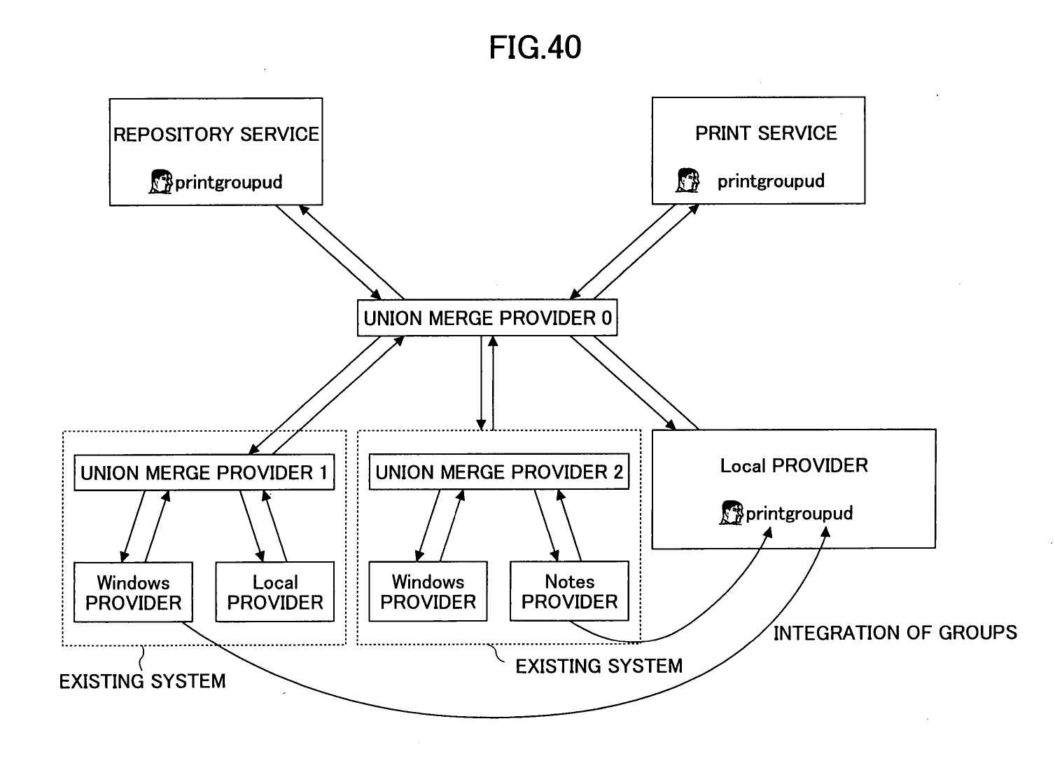

FIG. 40 is a diagram for explaining the example of integration for the case there exist plural Union merge providers.

As explained with reference to FIG. 17, the Union merge provider 13 has the session ticket 200 with a hierarchical structure, and because of this, it is possible to integrate, in the case that the system having the Union merge provider 13 exists in plural numbers as shown in FIG. 40, these systems into a new group by introducing a Union merge provider 13 (Union merge provider 0 of FIG. 40).

### EXAMPLE 3

Hereinafter, the example of taking out the information (construction information) regarding the Union merge provider 13 and the sub provider 14 to the outside of the Union merge provider 13 for holding and managing in the configuration manager 22 to be described later will be explained.

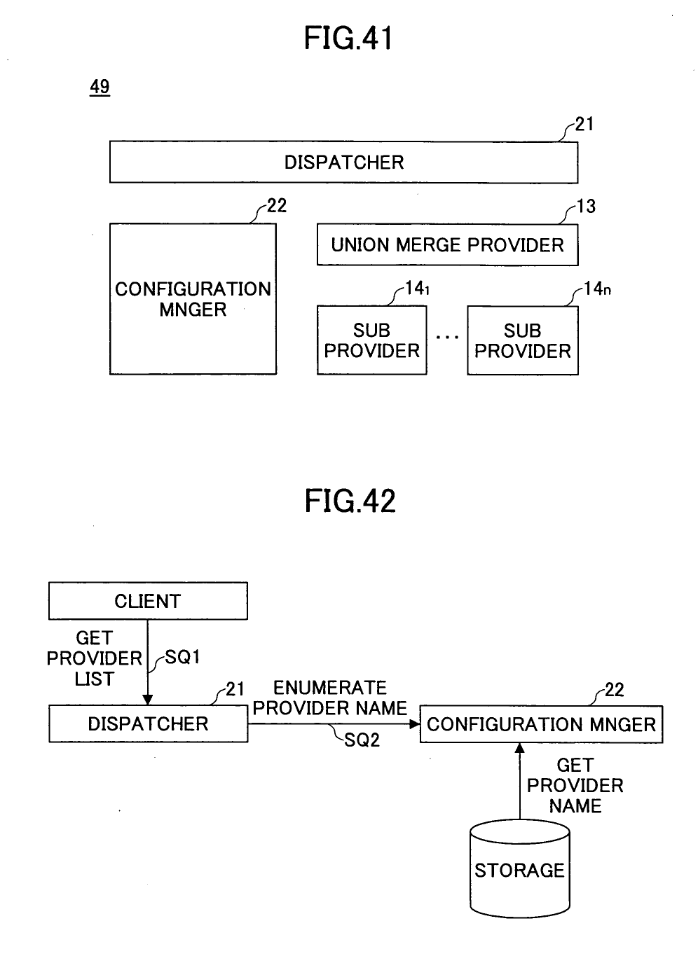

FIG. 41 is a fourth diagram for explaining the construction of the UCS.

In FIG. 41, the explanation will be made based on the assumption that all of the sub providers 14 and the Union merge provider 13 are included in the UCS 49 as noted before with reference to FIG. 13 for the sake of simplicity of explanation. As noted before, a part or all of the sub providers 14 may be included in other fusion machine 120.

It should be noted that the UCS 49 shown in FIG. 41 contains the dispatcher 21, the configuration manager 22, the Union merge provider 13 and the sub providers 14₁-14ₙ.

The dispatcher 21 receives the request from the client and distributes the same to the configuration manager 22 or the Union merge provider 13, or transmits the processing result of the configuration manager 22 and the Union merge provider 13 processed according to the distribution request to the client.

The configuration manager 22 is s managing part managing the construction of the Union merge provider 13 and the sub providers 14₁-14ₙ and holds the construction information, and the like, in the storage part.

Here, it should be noted that the Union merge provider 13 and the sub provider 14 are identical to those explained with reference to Example 1 or Example 2.

Hereinafter, the example of the provider list acquisition sequence will be explained with reference to FIG. 42, wherein it should be noted that FIG. 42 is a diagram for explaining the example of the provider list acquisition sequence.

As shown in FIG. 42, the client transmits, in the example of adding a new provider as the sub provider 14 of the Union merge provider 13, transmits the provider list acquisition request including the getProviderList method of the dispatcher 21, to the dispatcher 21 (Sequence SQ1).

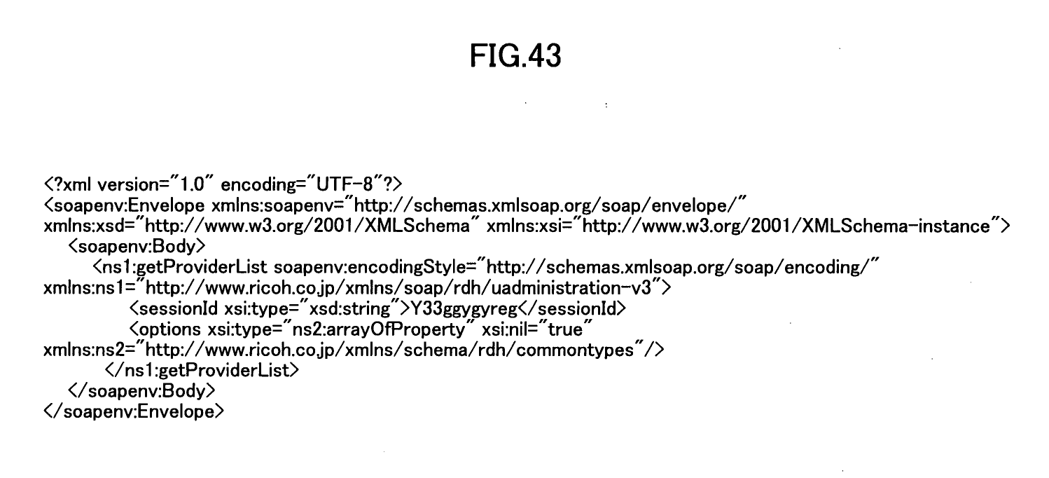

The example of the provider list acquisition request will be explained later with reference to FIG. 43.

The dispatcher 21 that has received the provider list acquisition request calls the enumerateProviderName method of the configuration manager 22 (Sequence SQ2).

The configuration rations manager 22 that has been subjected to the call of the enumerateProviderName method acquires the provider name, and the like, from the storage part and returns the same to the dispatcher 21 as the provider list.

The dispatcher 21 creates the provider list acquisition response including the provider list and transmits the same to the requesting client.

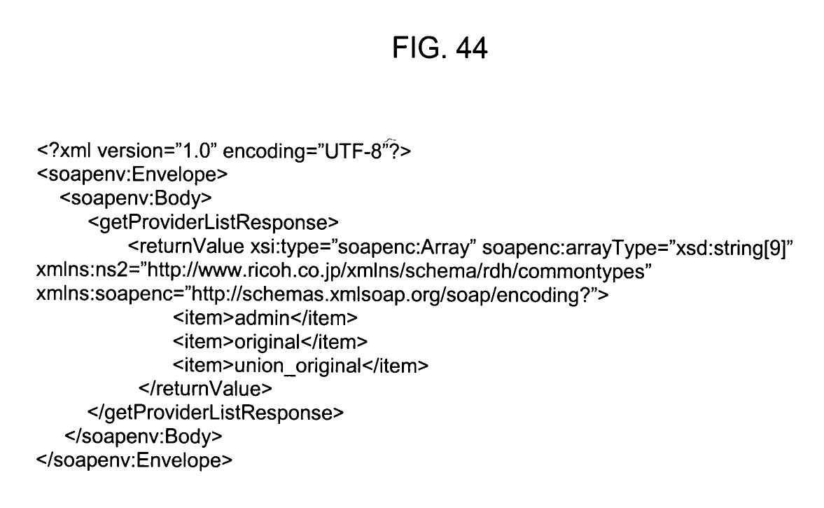

The example of the provider list acquisition response will be explained later with reference to FIG. 44.

For example, by conducting the processing shown in FIG. 42, the client displays the list of the providers and the user can select the provider to be added newly from the list of the providers as the sub provider 14 of the Union merge provider 13

Hereinafter, the example of the provider list acquisition request will be shown with reference to FIG. 43, wherein FIG. 43 is an example of the the XML message of a provider list acquisition request from the client to the dispatcher.

As shown in FIG. 43, it can be seen that the getProviderList method is included in the provider list acquisition request.

Hereinafter, an example of the provider list acquisition response will be described with reference to FIG. 44, wherein FIG. 44 is an example of the XML message of the provider list acquisition response from the dispatcher to the client.

As shown in FIG. 44, the name of the provider (or the identifier distinguishing the provider) is stored in the tag of <item></item>.

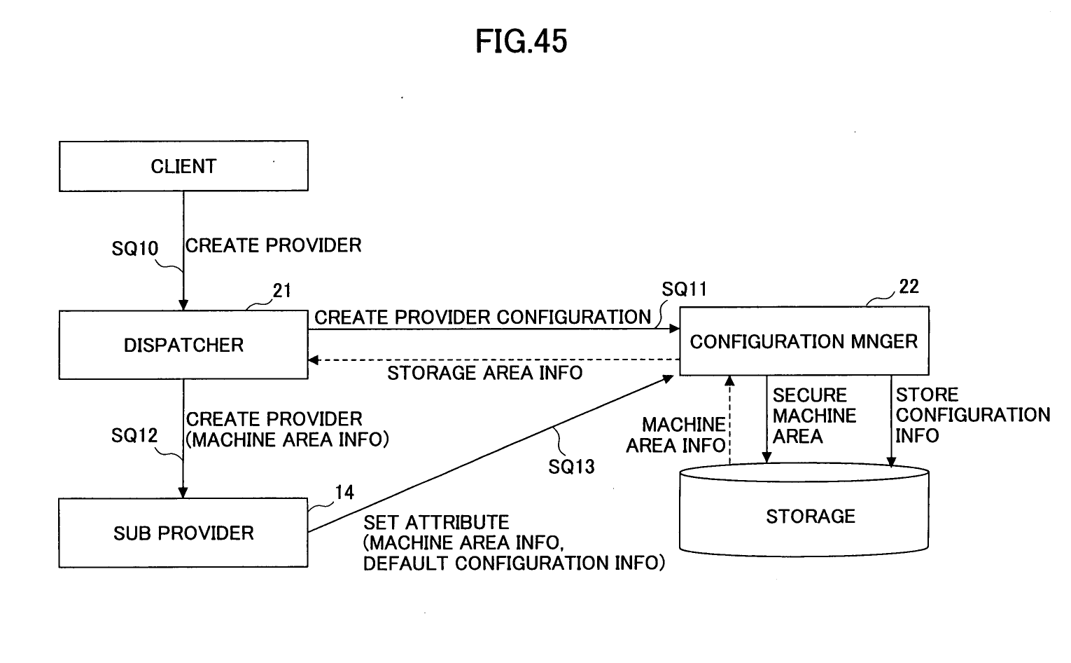

Next, an example of the sub provider addition sequence will be explained with reference to FIG. 45, wherein FIG. 45 is a diagram explaining the example of the sub provider addition sequence.

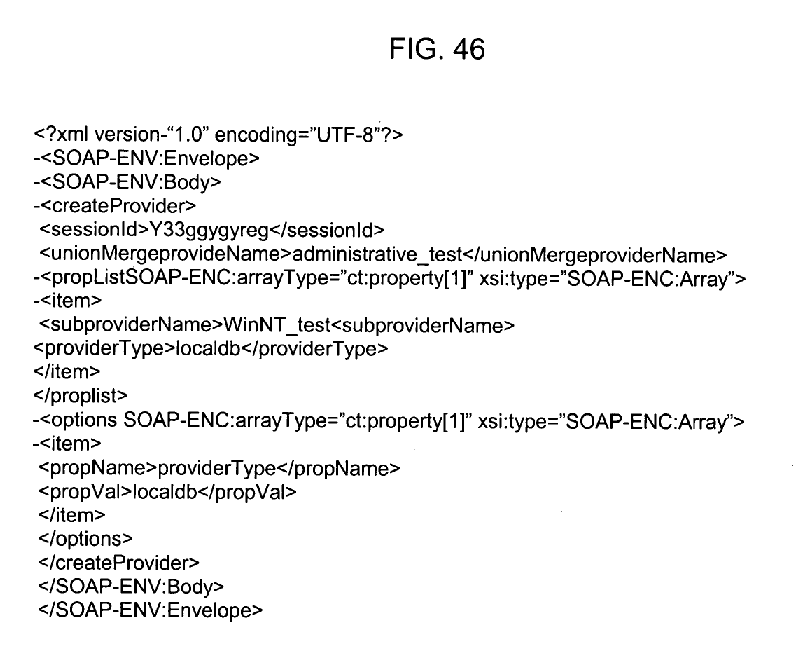

When the user has selected the provider to be added from the provider list as shown in FIG. 45 by using a GUI (Graphical User Interface) to be described later, the client transmits the sub provider addition request including the createProvider method of dispatcher 21 to the dispatcher 21 (sequence SQ10). Here, the example of the sub provider addition request will be shown later with reference to FIG. 46. While being omitted in FIG. 45, the sub provider addition request includes the information as to what sub provider 14 is to be added to what Union merge providers 13.

The dispatcher 21 that has received the sub provider addition request calls the createProviderConfiguration method of the configuration manager 22 (sequence SQ11).

The configuration manager 22 called by the createProviderConfiguration method secures a new region in the storage part for storing the construction information and returns the storage area information regarding that region. (head address, and the like of the newly secured region) to the dispatcher 21.

The dispatcher 21 that has thus acquired the storage area information calls the createProvider method of the sub provider 14 to be added while using the storage area information as the argument (Sequence SQ12).

The sub provider 14 having the createProvider method thus called calls the setAttribute method of the configuration manager 22 (Sequence SQ13) while using the storage area information provided as the argument of the createProvider method and further the default construction information of the identifier, the name of the sub provider 14, and the like, as the argument.

The configuration manager 22 having the setAttribute method thus called stores the construction information including the default construction information of the sub provider 14 given as the argument of the setAttribute method in a corresponding storage region based on the storage area information given as the argument of the setAttribute method.

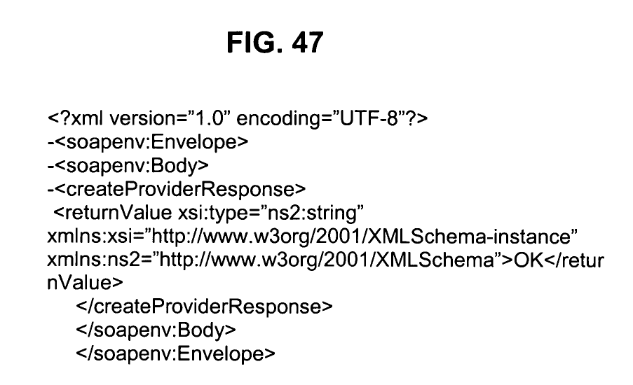

The dispatcher 21 received the information indicating that the construction information has been stored from the configuration manager 22 creates the sub provider addition response including the information indicating that the addition of the provider has completed normally, and transmits the same to the requesting client. The example of the sub provider addition response will be shown later with reference to in FIG. 47.

By conducting the processing shown in FIG. 45, it is possible to add a new provider as the sub provider 14 of the Union merge provider 13.

Hereinafter, the example of the sub provider addition request will be explained with reference to FIG. 46, wherein FIG. 46 is the XML message of a sub provider addition request from the client to the dispatcher.

As shown in FIG. 46, the sub provider addition request includes the createProvider method. Further, the identifier or the name of the Union merge provider is included in the tag <unionMergeproviderName></unionMergeproviderName> as, the argument of the createProvider method. Also, the identifier or the name of the sub provider to be newly added is included in <subproviderName></subproviderName> of the <item></item> tag.

Hereinafter, the example of the sub provider addition response will be explained with reference to FIG. 47, wherein FIG. 47 is the XML message of a sub provider addition response from the dispatcher to the client.

As shown in FIG. 47, the tag <returnValue></returnValue> of the sub provider addition response includes the information representing whether or not the addition of the sub provider has been successful (O.K. in the example of FIG. 47).

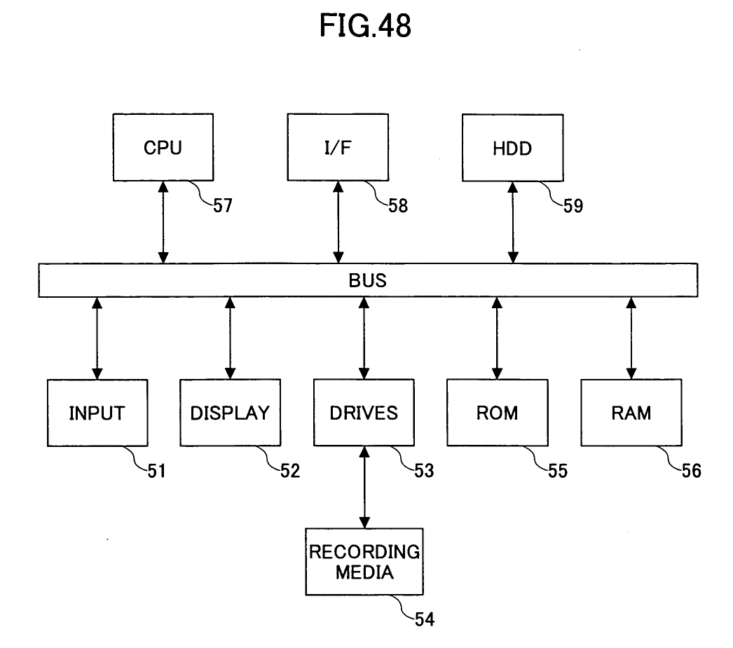

Hereinafter, an example of the hardware construction of the client will be explained with reference to FIG. 48, wherein FIG. 48 is the hardware construction diagram of a client.

The hardware construction of the client shown in FIG. 48 is formed of an input device 51,

a display device 52, a drive device 53, a recording medium 54, a ROM55, a RAM56, a CPU57, an interface device 58 and a HDD59 connected with each other by a bus.

The input device 51 is formed of a keyboard, mouse, and the like operated by the user of the client and is used for inputting the various operational signals to the client. On the other hand, the display device 52 is formed of a display, and the like, used by the user of the client and is used for displaying various information. The interface device 58 is an interface connecting the client to the network 5, and the like.

For example, the application program, and the like used for implementing the processing in the client is provided to the client by the recording medium 54 of the CD-ROM, and the like, or downloaded through the network 5. The recording medium 54 is set to the drive device 53 and the application program is installed to the HDD 59 from the recording medium 54 through the drive device 53.

The ROM 55 stores the data, and the like. The RAM56 reads the application program, and the like, from the HDD 59 at the time of the activation of the client and holds the same. The CPU57 carries out the processing according to the application program, and the like, read out to the RAM 56 and held therein. Further, the HDD 59 stores the data, files, and the like.

Although the foregoing explanation has been made by using the fusion machine 120 as an example of the apparatus on which the Union merge provider 13 and/or the sub provider 14 are mounted, it is also possible to construct so as to be mounted on a PC (personal computer) shown in FIG. 48.

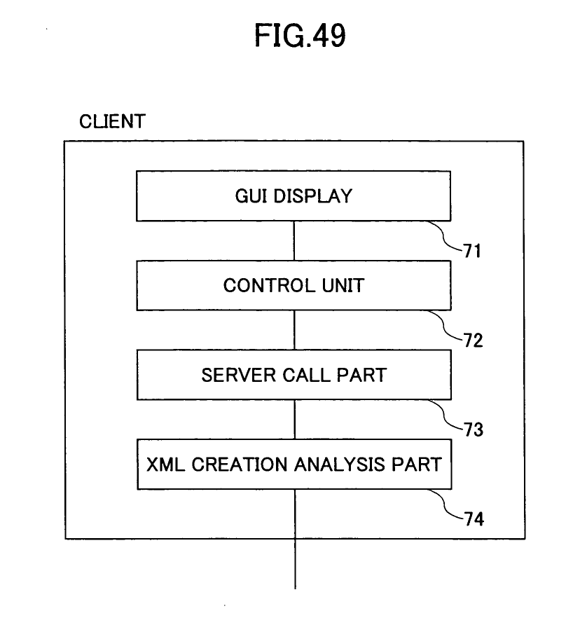

Hereinafter, an example of the function of the client will be explained with reference to FIG. 49, wherein FIG. 49 is a functional block diagram of a client.

As shown in FIG. 49, the client includes the GUI display part 71, a control unit 72, a server calling part 73 and a XML generation analysis part 74.

The GUI display part 71 is the display part creating GUI to be describes later and displaying the same in the display, and the like, of the client. The control unit 72 is the control unit that controls the overall processing of the client. The server calling part 73 is the calling part that calls the server including the Union merge provider 13, and the like. Further, the XML generation analysis part 74 generates the XML and transmits the same to the server and further analyzes the XML message received from the server and acquires the data, and the like included in the XML message.

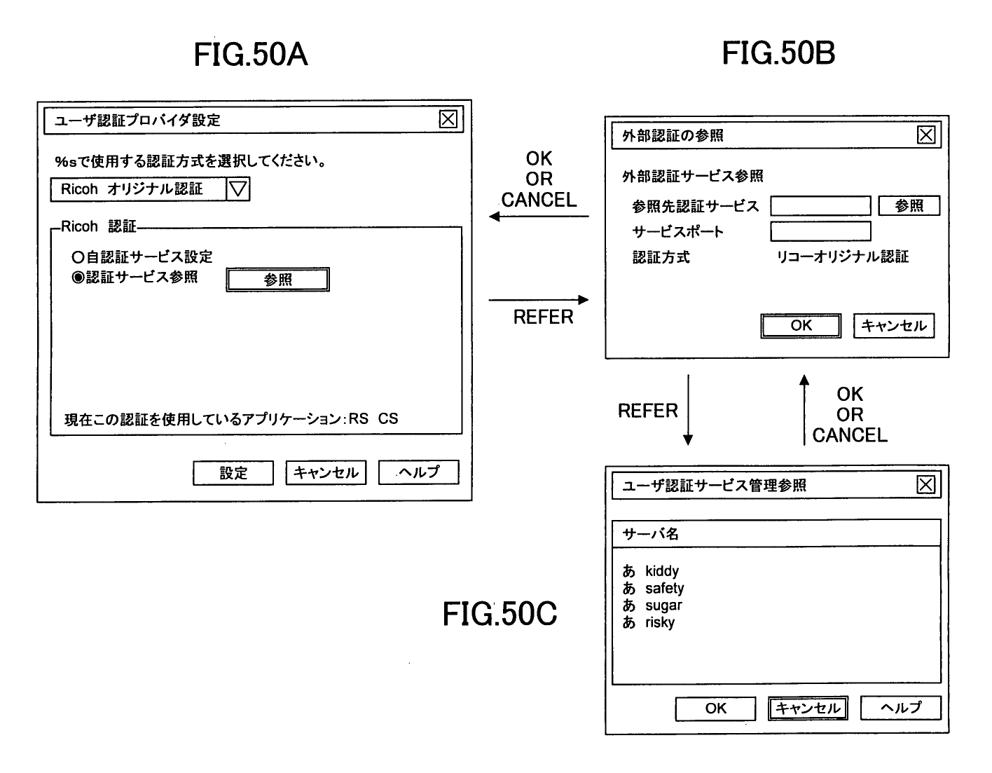

Hereinafter, an example of the GUI for setting up the provider in the client will be shown in FIG. 50, wherein FIG. 50 is a first diagram showing the GUI regarding the setting up of the provider in the client.

The client creates, when the provider list acquisition response shown in FIG. 44 is received, the user authentication provider setting screen that contains the list of the provider in the drop down menu as shown in FIG. 50A based on the list of the providers included in the provider list acquisition response and displays the same.

It should be noted that the content of the group box displayed under the drop down menu of the user authentication provider setting screen shown in FIG. 50A changes by the provider which the user has selected from the drop down menu.

For example, when the user has selected “authentication service reference” and clicked the “reference” button in FIG. 50A, the client displays the reference screen for the external authentication as shown in FIG. 50B. Here, it should be noted that the external authentication is the authentication that carries out the actual authentication (the ID password analyzing part 143 and the authentication ticket managing part 144 in the example of FIG. 25), by using an server, and the like as the authentication engine.

When the user has clicked the “reference” button in FIG. 50B, the client displays the user authentication service management reference screen as shown in FIG. 50C.

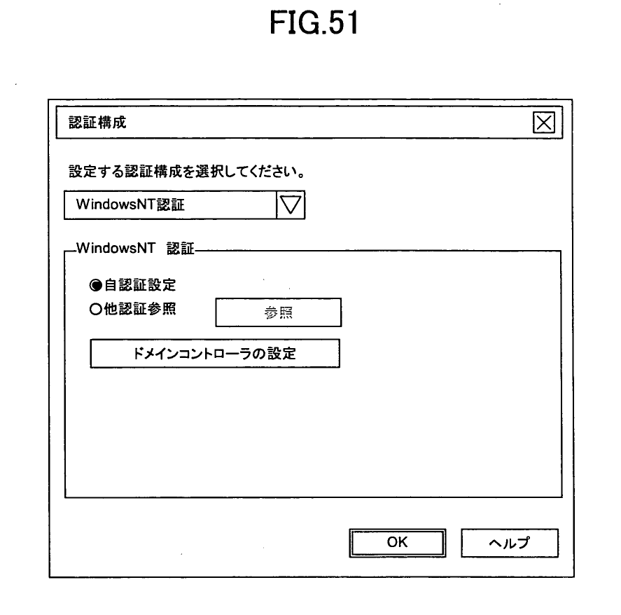

Hereinafter, another example of the GUI for setting up the client will be shown in FIG. 51, wherein FIG. 51 is the second diagram showing the GUI for setting up the provider in the client.

In FIG. 51, an example screen is shown for the case in which the user has chosen the Windows (trade mark) the NT authentication in the drop down menu. It should be noted that the “setting of domain controller” button of FIG. 51 becomes effective only in the case the user has selected “self authentication setting”.

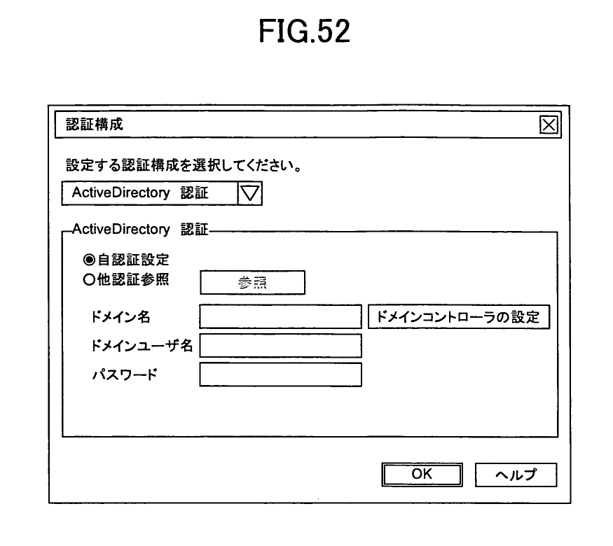

Hereinafter, the example other GUI for setting up the provider in the client will be shown in FIG. 52, wherein FIG. 52 is the third diagram showing the GUI for setting up the provider in the client.

In FIG. 52, an example screen for the case that the user has selected the ActiveDirectory (trade mark) authentication in the drop down menu. Here, it should be noted that the “setting of the domain controller” button of FIG. 52 becomes effective only in the case that the user has selected “the self authentication setting”.

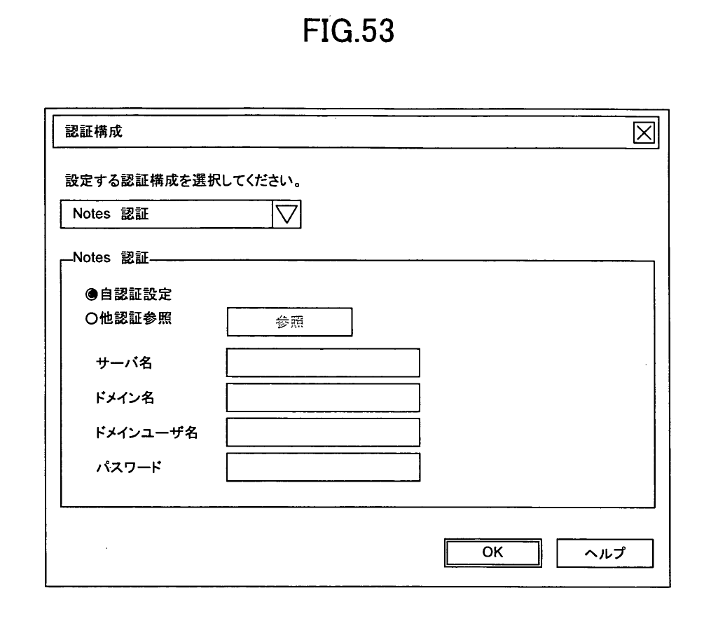

Hereinafter, a further example of the GUI for setting up the provider in the client will be shown in FIG. 53, wherein FIG. 53 is the fourth diagram showing the GUI for setting the provider in the client.

FIG. 53 shows an example screen for the case the user has selected the Notes (trade mark) authentication in the drop down menu.

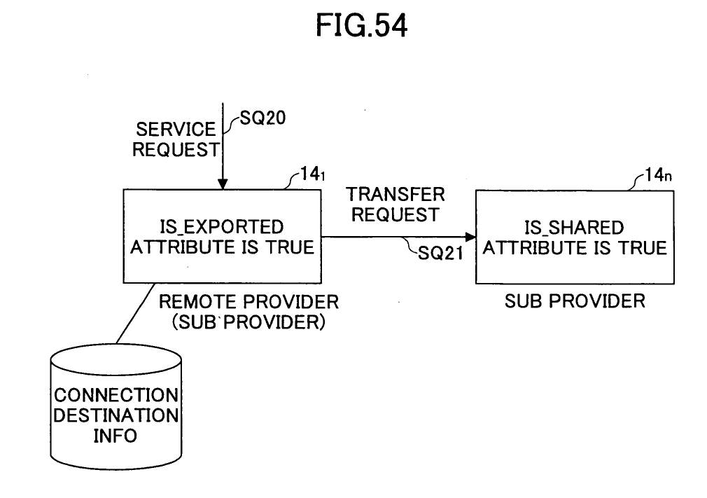

Hereinafter, the example of a remote provider will be explained with reference to FIG. 54, wherein FIG. 54 is a diagram explaining the example of a remote provider.

For example, in the case the Union merge provider 13 and/or the sub provider 14 has the “is_exported” attribute set to TRUE in the definition file, it is possible to conduct the processing as a remote provider as will be describe later. Here, the remote provider is the provider not having an authentication engine for itself in the case the provider is an authentication provider and carries out the processing according to the request from the client by utilizing the authentication engine of other providers as noted before. Here, the definition file is included in the configuration manager 22, and the like, for example.

For example, the sub provider 14, determines whether or not the “is_exported” attribute is TRUE when it receives the use request of the service (authentication service, for example) from the client or the Union merge provider 13 (sequence SQ20), by referring to the definition file etc.

When it is determined that the “is_exported” attribute is TRUE, the sub provider 141 acquires the connection destination information stored in the registry, and the like, assuming that the sub provider 14₁ itself is a remote provider, and requests transfer of the service use request to the connection destination (Sequence SQ21).

The sub provider 14n that has received the use request of the service determines whether or not the “is_shared” attribute is TRUE by referring to the definition file.

When it is determined that the “is_shared” attribute is TRUE, the sub provider 14n carries out the processing according to the use request for the service and returns the result of the processing to the remote provider (sub provider 14₁).

When the remote provider (sub provider 14₁) receives the processing result from the sub provider 14ₙ, the sub provider 141 applies a post-processing to the result of processing according to the needs and returns the result thus added with the post-processing to the requesting original client or the Union merge provider 13.

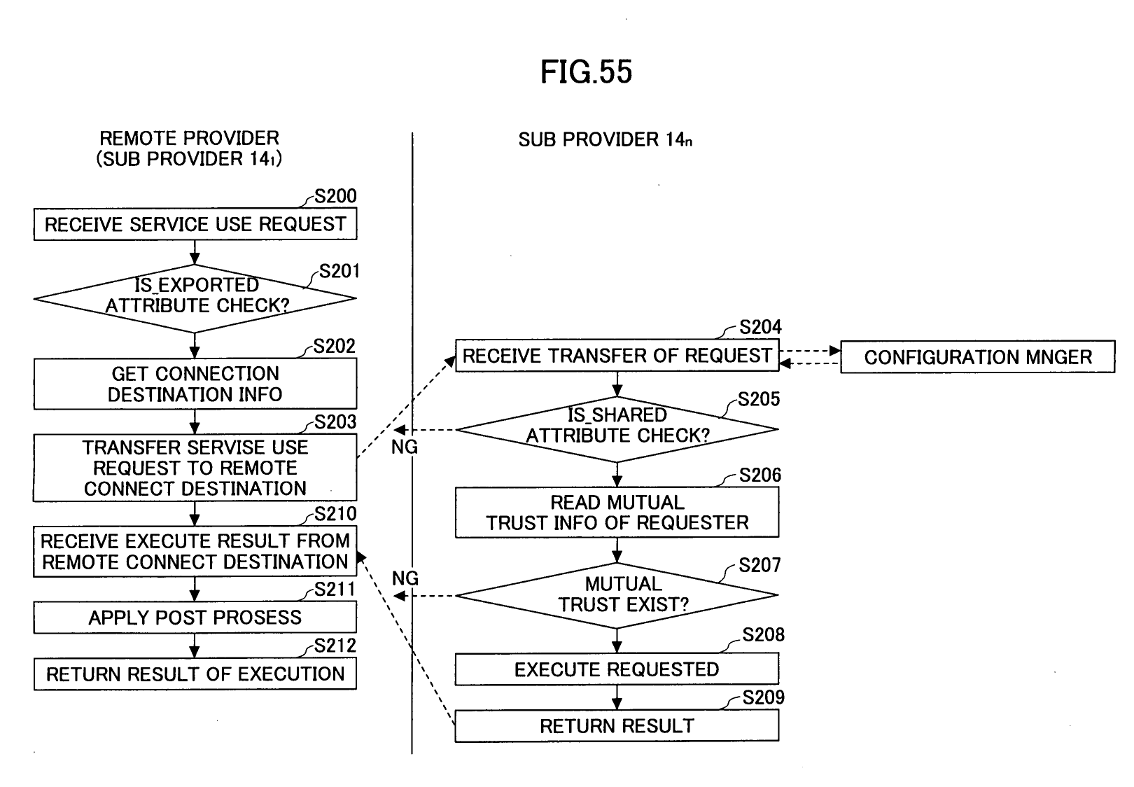

Hereinafter, the example of processing of a remote provider will be explained with reference to FIG. 55, wherein FIG. 55 is a diagram explaining an example of the processing related to a remote provider.

In the Step S200, the sub provider 14₁ receives the use request of the service from the client or the Union merge provider 13.

Following the step S200, the process proceeds to the step S201, and the sub provider 14₁ determines whether or not the “is_exported” attribute is TRUE by referring to the definition file. When it is determined that the “is_exported” attribute is TRUE, the sub provider 141 proceeds to the step S202, while when it determined that the “is_exported” attribute is FALSE, determination is made whether or not the “is_shared” attribute is real. For the sake of simplification of explanation, the processing for the case in which “is_exported” attribute is FALSE is omitted in FIG. 55.

In the step S202, sub provider 141 acquires the connection destination information stored in a registry, and the like based on the judgment that there exists a remote provider.

Following the step S202, the process proceeds to the step S203 and the sub provider 141 forwards the use request for the service received in the step S200 to the connection destination acquired in the step S202.

Following the step S203, the process proceeds to the step S204 and the sub provider 14ₙ of the connection destination receives the forwarded use request of the service from the remote provider.

Following the step S204, the process proceeds to the step S205 and the sub provider 14ₙ of the connection destination determines whether or not the is_shared attribute is TRUE by referring to the definition file. When it is determined that the “is_shared” attribute is TRUE, the sub provider 14ₙ of the connection destination proceeds to the step S206 and returns NG to the remote provider when it is determined that the “is_shared” attribute is FALSE.

In step S206, the sub provider 14ₙ of the connection destination reads out the mutual trust relationship of the request source remote provider from the configuration manager 22.

Following the step S206, the process proceeds to the step S207 and the sub provider 14ₙ of the connection destination determines whether or not there is mutual trust relationship to between the own sub provider 14n and the request source remote provider. When it is determined that there exists no mutual trust relationship between the own sub provider 14ₙ and the request source remote provider, the process proceeds to the step S208 and the sub provider 14ₙ of the connection destination returns NG to the request source remote provider.

In the step S208, the sub provider 14n of the connection destination carries out the processing according to the needs.

Following step S208, the process proceeds to the step S209 and the sub provider 14ₙ of the connection destination returns the result of the processing to the request source remote provider.

Following the step S209, the process proceeds to the step S210 and the remote provider receives the result of processing from the sub provider 14n of the connection destination.

Following the step S210, the process proceeds to the step S211, and a remote provider adds a necessary post-processing to the processing result received in the step S210.

Following the step S211, the process proceeds to the step S212, and the remote provider returns the processing result added with a necessary post-processing in the step S211 to the request source client or the Union merge provider 13.

[Second Embodiment]

Hereinafter, another embodiment of the present invention will be described with reference to the drawings, wherein those parts corresponding to the parts explained previously are designated by the same reference numerals.

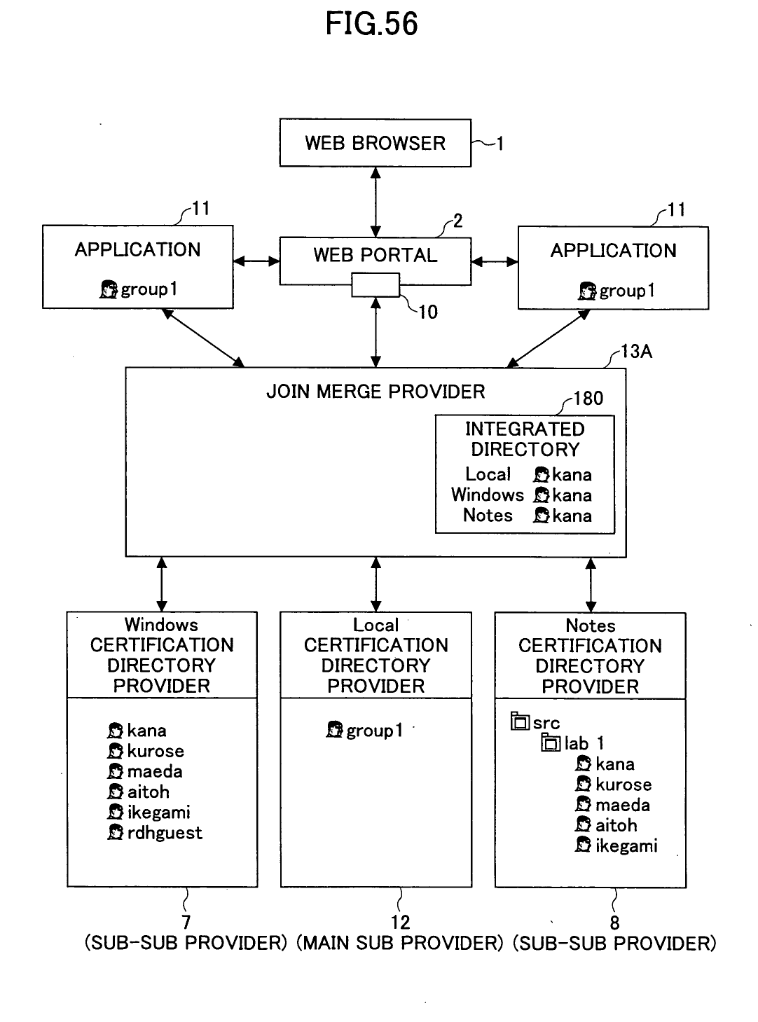

FIG. 56 is a diagram explaining the example in which a join merge provider of the present invention is introduced.

Referring to FIG. 56, the system of FIG. 56 is formed of a Web browser 1, a Web portal 2, a Windows (trade mark) authentication directory provider 7 constituting a sub-sub provider, a Notes (trade mark) authentication directory provider 8 constituting a sub-sub provider, an application 11, a Local authentication directory provider 12 constituting a main sub provider, and a join merge provider 13A.

Thus, in the construction of FIG. 56, it can be seen that the join merge provider 13A is introduced newly in place of the provider 9 of FIG. 5 showing the conventional technology.

Also, as shown in FIG. 56, the join merge provider 13A includes an integrated directory 180 to be described later.

In the description below, the main-sub provider and the sub-sub provider may be called simply as a sub provider for the sake of simplicity of explanation.

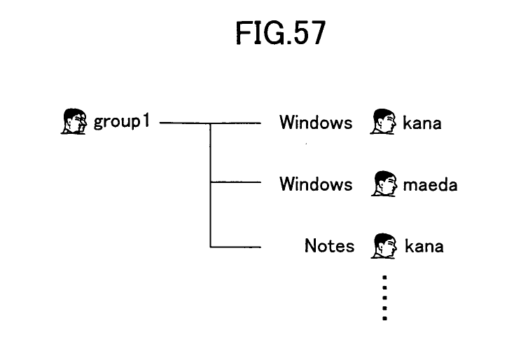

Hereinafter, the example of the members of the group registered in the Local authentication directory provider 12 shown in FIG. 56 will be explained with reference to FIG. 57, wherein FIG. 57 is a diagram explaining an example of the members of the group registered to the Local authentication directory provider shown in FIG. 56.

As shown in FIG. 57, the Local authentication directory provider 12 of FIG. 56 holds the users and groups of other providers as the members of the group of Local authentication directory provider 12.

Thus, the group Group1 of the Local authentication directory provider 12 shown in FIG. 56 has the user Kana of the Windows (trade mark) authentication directory provider 7, the user Maeda of Windows (trade mark) authentication directory provider 7, and the user Kana of the Notes (trade mark) authentication directory provider 8 as the members.

Further, the Local authentication directory provider 12 shown in FIG. 56 holds the user information, and the like, of other providers as the user ID.

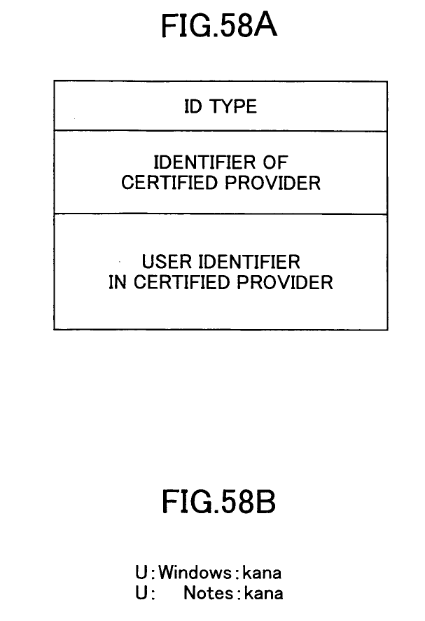

Hereinafter, an example of the user ID structure of the Local authentication directory provider 12 shown in FIG. 56 will be explained by using FIGS. 58A and 58B, wherein FIGS. 58A and 58B diagrams for explaining an example of the structure of the user ID of the Local authentication directory provider shown in FIG. 56.

As shown in FIG. 58A, the user ID of the Local authentication directory provider 12 of FIG. 56 includes the ID type, the identifier of the provider conducted the authentication, and the identifier of the user in the provider that has conducted the authentication.

The ID type represents whether it is a user or a group while the identifier of the provider that has conducted the authentication represents whether it is a Windows (trade mark) provider or a Notes (trade mark) provider, for example. Also, the identifier of the user in the provider that has conducted the authentication represents Kana, Kurose, Maeda, and the like.

FIG. 58B is an example of the user ID of FIG. 58A. The Local authentication directory provider 12 can register the user of the Windows (trade mark) authentication directory provider 7 and the user of the Notes (trade mark) authentication directory provider 8 in the distinguished state by holding the user ID as shown in FIG. 58B.

As will be described later, the Join merge provider 13A of the present invention can acquire and merge the user information and/or the group information of the group to which the user belongs and provide the merged information to the client in the case the same user is registered to different sub providers, without distinguishing the users by the sub providers of which use has been permitted

Also, the join merge provider 13A of the present invention can certify, in the case in the case the sub provider is the provider providing the registered user information and/or the group information of the group to which the user belongs and further the provider that provides the authentication service regarding the user, can certify the user as the user of a main sub provider even in the case the is sub provider certified by the log-in name and password input by the user is a sub-sub provider.

Thus, by using the user ID of the main sub provider, the application 11 can handle the users in an integrated manner without managing the users of other sub providers separately.

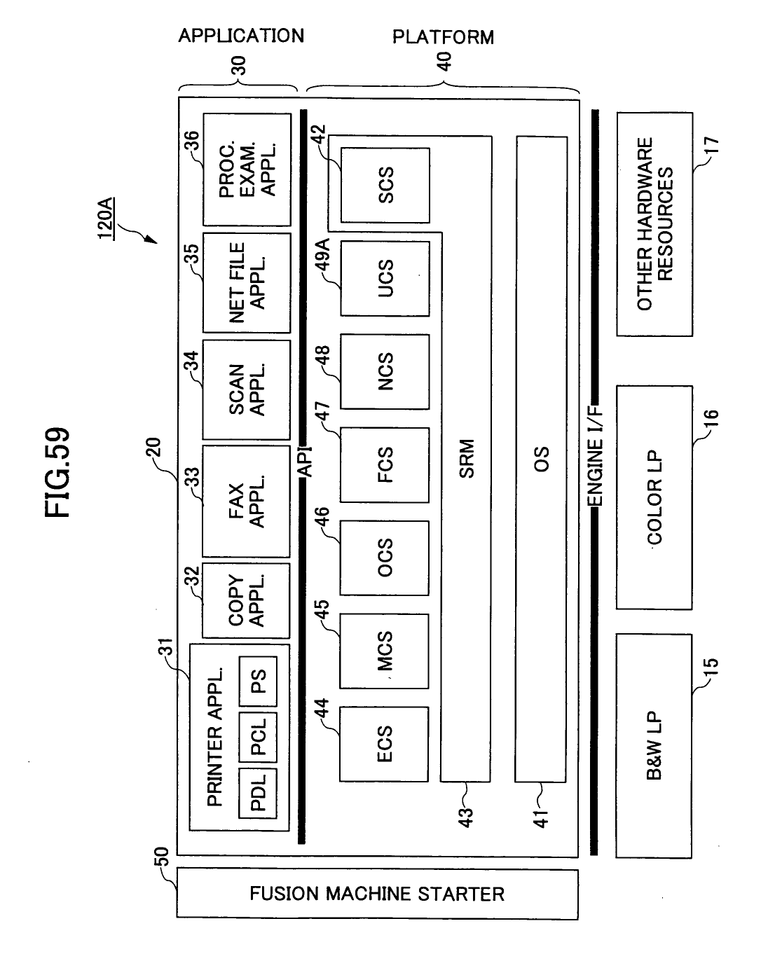

Hereinafter, an example of the apparatus mounted with the join merge provider 13A and/or the sub providers shown in FIG. 56 will be explained with reference to FIG. 59.

FIG. 59 shows the construction of a fusion machine 120A according to an embodiment of the present invention.

Referring to FIG. 59, the fusion machine 120A includes a black-and-white line printer 15 and a color line printer 16, a hardware resource 17 such as a scanner and facsimile, a software group 20, and a fusion machine starter 50. The software group 20 is formed of an application 30 and a platform 40.

The platform 40 is constructed so as to include a control service that interprets a process request from the application 30 and issues an acquisition request of hardware resources, a system resource manager 43 (referred to hereinafter as with SRM) arbitrating the acquisition requests from the control services by managing one or more hardware resources, and an operating system 41 (referred to hereinafter as OS).

The control service is constructed so as to have one or more service modules such as a system control service (Referred to hereinafter as SCS) 42, an engine control service (Referred to hereinafter as ECS) 44, a memory control service (referred to hereinafter as MCS) 45, an operation panel control service (referred to hereinafter as OCS) 46, a Fax control service (referred to hereinafter as FCS) 47, a network control service (referred to hereinafter as NCS) 48, a user information managing service (referred to hereinafter as UCS) 49A, and the like.

Here, the platform 40 is constructed to include an application program interface (referred to hereinafter as API) that enables reception of the process demand from the application 30 by a predefined function.

The OS 41 is an operating system such as UNIX (trade mark) and conducts parallel processing of each of the software in the platform 40 or the application 30 in parallel.

The process of SRM 43 carries out the system control and also the control of the resources together with the SCS 42. For example, the process of SRM43 arbitrates and control the execution in accordance with the request form an upper layer that uses hardware resources such as the engine, which may be a scanner part or a printer part, a memory, a hard disk device (HDD) file, a host I/O (Centronix interface), a network interface, an IEEE1394 interface, an RS 232C interface, and the like.

For example, the SRM 43 determines whether or not the requested hardware resources is available (not used by other requests), and if it is available,

a notification is made to the upper layer that the requested hardware resources are available. Further, the SRM 43 carries out scheduling of using the hardware resources in response to the request from the upper class layer. For example, the SRM 43 executes the requests such as paper feeding and picture formation conducted of the printer engine, memory securing, file generation, and the like, directly.

The process of SCS42 executes the application managing such as application control, operation part control, system screen display, LED display, resource managing and an interrupt application control. The process of ECS 44 executes the engine control of the black-and-white line printer 15, color line printer 16, and the hardware resource 17.

The process of MCS 45 executes acquisition and release of the image memory, the use of the hard disk devices (HDD), and compression and decompression of image data, and the like. The process of OCS 46 executes control of the operation panel used for the information transmission means between the operator and the main body control.

The process of FCS 47 provides the application for executing: facsimile transmission and reception that uses a PSTN or ISDN network from each of the application layers of the system controller, registration/quotation of various facsimile data managed by the BKM (backup SRAM), reading of facsimile, reception and printing of facsimile, fusion transmission and reception, and the like.

The process of NCS 48 provides the services that we used commonly to the applications that require a network I/O and distribute the data received from the network side by respective protocols to respective applications or provide mediation at the time of transmitting the data from the application to the side of the network.

The UCS 49 manages the user information of the user and/or the group information of the group to which the user belong and determines another device connected thereto via a storage device and/or a network and storing therein the user information corresponding to the request and/or the Group information of the group to which the user belongs. Thereby, the UCS 49 acquires the user information of the user and/or the group information of the group to which the user belongs from the foregoing another device connected via the storage device and/or the network thus determined and supplies the same to each of the applications.

Further, the process of the UCS 49 provides an authentication service of users, in addition to the managing of the user information of the user and/or the group information of the group to which the user belongs.

The Join merge provider 13 and/or the other sub providers explained with reference to FIG. 8 (such as the Local authentication directory provider 12, for example,) are mounted on the UCS 49.

The application 30 carries out processing pertinent to the user service related to image formation processing, such as printer, copier, facsimile, scanner, and the like. The application 30 includes a printer application 31, which is an application for the printer having a page description language (PDL, PCL) and postscript (PS) a copy application 32 for copiers, a fax application 33 for facsimiles, a scanner application 34 for scanners, a net file application 35 for network files and a process inspection application 36 for process inspection, and the like.

The fusion machine starter 50 is the part first executed upon power on of the fusion machine 120 activates the applications 30 or the platform 40. For example, the fusion machine starter 50 reads out the control service or application program from the flash memory as will be described later and transfers the programs thus read out to a memory region that secured on an SRAM or an SDRAM for system activation.

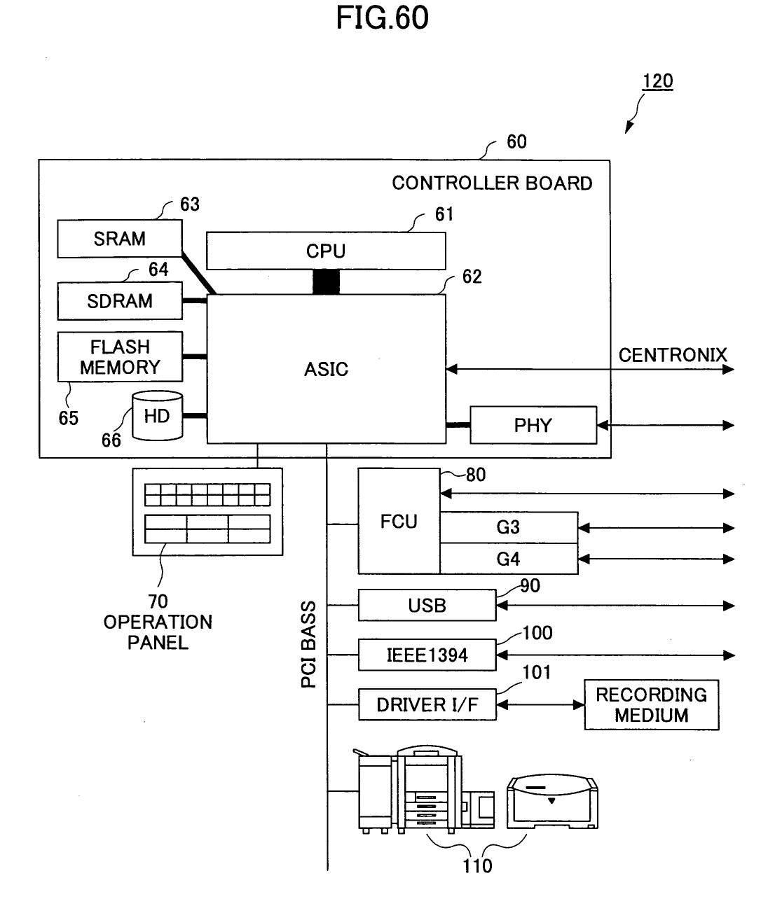

FIG. 60 shows the hardware construction of a fusion machine according to the present invention.

Referring to FIG. 60, the fusion machine 120 of FIG. 12 is constructed so as to include a controller board 60, an operation panel 70, a fax control unit 80 (referred to hereinafter as FCU), a USB device 90, an IEEE1394 device 100, a driver I/F 101, and an engine part 110.

Here, the driver I/F101 is and I/F (interface) used for reading the programs, and the like, corresponding to the Union merge provider 13 and/or the sub provider 14 from an inserted recording medium storing the programs, and the like, corresponding to the Union merge provider 13 and/or the sub provider 14 and for loading to the fusion machine 120. Here, the recording medium may be any of an SD memory card, smart media, a multimedia card, a CompactFlash (trade mark) medium, and the like.

The operation panel 70 is connected to an ASIC62 of the controller board 60 directly. Further, the FCU 80, the USB device 90, the IEEE1394 device 100, the driver I/F 101 and the engine part 110 are connected to the ASIC 62 of the controller board 60 with a PCI bus (Peripheral Component Interconnect bus), and the like.

The controller board 60 is constructed so as to include a CPU 61, the ASIC62, an SRAM (Static RAM) 63, an SDRAM (Synchronous DRAM) 64, a flash memory 65, and a HDD66. Thereby, the controller board 60 is constructed so as to connect the CPU 61, the SRAM63, the SDRAM64, the flash memory 65, the HDD66, and the like to the ASIC62.

It should be noted that the CPU61 carries out overall control of the fusion machine 120. Thus, the CPU61 activates the process of the SCS 42, the SRM 43, the ECS44, the MCS45, the OCS 46, the FCS 47 and also the NCS48 that form the platform 40 on the OS 41 and activates the printer application 31, the copy application 32, the fax application 33, the scanner application 34, the net file application 35 and also the process inspection application 36 that constitute the application 30.

The ASIC 62 is an IC for image processing and includes a hardware element for image processing. Further, a virtual memory region such as kernel and process are mapped in the physical memory region of the SRAM 63 and the SDRAM 64.

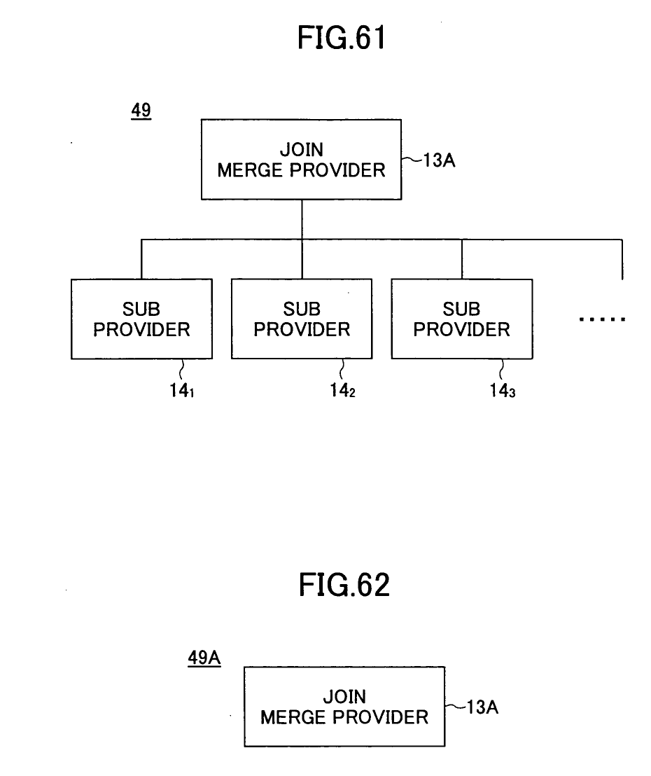

Hereinafter, a construction example of the UCS 49A will be explained with reference to FIGS. 61-63, wherein FIG. 61 is a diagram for explaining the construction of the UCS.

As shown in FIG. 13, the UCS 49A is formed of the Join merge provider 13 shown in FIG. 56 and one or more sub providers 14.

By adopting the construction of FIG. 61, the UCS 49A integrates the user information of the same user and/or the group information of the group to which that user belongs provided by the sub providers 14 in the Join merge provider 13A, as will be described later. Thereby, it becomes possible to provide the user information of the same user and/or the group information of the group to which that user belongs to the applications 30, and the like, of the fusion machine 120A in the merged state.

FIG. 62 is another diagram for explaining the construction of the UCS.

As shown in FIG. 62, the UCS 49A does not include the sub providers 14 and is formed of the Union merge provider 13A of FIG. 56 only.

By taking the construction of FIG. 62, it becomes possible to merge the user information of the same user and/or the group information of the group to which that user belongs and provided the sub providers 14 mounted to other devices are merged in the Join merge provider 13A. Thus, it becomes possible to provide the user information of the same user and/or the group information of the group to which that user belongs to the applications 30, and the like, of the fusion machine 120A in the merged state.

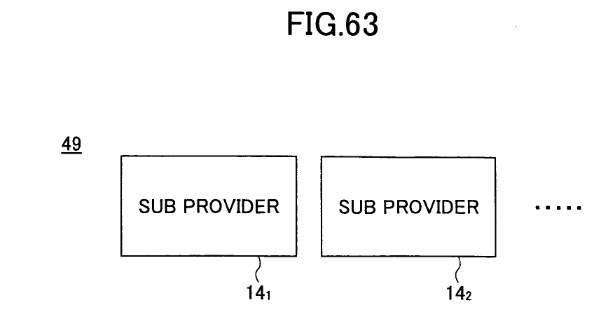

FIG. 63 is another diagram for explaining the construction of the UCS.

As shown in FIG. 63, the UCS 49A is formed of at least one sub provider 14.

By adopting the construction of FIG. 63, it becomes possible to provide the user information of the same user and/or the group information of the group to which that user belongs in response to a request from the Union merge provider 13 mounted to other devices.

In the following, explanation will be made by using the Join merge provider 13A and the sub providers 14 for simplification of the explanation.

### EXAMPLE 4

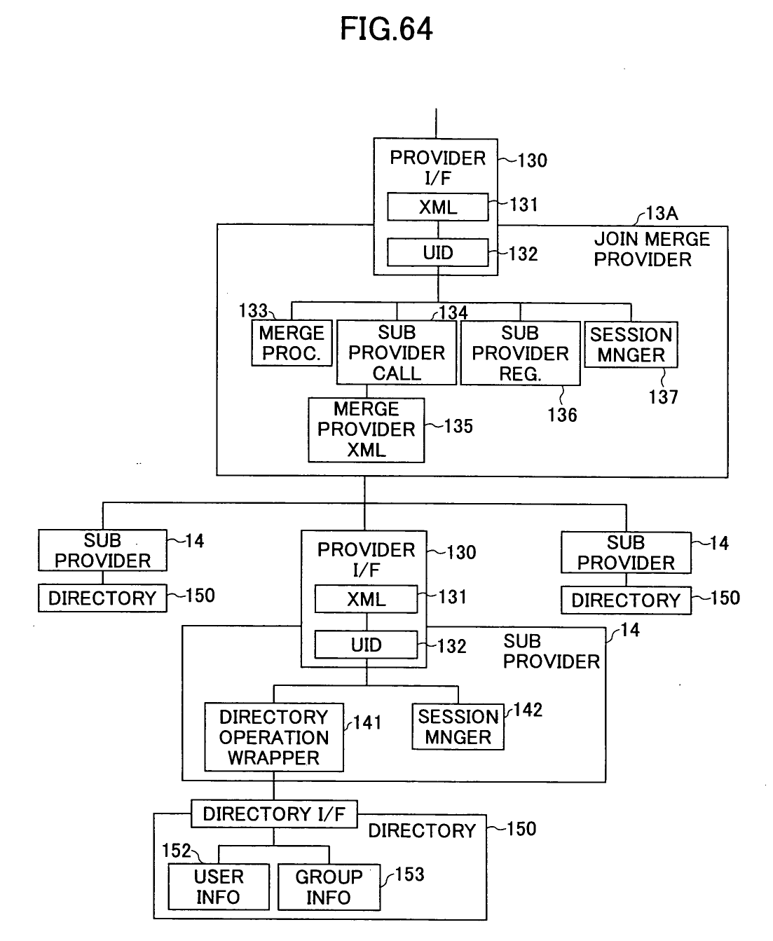

FIG. 64 is a functional block diagram of a Join merge provider and sub providers according to a Example 4 of a present invention.

In the Example 4, for the sake of simplification of the explanation, it is assumed that the Join merge provider 13A and the sub providers 14 provide the user information of users and/or the group information of the group to which the user belongs, but not provide the authentication of the users.

As shown in FIG. 64 the Join merge provider 13A is formed of a provider I/F 130, a merge processing part 133, a sub provider calling part 134, a Merge provider XML processing part 135, a sub provider registration part 136, a session managing department 137 and an integrated directory 180.

Also, the provider I/F 130 is formed of the XML processing part 131 and the UID conversion part 132.

The Provider I/F 130 is an interface that connects the Join merge provider 13A to other providers and/or other applications. As will be explained later, the sub provider 14, too, has a similar provider I/F 130.

The XML processing part 131 analyzes the XML message transmitted from other applications or Web portals, and the like, and converts the same to a form usable by the programs in the Join merge provider 13A.

Conversely, the XML processing part 131 creates an XML message from the data, and the like, given from the UID conversion part 132 and transmits the same to the applications, Web portals, and the like.

Furthermore, it should be noted that the applications and the Web portals may be the application 30 explained with reference to FIG. 59, or alternatively an applications of other fusion machine or other device connected to the fusion machine 120 via a network.

The UID conversion part 132 converts the user ID that is contained to the XML message (referred to hereinafter as UID) according to the needs.

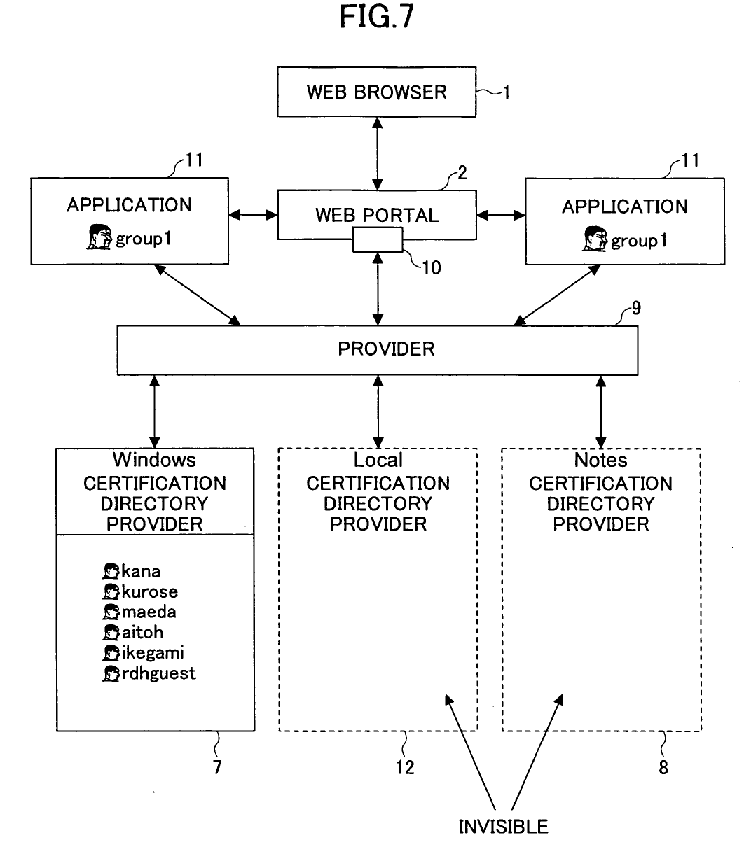

In the case the UID contained in the XML message has the construction of U: Windows (trade mark): Kana as explained with reference to FIG. 7 of the conventional technology and the construction of UID inside the provider is kana, for example, the UID conversion part 132 converts UID from U: Windows: Kana to Kana. Similarly, in the case the XML message is transmitted from the provider a conversion of UID from Kana to U: Windows (trade mark): kana may be conducted according to the needs.

Further, the merge processing part 133 merges the user information of a user and/or the group information of the group to which the user belongs and registered to the sub providers 14 as will be described later.

The sub provider calling part 134 forwards the data necessary to create the XML message transmitted to the sub provider 14 to the merge provider XML processing part 135 to be described later. For example, the sub provider calling part 134 designates an UID and acquires the UID of the same user from the integrated directory 180 to be explained later and provides the information of the UID thus acquired to the merge provider XMP processing part 135 to be described later.

Further, the sub provider calling part 134 forwards the user information of a user and/or the group information of the group to which the user belongs and acquired from the sub provider 14 through the merge provider XML processing part 135 to be described later, to the merge processing part 133.

The merge provider XML processing part 135 creates the XML message on the basis of the data given from the sub provider calling part 134 and transmits the same to a designated sub provider 14.

Further, the merge provider XML processing part 135 receives the XML message transmitted from the sub provider 14 forwards the data contained in the XML message to the sub provider calling part 134.

It should be noted that the data about the sub provider 14 to be managed is registered in the sub provider registration part 136. In the sub provider registration part 136, the identifier of the sub provider 14, the name of the sub provider 14, the managing ID of the sub provider 14, the managing password of the sub provider 14, and the like are registered for each of the sub providers 14.

In the case of registering a new sub provider 14 to the Join merge provider 13A, for example, the identifier of the sub provider 14, the name of the sub provider 14, the managing ID of the sub provider 14 and the managing password of the sub provider 14 are registered to the sub provider registration part 136.

The session managing part 137 manages the sessions between the Union merge provider 13 and other sub providers 14 as well as other applications or the Web portal.

For example, analysis is made whether or not the XML message acquired in the XML processing part 131 included the session ticket ID 210 of the valid session ticket 200, which permits the use of the Join provider 13A.

Further, the session managing part 137 acquires the session ticket ID 310 of the anonymous session ticket 300 from the sub provider 14 by using the managing ID and the managing password of the sub provider 14 registered in the sub provider registration part 136.

Thereby, the session managing part 137 issues the session ticket 200 of the Union merge provider 13 to be described later by using the session ticket ID310, and the like, of the acquired sub provider 14.

The integrated directory 180 integrates and manages the user ID (designated hereinafter as UID) of the sub providers 14. As mentioned before, the integrated directory 180 provides the UID of the same user as the designated user to the sub provider calling part 134 in response to the request therefrom.

The session managing part 137 can acquire the session ticket ID 310 of the anonymous session ticket 300 also from the sub provider 14 other than the sub providers 14 in which the user has requested the creation of the session ticket 400 by using the user name and the password.

Further, the integrated directory 180 can provide the same UID as the designated.

Thus, the join merge provider 13A can acquire the user information of the same user and/or the group information of the group to which that user belongs from a different sub provider 14 by using the UID.

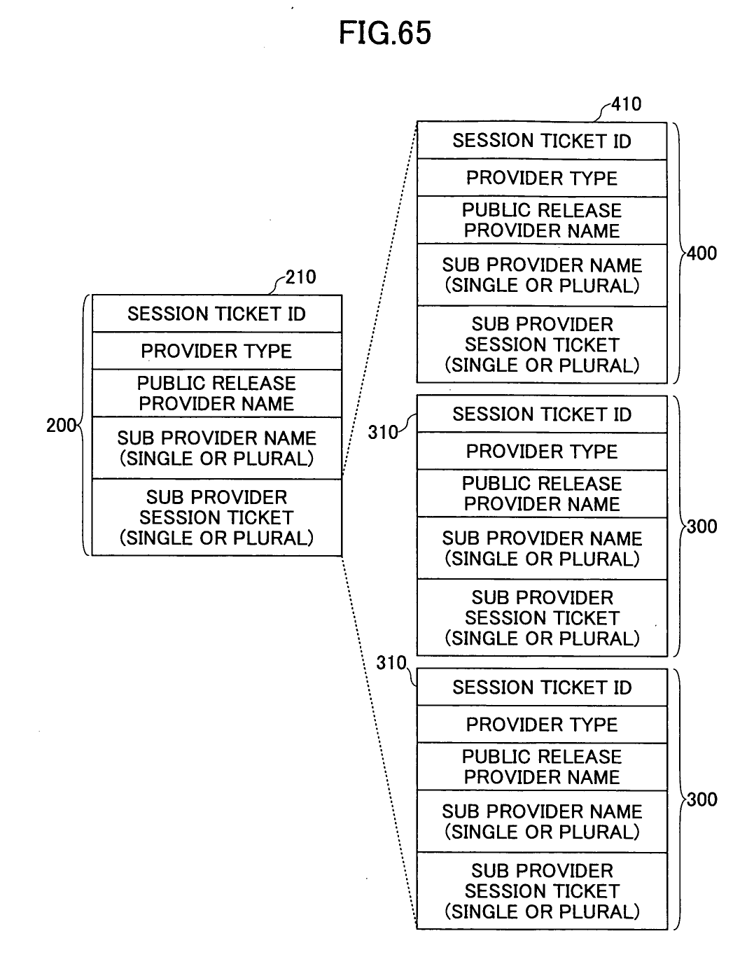

FIG. 65 is a concept diagram for explaining the structure of the session ticket of the Join merge provider.

As shown in FIG. 65, the session ticket 200 of the Join merge provider 13A has the structure including the session ticket ID 210, the provider type, the provider name for public release, one or more sub provider names, the session ticket 300 of one or more sub providers and/or a session ticket 400.

Here, the session ticket ID 210 is the identifier that distinguishes the current session ticket, while the provider type is the type of the providers, which may be “Join Merge”, and the like.

The public released provider name is the name of the public released Union merge provider 13, which may be “Join Merge 1”.

The sub provider name is the names of one or more registered sub providers 14. It should be noted that the session ticket 300 and/or the session ticket 400 of the foregoing one or more registered sub providers 14 and the Join merge provider 13A are stored in the session ticket of the sub provider.

Further, the session ticket 400 is the session ticket of the sub provider 14 issued based on the user name and the password input by the user, while the session ticket 300 is the session ticket of the sub provider 14 issued based on the managing ID and the managing password under authority of the manager and stored in the sub provider registration part 136.

In the description hereinafter, it is assumed for the sake of simplicity of explanation that the anonymous session ticket 300 is the only session ticket of the sub provider 14 contained in the session ticket 200 of the Union merge provider 13.

By providing the hierarchical structure shown in FIG. 65, the sub provider 14 can become the Join merge provider 13A.

Further, while explanation has been made in FIG. 65 by using the example in which the session ticket 300 and/or the session ticket 400 for the one or more registered sub providers 14 and the Join merge provider 13A are stored in the session ticket of the sub provider, it is also possible that the session ticket 300 and/or the session ticket 400 are stored in the decoded form.

The sub provider 14 of FIG. 16 is formed of a provider I/F 130, a directory operation wrapper 141 and a session managing part 142.

The directory operation wrapper 141 modifies the data inside the sub provider 14 into the data capable of manipulating the user information held in the user information saving part 152 of the directory 150 or the group information of the group to which the user belongs and held in the group information saving part 153, and acquires the user information or the group information of the group to which the user belongs from the directory 150.

Further, it converts the acquired user information or the group information into the data possible to be processed inside the sub provider 14.

An example of modification of the data of the directory operation wrapper 141 will be explained later by using FIG. 18.

The session managing part 142 manages the sessions between the sub providers 14 and the Join merge provider 13A.

For example, the session managing part 142 analyzes whether or not session ticket ID 310 of the valid session ticket 300 that permits the use of the sub provider 14 is included in the XML message acquired in the XML processing part 131.

Further, the session managing part 142 issued the anonymous session ticket 300 when it receives the issue request of the anonymous session ticket 300 that contains the managing ID and the managing password from the Union merge provider 13 via the provider I/F 130.

Further, the session managing part 142 gives the session ticket ID 310 of the anonymous session ticket 300 thus issued to the provider I/F 130, and transmits the issue response of the anonymous session ticket 300 including the session ticket ID 310 to the Join merge provider 13A.

Further, the directory 150 of FIG. 16 contains the user information saving part 152 and the group information saving part 153.

The user information saving part 152 holds the user information of the user registered in the sub provider 14. For example, the UID, the user name, the user password, and the like, are held in the user information saving part 152.

Further, the group information registered to the sub provider 14 is held in the group information saving part 153. For example, the group information saving part 153 holds the group ID, the group name, the membership of the group, and the like.

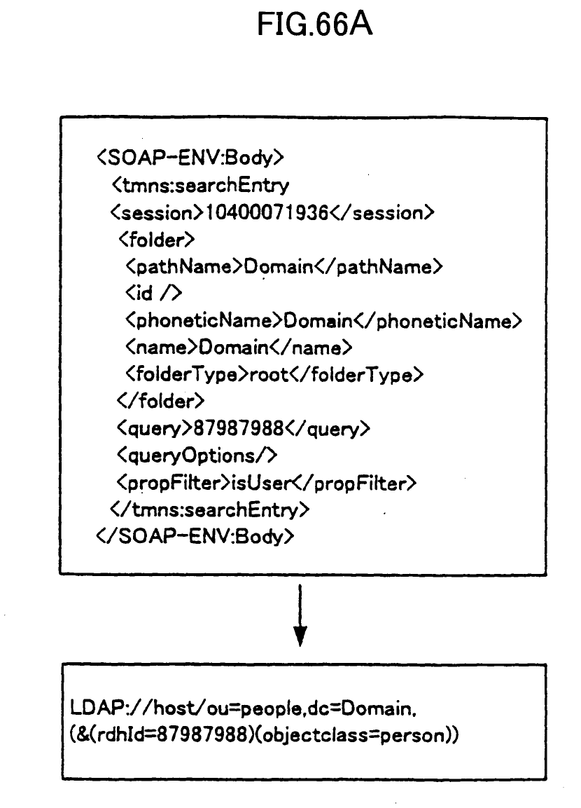

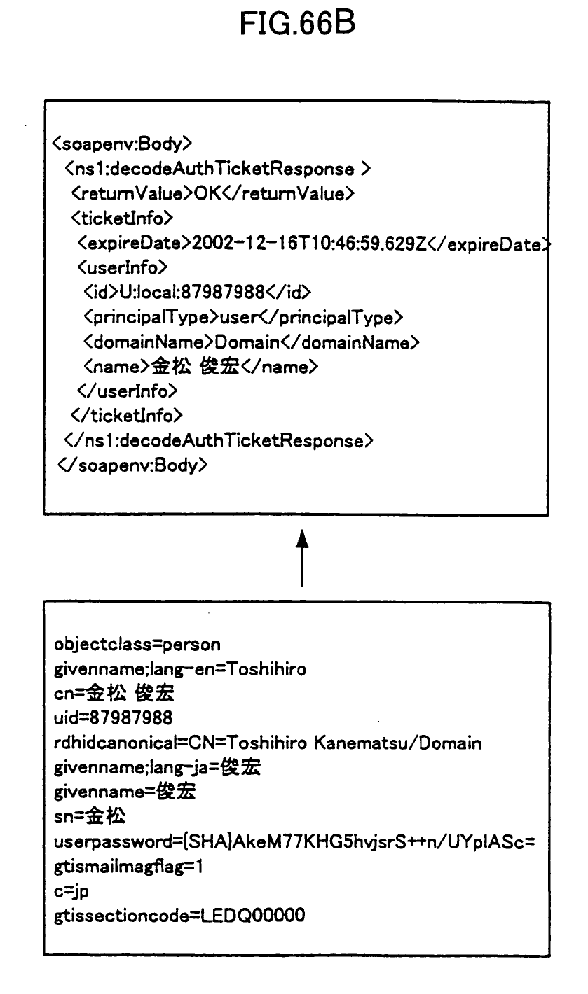

FIGS. 66A and 66B are diagrams explaining modification of data in the directory operation wrapper.

FIG. 66A is an example of modifying the data inside the sub provider 14 to the data capable of manipulating the user information held in the user information saving part 152 and the group information of the group to which the user belongs and held in the information saving part 153 of the directory 150.

FIG. 66B is an example of modifying the date of the user information held in the user information saving part 152 of the directory 150 or the group information of the group to which the user belongs and held in the group information saving part 153 to the data capable of processing in the sub provider 14.

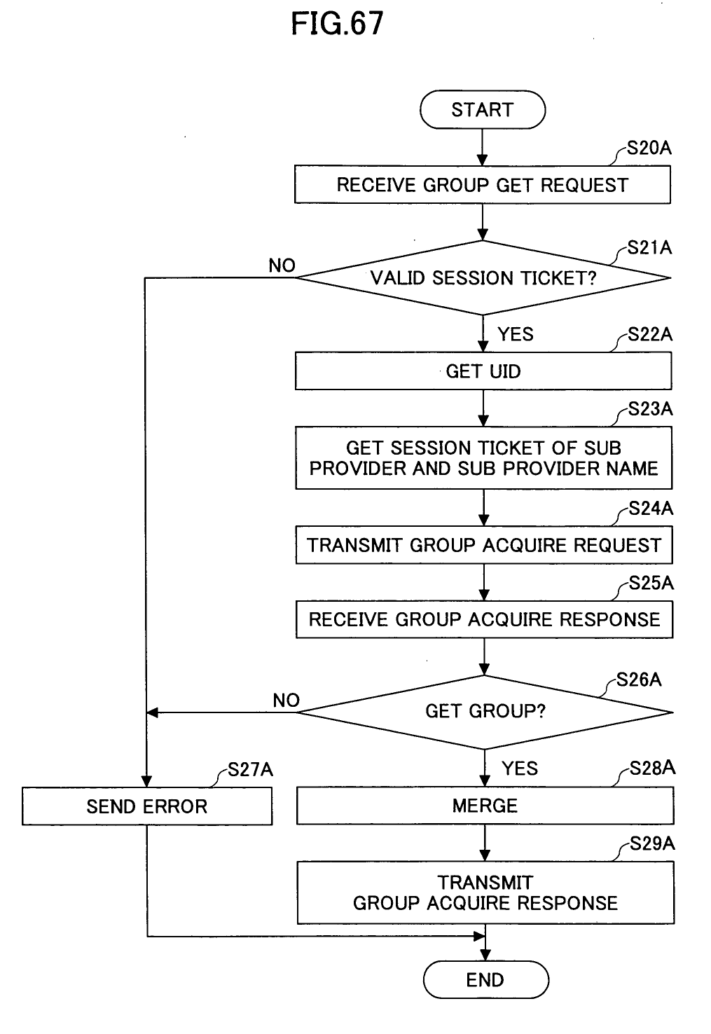

FIG. 67 is a flowchart showing an example of the acquisition processing of the group to which the user belongs in the Join merge provider.

In the following, the application or Web portal that transmits the acquisition request of the group information for the group to which the user belongs to the Join merge provider 13A will be referred to as simply the client for the sake of simplicity of explanation.

In the step S20A, the XML processing part 131 of the Join merge provider 13A receives the acquisition request of the group to which the user belongs from the client.

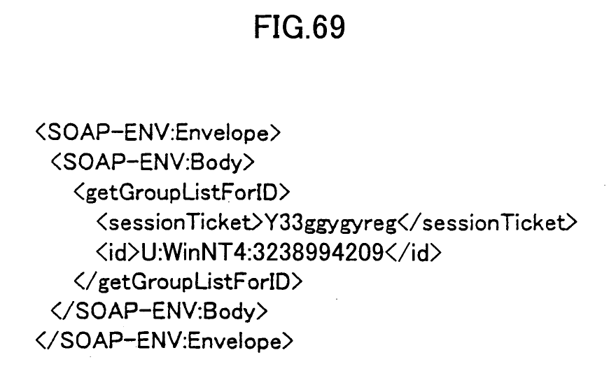

The example of the group acquisition request from the client to the Union merge provider 13 will be describes later with reference to FIG. 69.

After the step S20A, the process proceeds to the step S21A, and the session managing part 137 determines whether or not the session ticket ID 210 of the session ticket 200 of the Join merge provider 13A contained in the acquisition request of the group to which the user belongs and received in the step S20A, is a valid session ticket ID 210.

When it is determined that the session ticket is the session ticket ID210 of the valid session ticket 200 ((YES in step S21A), the process proceeds to the step S22A, while when it is determined that the session ticket is the session ticket ID 210 of an invalid session ticket 200 (NO in step S21A), the process proceeds to the step S27A.

In the step S22A, the sub provider calling part 134 acquires the UID of a user in the sub provider 14, the user being the same user whose UID is included in the acquisition request for the user group received in the step S20A from the integrated directory 180.

Following the step S22A, the process proceeds to the step S23A, and the sub provider calling part 134 acquires the session ticket ID 310 of the session ticket 300 of all the sub providers 14 included in session ticket 200 of the join merge provider 13A and the sub provider names from the session managing part 137.

After the step S23A, the process proceeds to the step S24A, and the merge provider XML processing part 135 issues the acquisition request of the group to which the user belongs, to each of the sub providers 14 including the UID and the session ticket ID 310 of the session ticket 300 of the sub providers 14 acquired through the sub provider calling part 134, and transmits the same to each of the sub providers 14.

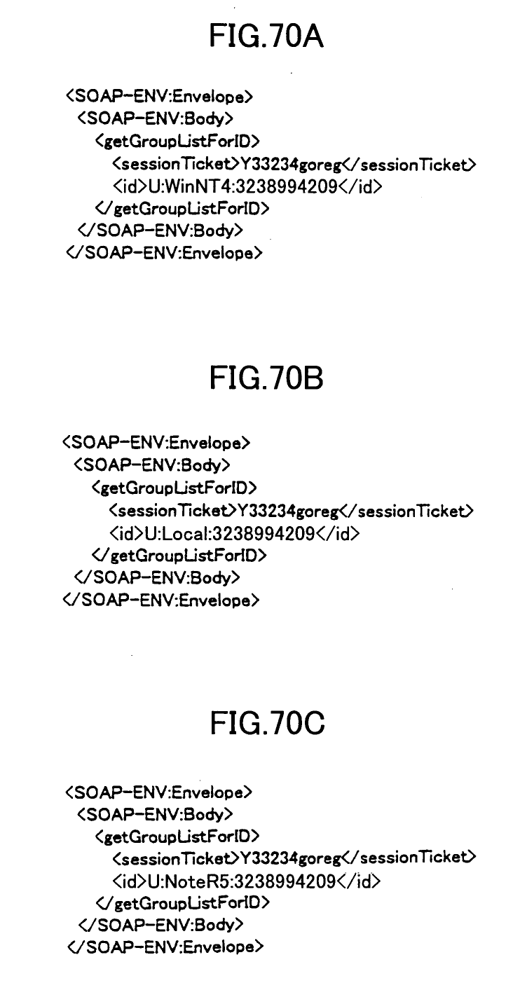

The example of the group acquisition request from the Union merge provider 13 to each of the sub providers 14 will be described later with reference to FIGS. 70A-70C, 71A-71C and 72A-72C.

After the step S24A, the process proceeds to the step S25A and the sub provider calling part 134 receives the assignment group acquisition response responding to the acquisition request of the groups to which the user belongs, from each of the sub providers 14 via the merge provider XML processing part 135.

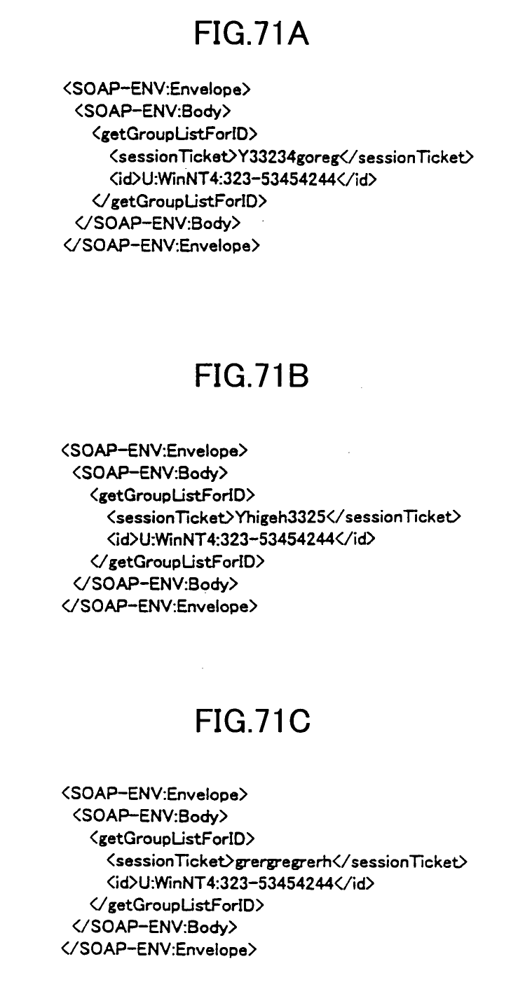

The example of the group acquisition response from the sub providers 14 to the Join merge provider 13A will be described later with reference to FIG. 71A-71C.

After the step S25A, the process proceeds to the step S26A, and the sub provider calling part 134 determines whether or not the group information of the groups to which the designated user belongs is included in the assignment group acquisition responses from the sub providers 14 that have received the response in the step S24A.

When it is determined that even one piece of assignment group information of the user is contained (YES in step S26A), the process proceeds to the step S28A, while when it is determined that there is not even one group to which the user belongs is contained (NO in step S26A), the process proceeds to the step S27A.

In the step S27A, the XML processing part 131 of the Join merge provider 13A issues a response indicating that the acquisition of the groups to which the user belongs has failed, and transmits the same to the client.

In the step S28A, the merge processing part 133 merges the groups to which the user belongs and included to the assignment group acquisition response acquired in the step S25A from each of the sub providers 14.

After the step S28A, the process proceeds to the step S29A, and the XML processing part 131 of the Join merge provider 13A issues the assignment group acquisition response including the information of the groups to which the user belongs and merged in the step S28A, and transmits the same to the client.

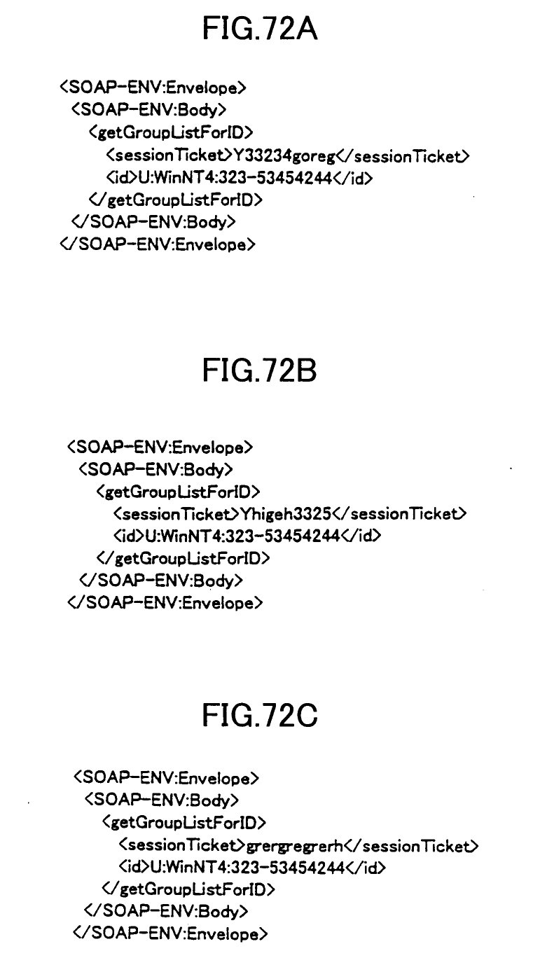

The example of the group acquisition response from the Join merge provider 13A to the client will be described later with reference to FIGS. 72A-72C.

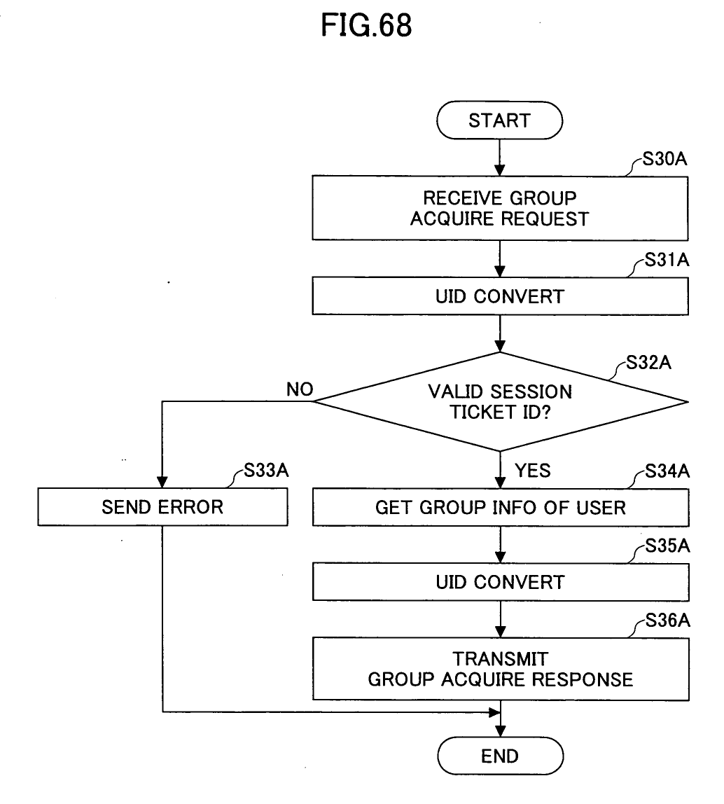

FIG. 68 is a flowchart showing the example of the group acquisition process of the group to which the user belongs conducted in a sub provider.

The sub provider 14 starts the processing of the steps starting from step S30A as will be described below, when the Join merge provider 13A has transmitted the acquisition request of the groups to which the user belongs to each of the sub providers 14 in the step S24A of FIG. 67.

In the step S30A, the XML processing part 131 of the sub provider 14 receives the acquisition request of the group to which the user belongs from the Join merge provider 13A.

The example of the group acquisition request from the Join merge provider 13A to each of the sub providers 14 will be described later with reference to FIG. 70A-70C.

Following the step S30A, the process proceeds to the step S31A, and the UID conversion part 132 of the sub provider 14 converts the UID included in the acquisition request of the group to which the user belongs and received in the step S30A into the UID peculiar to the directory 150.

Following the step S31A, the process advances to the step S32A, and the session managing part 142 determines whether or not the session ticket ID310 of the session ticket 300 of sub provider 14 included in the acquisition request of the group to which the user belongs and received in the step S30A is the session ticket ID 310 of a valid session ticket 300.

When it is determined that the session ticket ID 310 is a valid session ticket 300 (YES in step S32A), the process proceeds to the step S34A, while when it is determined the session ticket ID 310 is an invalid session ticket 300 (NO in step S32A), the process proceeds to the step S33A.

In the step S33A, the XML processing part 131 of the sub provider 14 issues a group acquisition response indicating that the acquisition of the group to which the user belongs has failed, and transmits the same to the Join merge provider 13A.

In the step S34A, the sub provider 14 acquires the group information of the group to which the user belongs from the directory 150 through the directory operation wrapper 141.

After the step S34A, the process proceeds to the step S35A, and the UID conversion part 132 of the sub provider 14 converts the UID peculiar to the directory 150 into an UID available in the Join merge provider 13A.

Following the step S35A, the process proceeds to the step S36A, and the XML processing part 131 of the sub provider 14 issues the group acquisition response including the information of the group to which the user belongs and transmits the same to the Join merge provider 13A.

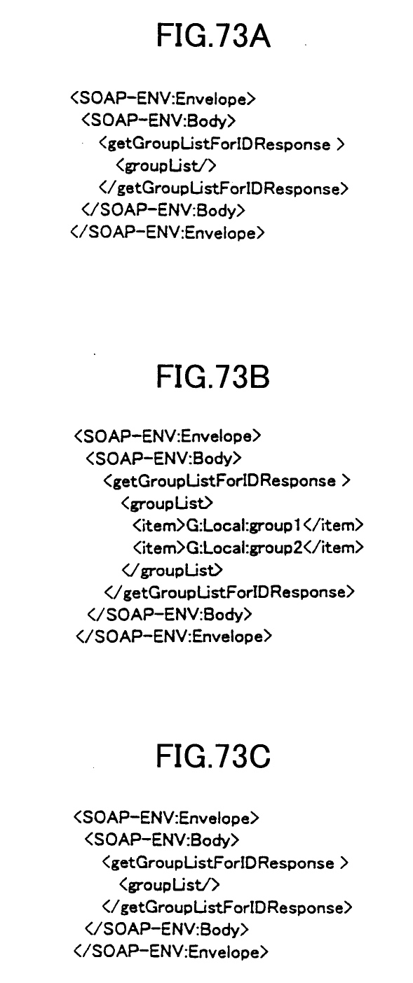

The example of the group acquisition response from each sub provider 14 to the Join merge provider 13A will be described later with reference to FIG. 73A-73C.

Furthermore, the step S25 of FIG. 67 receives the group acquisition response transmitted in the step S33A or step S36A of FIG. 68.

FIG. 69 shows an example of the XML message of the group acquisition request from the client to the Join merge provider.

As shown in FIG. 69, the group acquisition request of the group to which the user belongs and sent from the client to the Union merge provider 13 includes the session ticket ID 210 of the session ticket 200 of the Join merge provider 13A in the tag of <session Ticket></session Tickets. Further, the UID identifying the user is contained in the tag of <Id></id>.

The join merge provider 13A receives the group acquisition request of the group to which the user belongs and contains the UID and the session ticket ID210 of the session ticket 200 of the join merge provider 13A from the client.

FIGS. 70A-70C show the examples of the XML messages of the group acquisition request from the Join merge provider to the Local directory provider 160, which is one of the sub providers 14.

FIG. 70A is the XML message of a group acquisition request sent to the Local directory provider 160, which is one of the sub providers 14, from the Join merge provider 13A.

As shown in FIG. 70A, the acquisition request of the group to which the user belongs and transmitted from the Join merge provider 13A to the Local directory provider 160 includes, in the tag of <session Ticket></session Ticket>, the session ticket ID 310 of the session ticket 300 of the Local directory provider 160.

Also, in the tag of <Id></id>, the UID that identifies the user is contained. This UID is the one similar to the UID included in the XML message of FIG. 69.

FIG. 70B is the XML message of a group acquisition request transmitted to the Local directory provider 160, which is one of the sub providers 14, from the Join merge provider 13A.

As shown in FIG. 70B, the acquisition request of the group to which the user belongs and transmitted from the Join merge provider 13A to the Local directory provider 160 includes the session ticket ID 310 of the session ticket 300 of the WinNT4 directory provider 161 in the tag of <Session Ticket></session Ticket>.

Further, in the tag <Id></id>, an UID that identifies the user is included. It should be noted that this UID is the one of the UIDs that the Join merge provider 13 has acquired from the integrated directory 180 based on the UID included in the XML message of FIG. 69.

FIG. 70C is the XML message of a group acquisition request transmitted to the Local directory provider 160, which is one of the sub providers 14, from the Join merge provider 13A.

As shown in FIG. 70C, the acquisition request of the group to which the user belongs and transmitted from the Join merge provider 13A to the Local directory provider 160 includes the session ticket ID 310 of the session ticket 300 of the Local directory provider 160 in the tag <session Ticket></session Ticket>.

Further, the UID identifying the user is included in the tag <id></id>. This UID is the one similar to the UID that the Join merge provider 13A has acquired from the integrated directory 180 based on the UID included in the XML message of FIG. 69.

Because the Join merge provider 13A manages the session ticket with the hierarchical structure as explained it in FIG. 65, it becomes possible to acquire the session ticket ID 310 of the session ticket 300 of the Local directory provider 160 forming the sub providers 14 based on the session ticket ID 210 of the session ticket 200 of the Join merge provider 13A contained in the acquisition request of the group to which the user belongs and transmitted from the client, and to include the session ticket ID310 in the respective XML messages.

Because the Join merge provider 13A manages the UID of the users in the sub providers 14 integrally in the integrated directory 180, it becomes possible to acquire the UID of the same user from the integrated directory 180 based on the UID included in the user group acquisition request and include the UID thus acquired in the XML message.

FIGS. 71A-71C show examples of the XML message of a group acquisition request from the Join merge provider to the WinNT4 directory provider, which is one of the sub providers.

FIG. 71A is the XML message of a group acquisition request from the Join merge provider 13A to the WinNT4 directory provider 161, which is one of the sub providers 14.

As shown in FIG. 71A, the acquisition request of the group to which the user belongs and transmitted from the Join merge provider 13A to the WinNT4 directory provider 161 includes the session ticket ID310 of the session ticket 300 of the WiNT4 directory provider 161 in the tag <sessionTicket>,</sessionTicket>.

Further, the tag <id>,/id> includes the UID for identifying the user. This UID is similar to the UID included in the XML message of FIG. 69.

FIG. 71B is another diagram showing the XML message of a group acquisition request transmitted from the Join directory provider 13A to the WinNT4 directory provider 161, which is one of the sub providers 14.

As shown in FIG. 23B, the acquisition request of the group to which the user belongs and transmitted from the Join merge provider 13A to the WinNT4 directory provider 161 contains the session ticket ID 310 of the session ticket 300 of the WinNT4 directory provider 161 in the tag S<sessionTicket></sessionTicket>.

Further, the tag <id></id> contains the UID identifying the user. This UID is on eof the UIDs of the same user that the Join merge providre 13 has acquired from the integrated directory 180 based on the UID included in the XML message of FIG. 69.

FIG. 71C is another diagram showing the XML message of a group acquisition request transmitted from the Join merge provider 13A to the WinNT4 directory provider 161, which is one of the sub providers 14.

As shown in FIG. 71C, the group acquisition request of the group to which the user belongs from the Join merge provider 13A to the WinNT4 directory provider 161 includes the session ticket ID 310 of the session ticket 300 of the WinNT4 directory provider 161 in the tag <sessionTicket></sessionTicket>.

Further, the tag <id></id> includes the UID identifying the user. It should be noted that this UID is one of the UIDs that the Join merge provider 13A has acquired from the integrated directory based on the UID included in the XML message of FIG. 69.

Because the Join merge provider 13A manages the session ticket with the hierarchical structure as explained it in FIG. 65, it becomes possible to acquire the session ticket ID 310 of the session ticket 300 of the WinNT4 directory provider 161 constituting the sub providers 14 based on the session ticket ID 210 of the session ticket 200 of the Join merge provider 13A contained in the acquisition request of the group to which the user belongs and transmitted from the client, and to include the session ticket ID 310 in the respective XML messages.

Because the Join merge provider 13A manages the UID of the users in the sub providers 14 integrally in the integrated directory 180, it becomes possible to acquire the UID of the same user from the integrated directory 180 based on the UID included in the user group acquisition request and include the UID thus acquired in the XML message.

FIGS. 72A-72C show examples of the XML message of a group acquisition request from the Join merge provider to the Notes (trade mark) R5 directory provider, which is one of the sub providers.

FIG. 72A is the XML message of a group acquisition request from the Join merge provider 13A to the Notes (trade mark) R5 directory provider 162, which is one of the sub providers 14.

As shown in FIG. 72A, the acquisition request of the group to which the user belongs and transmitted from the Join merge provider 13A to the Notes (trade mark) R5 directory provider 162 includes the session ticket ID 310 of the session ticket 300 of the Notes (trademark) R5 directory provider 162 in the tag <sessionTicket>,</sessionTicket>.

Further, the tag <id>,/id> includes the UID for identifying the user. This UID is similar to the UID included in the XML message of FIG. 69.

FIG. 72B is another diagram showing the XML message of a group acquisition request transmitted from the Join directory provider 13A to the Notes (trademark) R5 directory provider 162, which is one of the sub providers 14.

As shown in FIG. 72B, the acquisition request of the group to which the user belongs and transmitted from the Join merge provider 13A to the Notes (trade mark) R5 directory provider 162 contains the session ticket ID 310 of the session ticket 300 of the Notes (trade mark) directory provider 162 in the tag <sessionTicket></sessionTicket>.

Further, the tag <id></id> contains the UID identifying the user. This UID is on eof the UIDs of the same user that the Join merge providre 13 has acquired from the integrated directory 180 based on the UID included in the XML message of FIG. 69.

FIG. 72C is another diagram showing the XML message of a group acquisition request transmitted from the Join merge provider 13A to the Notes (trade mark) directory provider 162, which is one of the sub providers 14.

As shown in FIG. 72C, the group acquisition request of the group to which the user belongs from the Join merge provider 13A to the Notes (trade mark) directory provider 162 includes the session ticket ID 310 of the session ticket 300 of the Notes (trade mark) R5 directory provider 162 in the tag <sessionTicket></sessionTicket>.

Further, the tag <id></id> includes the UID identifying the user. It should be noted that this UID is one of the UIDs that the Join merge provider 13A has acquired from the integrated directory based on the UID included in the XML message of FIG. 69.

Because the Join merge provider 13A manages the session ticket with the hierarchical structure as explained it in FIG. 65, it becomes possible to acquire the session ticket ID 310 of the session ticket 300 of the Notes (trade mark) R5 directory provider 162 constituting the sub providers 14 based on the session ticket ID 210 of the session ticket 200 of the Join merge provider 13A contained in the acquisition request of the group to which the user belongs and transmitted from the client, and to include the session ticket ID 310 in the respective XML messages.

Because the Join merge provider 13A manages the UID of the users in the sub providers 14 integrally in the integrated directory 180, it becomes possible to acquire the UID of the same user from the integrated directory 180 based on the UID included in the user group acquisition request and include the UID thus acquired in the XML message.

FIGS. 73A-73C are the XML messages of a group acquisition response from the Local directory provider, which is one of the sub providers, to the Join merge provider.

FIGS. 73A-73C show the examples of the XML messages of the group acquisition response to the join merge provider from the Local directory provider, which is one of the sub providers.

FIG. 73A is the XML message of a group acquisition response to the request of FIG. 70A.

In the case that the user corresponding to the designated UID is not registered in the Local directory provider 160, the Local provider 160 transmits the acquisition response shown in FIG. 73A not having the tag <item></item> to the join merge provider 13A.

FIG. 73B is the XML message of group acquisition response to the request of FIG. 70B.

As shown in FIG. 73B, in the case the user corresponding to the designated UID is registered in the Local directory provider 160, the Local directory provider 160 stores the group information that this user belongs to in each of the tags <item></item> included in the tag 10<groupList></groupList> and transmits the same to the join merge provider 13A.

FIG. 73C is the XML message of a group acquisition response to the request of FIG. 70C.

Similarly to FIG. 73A, in the case the user is corresponding to the designated UID is not registered in the Local directory provider 160, the Local directory provider 160 transmits the acquisition response shown in FIG. 73C not containing the tag <item></item> to the join merge provider 13A.

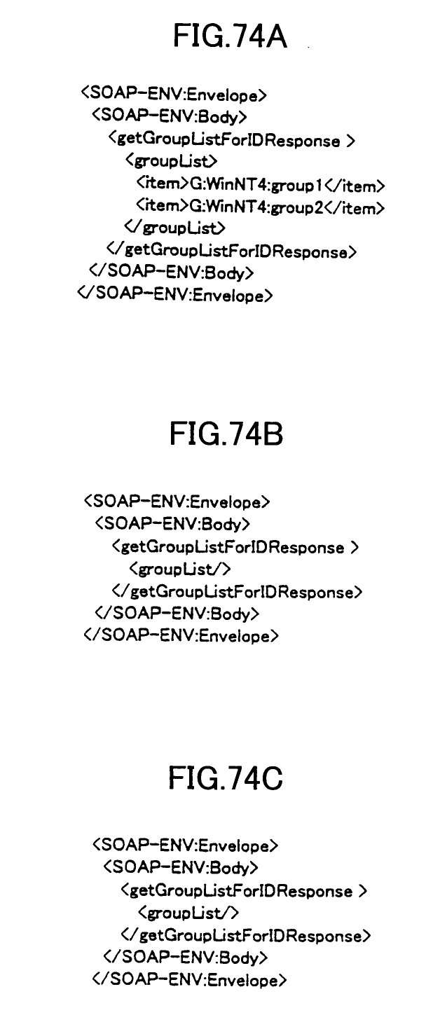

FIGS. 74A-74C are the XML messages of the group acquisition response to the join merge provider from the WinNT4 directory provider, which is one of the sub providers.

FIG. 74A is the XML message of a group acquisition response to the request of FIG. 71A. As shown in FIG. 74A, in the case the user corresponding to the designated UID is registered in the WinNT4 directory provider 161m the WinNT4 directory provider 161 stores the group information that this user belongs to in each of the tags <item></item> included in the <groupList></groupList> and transmits the same to the join merge provider 13A.

FIG. 74B is the XML message of a group acquisition response to the request of FIG. 71B.

In the case that the user corresponding to the designated UID is not registered in the WinNT4 directory provider 161, the WinNT4 directory provider 161 transmits the acquisition response not containing the tag <item></item> as shown in FIG. 74B to the join merge provider 13A.

FIG. 74C is the XML message of the group acquisition response to the request of FIG. 71C.

Similarly to FIG. 74B, in the case the user corresponding to the designated UID is not registered in the WinNT4 directory provider 161, the WinNT4 directory provider 161 transmits the acquisition response not having the tag <item></item> as shown in FIG. 74C to the join merge provider 13A.

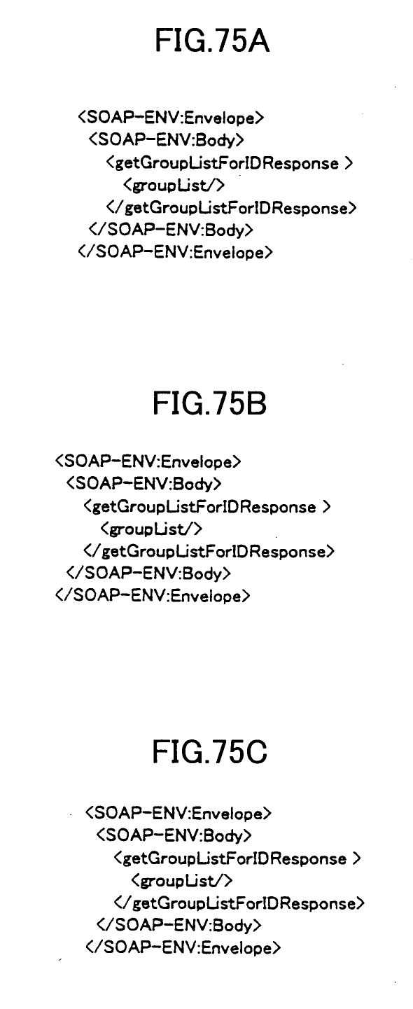

FIG. 75A-75C show the examples of the XML message of the group acquisition response to the join merge provider from the Notes (trade mark) R5 directory provider, which is one of the sub providers.

FIG. 75A is the XML message of a group acquisition response to the request of FIG. 72A.

FIG. 75B is the XML message of a group acquisition response to the request of FIG. 72B.

FIG. 75C is the XML message of a group acquisition response to the request of FIG. 72C.

In the case the user corresponding to the designated UID is not registered in the Notes (trade mark) R5 directory provider 162, the Notes (trade mark) R5 directory provider 162 transmits the acquisition response not having the tag <item></item> as shown to from FIGS. 75A-75C to the join merge provider 13A.

Each sub provider 14 crates, in the case the user corresponding to the designated UID is registered in that sub provider 14 as the user of this sub provider 14, the group acquisition response including the group information of the group to which this user belongs and transmits the same to the join merge provider 13A.

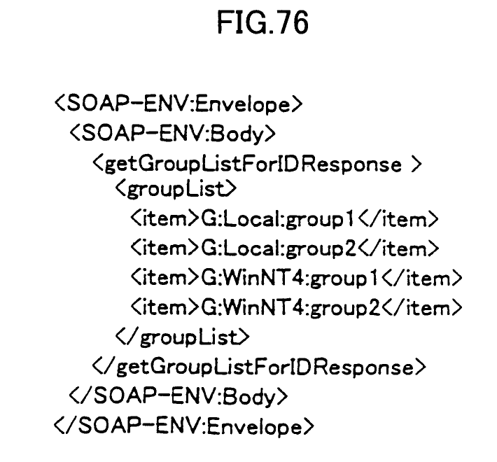

FIG. 76 is the XML message of a group acquisition response from the join merge provider to the client.

As shown in FIG. 76, the Join merge provider 13A stores the group information acquired from each of the sub providers 14 by merging the tag <item></item> holding the group information into a single tag <groupList></groupList> and transmits the same to the client. By transmitting the acquisition request of the group to which the user belongs and contains the session ticket ID 210 of the session ticket 200 of the Join merge provider 13A and the UID identifying the user to the Join merge provider 13A, the client can acquire the information of the groups to which the same user, who is registered to the respective sub providers 14, belongs and managed by the join merge provider 13A, from the join merge provider 13A.

For example, <item>G: Local: group1</item> and <item>G: Local: group2</item> of FIG. 76 are the information of the group to which the user 3,238,994,209 belongs, who is registered to the Local directory provider 160 as the user of the Local directory provider 160. Further, <Item>G: WinNT4: group1</item> and <item>G: WinNT4: group2</item> of FIG. 76 are the information of the group to which the user 3,238,994,209 belongs and registered to the WinNT4 directory provider 161 as the user of the WinNT4 directory provider 161.

Thus, the Join merge provider 13A can acquire and merge the group information of the groups to which the same user belongs, from each of the sub providers 14.

While the explanation of Example 4 has been made for the case the session ticket ID 210 and/or the session ticket ID 310 is transmitted and received between the Join merge provider 13A and the sub provider 14 or between the join merge provider 13A and the client, the present invention is not limited to such a case and it is possible also to transmit and receive the session ticket 200 and/or the session ticket 300.

Heretofore, the case in which that sub provider 14 does not require the authentication in the Example 4. In the Example 5 below, the case in which the sub provider requires authentication will be explained.

### EXAMPLE 5

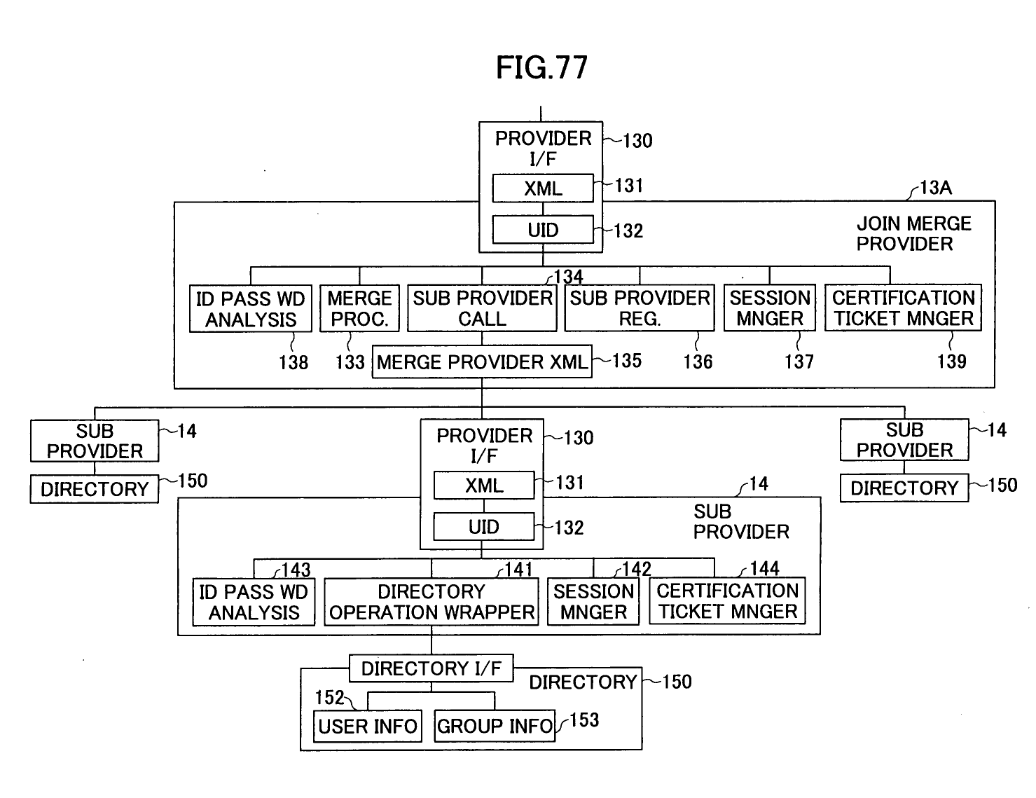

FIG. 77 is a functional block diagram of the Join merge provider and the sub providers according to Example 5 of the present invention.

In the Example 5, it is assumed that the sub providers 14 provide not only the user information and/or the group information of the group to which the user belongs but also an authentication service of the user.

As shown in FIG. 77, the Join merge provider 13A includes the provider I/F 130, the merge processing part 133, the sub provider calling part 134, the merge provider XML processing part 135, the sub provider registration part 136, the session managing part 137, an ID password analyzing part 138, an authentication ticket managing part 139 and the integrated directory 180.

Further, the provider I/F 130 is formed of the XML processing part 131 and the UID conversion part 132.

As for the construction of the Join merge provider 13A of Example 5 of FIG. 77, it will be noted that the ID password analyzing part 138 and the authentication ticket managing part 139 are added newly to the construction of the Join merge provider 13A of Example 4 of FIG. 64.

The ID password analyzing part 138 acquires the ID and password contained to the issue request of an authentication ticket 500 for certifying the user in the Union merge provider 13 and transmitted from a client (Web portal, for example), and forwards the same to the sub provider calling part 134.

The sub provider calling part 134 forwards the ID and the password given from the ID password analyzing part 138 to the merge provider XML processing part 135 to be described later.

Further, in the case the sub provider 14 that has succeeded in the authentication is a sub-sub provider, the sub provider calling part 134 acquires the authentication ticket ID 610 of the authentication ticket 600 from the sub-sub provider and certifying the user in that sub-sub provider and transmits a confirmation request to the foregoing sub-sub provider via the merge provider XML processing part 135 as will be described later by using the authentication ticket ID 610 of the authentication ticket 600.

Upon acquisition of the confirmation response to the confirmation request from the sub-sub provider through the merge provider XML processing part 135, the sub provider calling part 134 acquires the UID of the same user who is registered to the main sub provider as the user of the main sub provider from the integrated directory 180 by using the UID of the user registered to the mentioned sub-sub provider as the user of the sub-sub provider and is included in the confirmation response.

The Sub provider calling part 134 acquires the authentication ticket ID 610 of the authentication ticket 600 certifying the user corresponding to the UID of the main sub provider thus acquired, from the main sub provider via the merge provider XML processing part 135, by using the managing ID and the managing password for acquisition of the authentication ticket of the main sub provider stored in the sub provider registration part 136, provides the authentication ticket 600 and/or the authentication ticket ID 610 thus acquired to the authentication ticket managing part 139.

As compared with the Example 4, it should be noted that present example differs in the point that the managing ID and the managing password for acquisition of the authentication ticket of the sub provider are registered to the main sub provider registration part 136, as mentioned above.

As will be noted later, the Join merge provider 13A can register the sub provider 14 as a main sub provider by registering the managing ID and managing password for acquisition of the authentication ticket to the sub provider registration part 136.

The authentication ticket managing part 139 creates and manages the authentication ticket 500 certifying the user in the Join merge provider 13A based on the authentication ticket 600 and/or the authentication ticket ID 610 in the main sub provider acquired from the main sub provider.

Also, the authentication ticket managing part 139 transmits the authentication ticket ID 510 of the authentication ticket 500 that certifies the user in the Join merge provider 13A thus created to the client (Web portal, for example) that has required the authentication via the provider I/F130 of the Join merge provider 13A.

The Join merge provider 13A can crate the authentication ticket 500 that certifies the user in the Join merge provider 13A based on the authentication ticket 600 and/or the authentication ticket ID 610 that certifies the user of the main sub provider by conducting the authentication as the user of the main sub provider, also in the case the client has requested the authentication of the user of the sub-sub provider based on the user name and password, and provide the authentication ticket ID 510 of the authentication ticket 500 to the client.

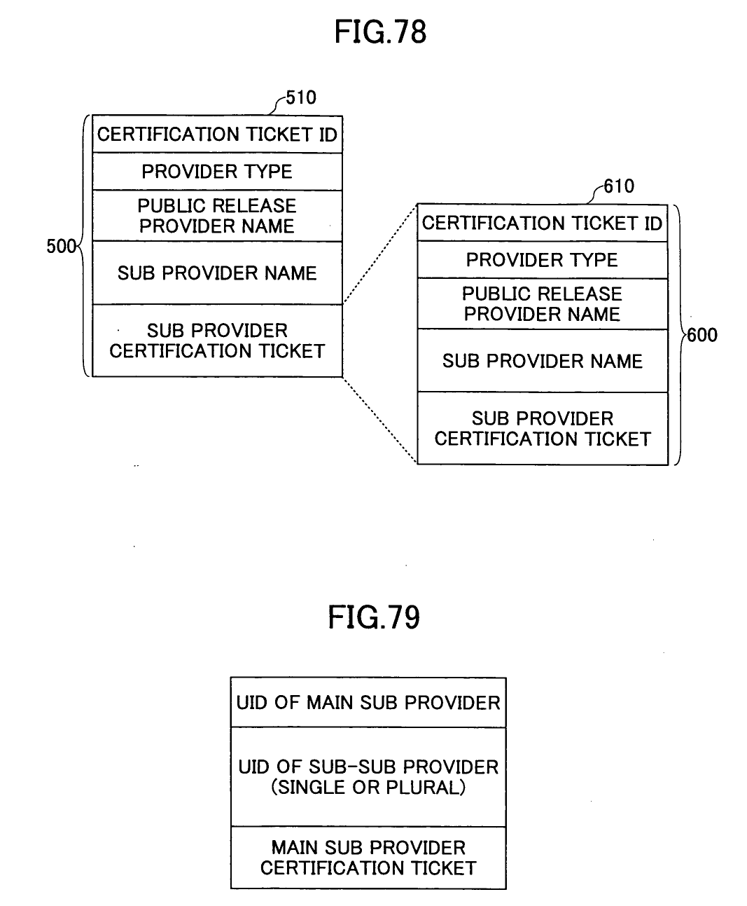

FIG. 78 is a concept diagram for explaining the structure of the authentication ticket of the Join merge provider.

As shown in FIG. 78, the authentication ticket 500 of the Join merge provider 13A has the authentication ticket ID510, the provider type, the provider name for public release, the sub provider name and the authentication ticket 600 of the sub provider as the structure.

It should be noted that the authentication ticket ID 510 is the identifier that distinguishes the authentication ticket. The provider type is the type of the provider, such as “Join merging”.

Further, the provider name released to the public is the name of the Join merge provider 13A to be released to the public such as “Join merging 1”.

The Sub provider name is the name of the main sub provider included in the registered sub providers 14 and succeeded in the authentication and transmission of the authentication ticket 600 has been made. The authentication ticket of the sub provider is the authentication ticket 600 of the main sub provider succeeded in the authentication and the transmission of the authentication ticket 600 has been made.

By providing the structure of the authentication ticket as shown in FIG. 78 to the Join merge provider 13A, the user can finish the authentication in one step.

Furthermore, the authentication ticket of the sub provider may include the decoded authentication ticket 600 of the sub provider 14 succeeded in the authentication and the transmission of the authentication ticket 600 has been made.

FIG. 79 is a concept diagram of the data managed in the integrated directory.

As shown in FIG. 79, the integrated directory 180 integrally manages the UID of the main sub provider and the UID of one or more sub-sub providers and further the authentication ticket of the main sub provider.

By integrally managing the data as shown in FIG. 79, the integrated directory 180 can provide the UID of the same user.

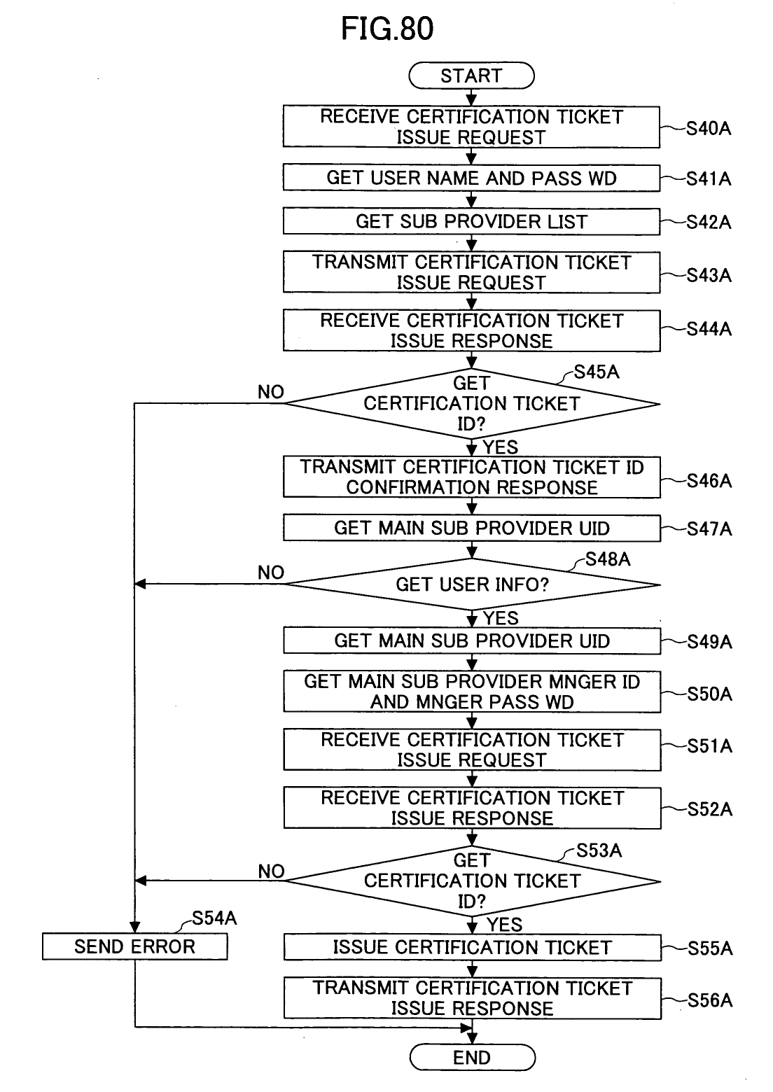

Hereinafter, the process of creating the authentication ticket in the Join merge provider 13A will be explained for the case in which the user name and the password registered to the sub-sub provider are contained as the user of the sub-sub provider in the authentication ticket issue request from the client with reference to FIG. 80.

FIG. 80 is the flowchart of an authentication ticket creation processing in the Join merge provider.

In the step S40A, the XML processing part 131 of Join merge provider 13A receives the issue request of authentication ticket 500 for certifying the user in the Join merge provider 13A from the client (Web portal, for example).

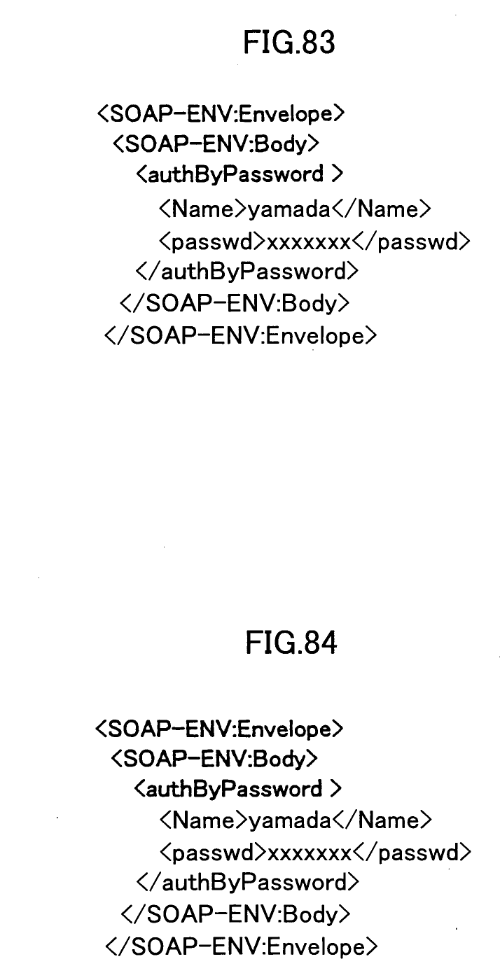

The example of the authentication ticket issue request from the client (Web portal, for example) to the Join merge provider 13A will be described later with reference to FIG. 83.

Following the step S40A, the process proceeds to the step S41A, and the ID password analyzing part 138 gives the user name and password included to the issue request of the authentication ticket received from the client (Web portal, for example) in the step S40A to the sub provider calling part 134.

Following the step S41A, the process proceeds to the step S42A, and the sub provider calling part 134 acquires the list of the sub providers 14 registered in the sub provider registration part 136.

Following the step S42A, the process proceeds to the step S43A, and the merge provider XML processing part 135 crates the issue request of the authentication ticket 600 for certifying the user in the sub provider 14 and containing the ID and password acquired via the sub provider calling part 134 and transmits the same to each of the sub providers 14 registered to the list of the sub providers 14.

The example of the authentication ticket issue request from the Join merge provider 13A to the sub provider 14 will be described later with reference to FIG. 84.

Following the step S43A, the process proceeds to the step S44A, and the sub provider calling part 134 receives the authentication ticket issue response to the issue request for the authentication ticket 600 from the sub-sub provider via the merge provider XML processing part 135.

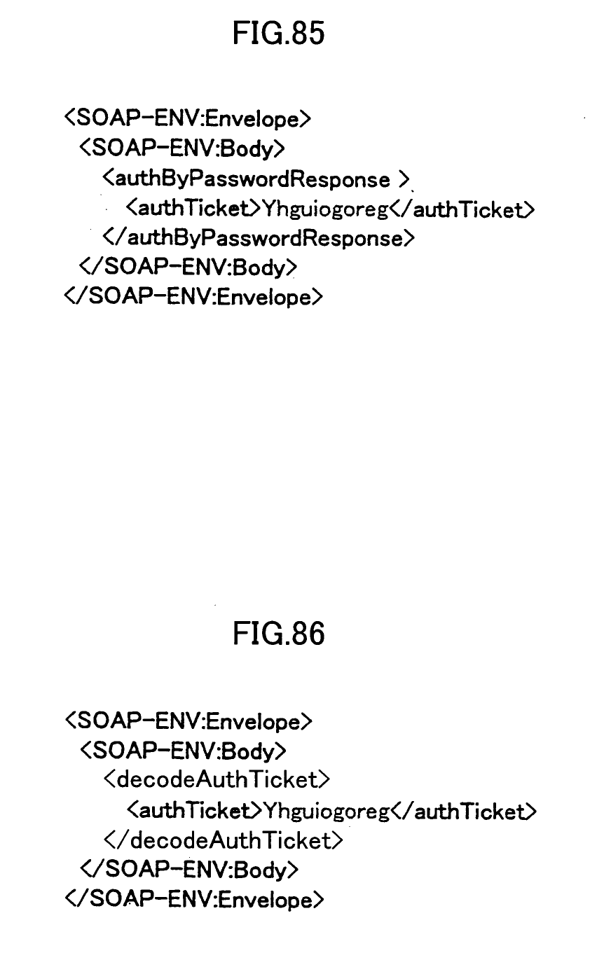

The example of the authentication ticket issue response from the sub-sub provider to the Join merge provider 13A will be explained later with reference to FIG. 85.

Following the step S44A, the process proceeds to the step S45A, and the sub provider calling part 134 determines whether or not the authentication ticket ID 610 that distinguishes the authentication ticket 600 is included in the authentication ticket issue response received from the sub-sub provider in the step S44A.

When it is determined that the authentication ticket ID 610 that distinguishes the authentication ticket 600 is included in the authentication ticket issue response (YES in step S45A), the process proceeds to the step S46A, while when it is determined that the authentication ticket ID 610 that distinguishes the authentication ticket 600 is not contained (NO in the step S45A), the process proceeds to the step S54A.

In the Step S46A, the merge provider XML processing part 135 crates the authentication ticket ID confirmation request including the authentication ticket ID 610 by using the authentication ticket ID 610 distinguishing the authentication ticket 600 and contained in the authentication ticket issue response acquired via the sub provider calling part 134 and transmits the to the sub-sub provider that has transmitted the authentication ticket issue response.

The example of the authentication ticket ID confirmation request from the Join merge provider 13A to the sub provider 14 will be described later with reference to FIG. 86.

Following the step S46A, the process proceeds to the step S47A, and the Sub provider calling part 134 receives the confirmation response of the authentication ticket ID 610 from the sub-sub provider that has transmitted the authentication ticket ID confirmation request, via merge provider XML processing part 135.

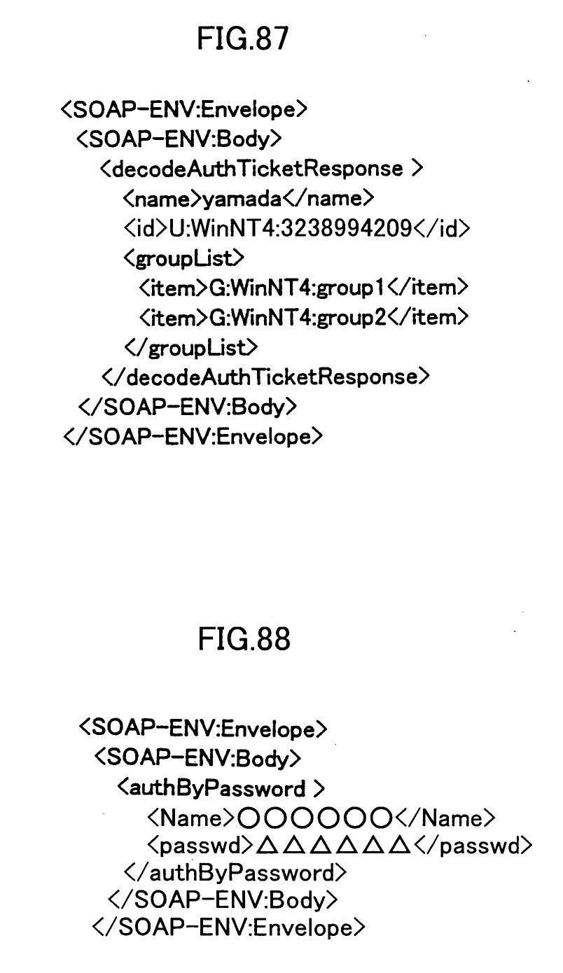

The example of the authentication ticket ID confirmation response from the sub-sub provide to the Join merge provider 13A will be described later with reference to FIG. 87.

Following the step S47A, the process proceeds to the step S48A, and the sub provider calling part 134 determines whether or not the user information is included in the confirmation response of the authentication ticket ID 610 received in the step S47A.

When it is determined that the user information is contained (YES in step S48A), the process proceeds to the step S49A, while when it is determined that the user information is not contained (NO in step S48A), the process proceeds to the step S54A.

In the step S49A, the sub provider calling part 134 acquires the UID of the main sub provider for the same user from than integrated directory 180 by using the UID included in the authentication ticket ID confirmation response from the sub-sub provider acquired in the step S47A.

Following the step S49A, the process proceeds to the step S50A and the sub provider calling part 134 acquires the managing ID and the managing password for acquisition of the authentication ticket of the main sub provider from the sub provider registration part 136.

Following the step S50A, the process proceeds to the step S51A and the merge provider XML processing part 135 creates the issue request for the authentication ticket 600 certifying the user corresponding to the UID of the main sub provider and containing the managing ID and the managing password, which have been acquired via the sub provider calling part 134, for acquisition of the authentication ticket of the main sub provider, and transmits the same to the main sub provider.

The example of the authentication ticket issue request from the Join merge provider 13A to the main sub provider will be describes later with reference to FIG. 88.

Following the step S51A, the process proceeds to the step S52A, and the sub provider calling part 134 receives the authentication ticket issue response to the issue request for the authentication ticket 600 from the main sub provider that has transmitted the authentication ticket issue request via the merge provider XML processing part 135.

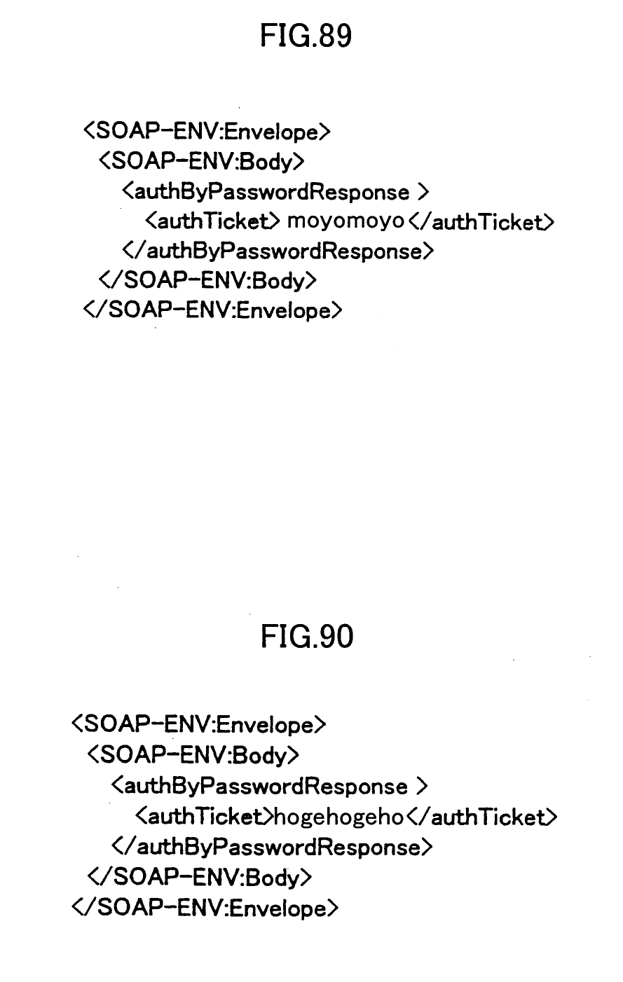

The example of the authentication ticket issue response from the main sub provider to the Join merge provider 13A will be described later with reference to FIG. 89.

Following the step S52A, the process proceeds to the step S53, and the sub provider calling part 134 determines whether or not the authentication ticket ID 610 that distinguishes the authentication ticket 600 is included in the authentication ticket issue response from the main sub provider received in the step S52A.

In the case it is determined that the authentication ticket ID 610 distinguishing the authentication ticket 600 is included in the authentication ticket issue response, (YES in step S53A), the process proceeds to the step S55A, while when it is determined that the authentication ticket ID 610 that distinguishes the authentication ticket 600 is not contained (NO in step S53A), the process proceeds to the step S54A.

In the step S54A, the XML processing part 131 of the Join merge provider 13A creates the response indicating that the creation of the authentication ticket 500 has failed and transmits the same to the client (Web portal for example).

In the Step S55A, the authentication ticket managing part 139 creates the authentication ticket 500 that certifies the user in the Join merge provider 13A as explained in FIG. 78 by using the authentication ticket ID610 of the main sub provider.

Following the step S55A, the process proceeds to the step S56A, and the XML processing part 131 of the Join merge provider 13A creates the authentication ticket issue response including the authentication ticket ID 510 of the authentication ticket 500 created in the step S55A and transmits to the client (Web portal for example).

The example of the authentication ticket issue response from the Join merge provider 13A to the client (Web portal, for example) will be explained later with reference to FIG. 90.

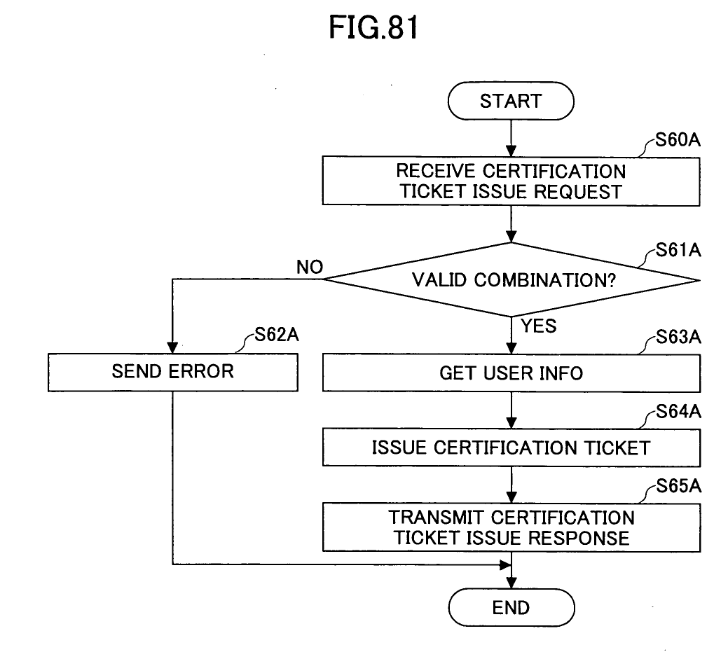

FIG. 81 is the flowchart of authentication ticket creation process in a sub provider.

The sub provider 14 starts the processing from the step S60A as shown below when the Join merge provider 13A has transmitted the issue request for the authentication ticket 600 that certifies the user in the sub provider 14 in the step S43A or step S51A of FIG. 80 to the sub provider 14

In the step S60A, the XML processing part 131 of the sub provider 14 receives the issue request of the authentication ticket 600 that certifies the user in the sub provider 14 from the Join merge provider 13A.

As noted before, the example of the authentication ticket issue request from the Join merge provider 13A to the sub provider 14 will be described later by using FIG. 84. Further, the example of the authentication ticket issue request from the Join merge provider 13A to the main sub provider will be described later with reference to FIG. 88.

Following the step S60A, the process proceeds to the step S61A, and the ID password analyzing part 143 determines whether or not the user name and the password included in the issue request of the authentication ticket 600 received in the step S60A is a valid combination, by confirming with the directory 150 through the directory operation wrapper 141.

When it is determined the combination a valid combination (YES in step S61A),

the process proceeds to the step S63A, while when it is determined that the combination is not a valid combination (NO in step S61A), the process proceeds to the step S62A.

In the step S62A, the XML processing part 131 of the sub provider 14 creates the authentication ticket issue response indicating that the creation of the authentication ticket 600 has failed and it transmits the same to the Join merge provider 13A.

In the step S63A, the authentication ticket managing part 144 acquires the user information corresponding to the user is name and the password from the directory 150 via the directory operation wrapper 141.

Following the step S63A, the process proceeds to the step S64A, and the authentication ticket managing part 144 creates the authentication ticket 600 that certifies the user in the sub provider 14.

Following the step S64A, the process proceeds to the step S65A, and the XML processing part 131 of the sub provider 14 creates the authentication ticket issue response including the authentication ticket ID 610 of the authentication ticket 600 created in the step S64A and transmits the same to the Join merge provider 13A.

As we noted before, the example of the authentication ticket issue response from the sub-sub provider to the Join merge provider 13A will be described later with reference to FIG. 85 and the example of the authentication ticket issue response from a main sub provider to the Join merge provider 13A will be described later with reference to FIG. 89.

Furthermore, it should be noted that the step S44A and/or step S52A of FIG. 80 receives the authentication ticket issue response transmitted in the step S62A or step S65A of FIG. 81.

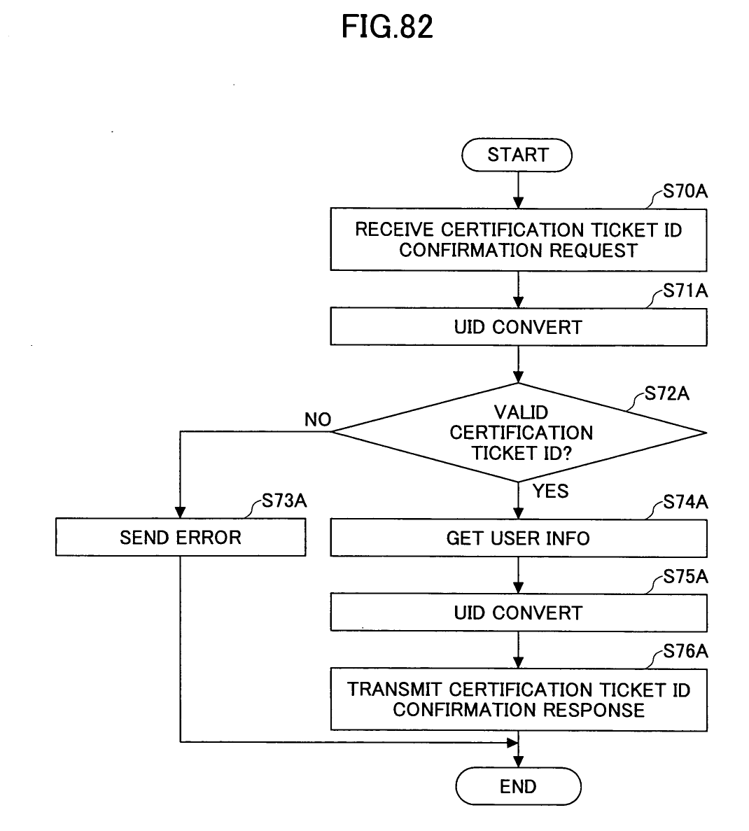

FIG. 82 is the flowchart of an authentication ticket ID confirmation processing in a sub provider.

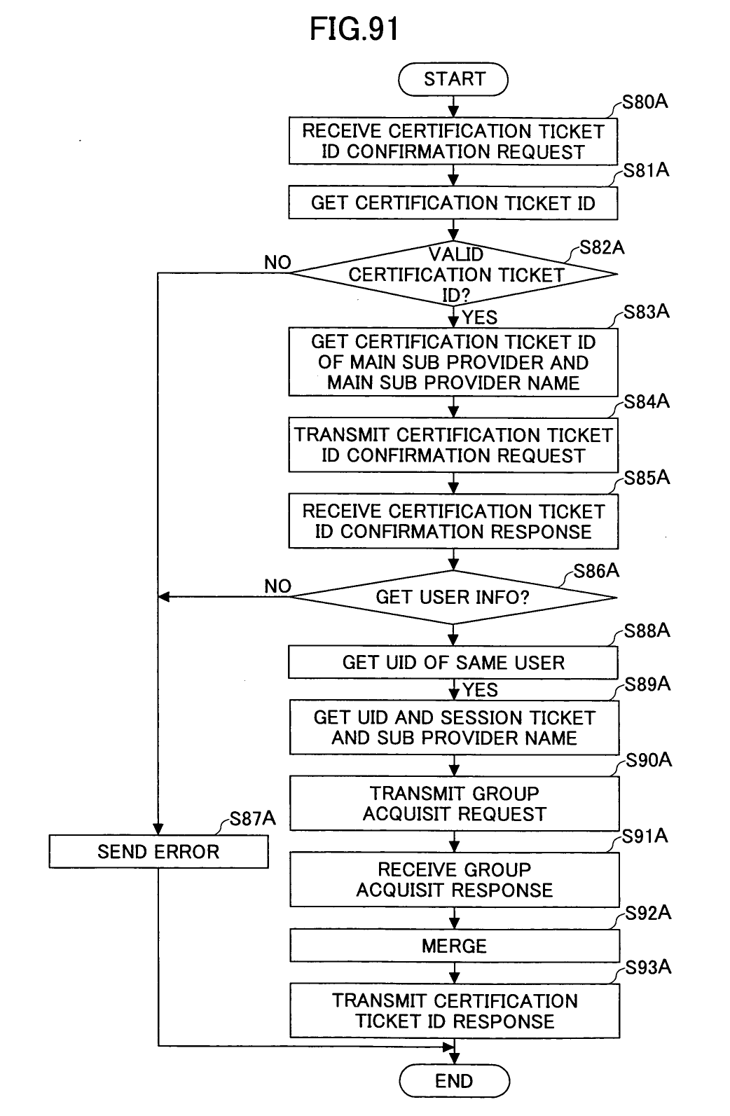

Sub provider 14 starts the processing from the step S70A shown below when the Join merge provider 13A has transmitted the confirmation request of the authentication ticket ID 610 to the sub provider 14 in the step S46A of FIG. 80 and the step S84A of FIG. 91 to be described later.

In the step S70A, the XML processing part 131 of the sub provider 14 receives the confirmation request of the authentication ticket ID 610 from the Join merge provider 13A.

The example of the authentication ticket ID confirmation request from the Join merge provider 13A to the sub-sub provider will be described later with reference to FIG. 86. Also, the example of the authentication ticket ID confirmation request from the Join merge provider 13A to the main sub provider will be described later with reference to FIG. 93.

Following the step S70A, the process proceeds to the step S71A and the UID conversion part 132 of the sub provider 14 converts the UID included in the confirmation request of the authentication ticket ID 610 received in the step S70A into the UID pertinent to the directory 150.

Following the step S71A, the process proceeds to the step S72A and the authentication ticket managing part 144 determines whether or not the authentication ticket ID 610 included in the confirmation request of the authentication ticket ID 610 received in the step S70A is the authentication ticket ID610 of a valid authentication ticket 600.

When it is determined that it is the authentication ticket ID 610 of a valid authentication ticket 600 (YES in step S72A), the process proceeds to the step S74A, while when it is determined it is the authentication ticket ID 610 of an invalid authentication ticket 600 (NO in step S72A), the process proceeds to the step S73A.

In the step S73A, the XML processing part 131 of the sub provider 14 creates the authentication ticket ID confirmation response indicating that the confirmation of the authentication ticket ID 610 has failed and transmits the same to the Join merge provider 13A.

In the step S74, the sub provider 14 acquires the user information from the directory 150 through the directory operation wrapper 141.

Following the step S74A, the process proceeds to the step S75A and the UID conversion part 132 of the sub provider 14 converts the UID peculiar to the directory 150 into the UID available for the Join merge provider 13A.

Following the step S75A, the process proceeds to the step S76A and the XML processing part 131 of the sub provider 14 creates the authentication ticket ID confirmation response including the user information acquired in the step S74A and transmits the same to the Join merge provider 13A.

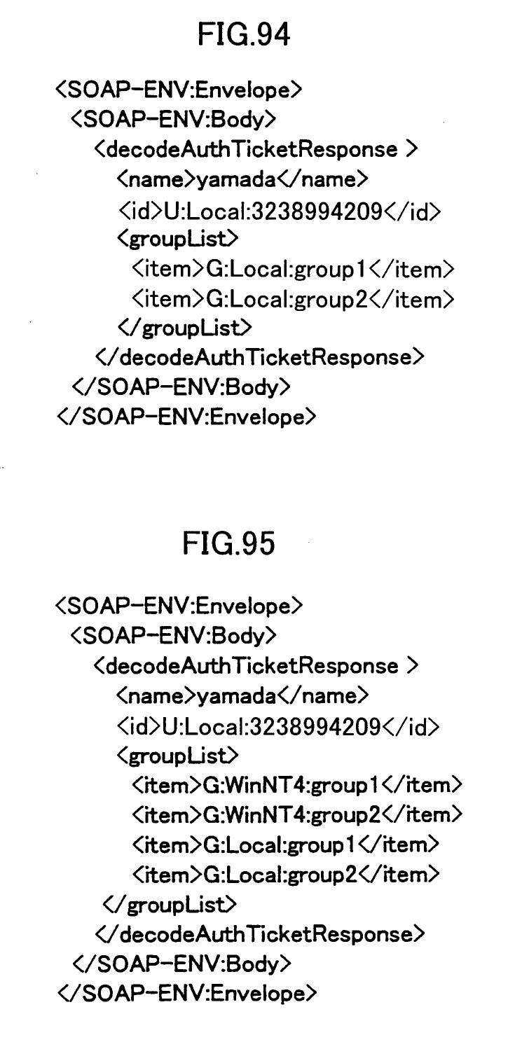

The example of the authentication ticket ID confirmation response from the sub-sub provider to the Join merge provider 13A will be described later with reference to FIG. 87. Also, the example of the authentication ticket ID confirmation response from the main sub provider to the Join merge provider 13A will be described later by using FIG. 94.

It should be noted that the step S47A of FIG. 80 and/or the step S85A of FIG. 91 to be described later receives the authentication ticket ID confirmation response transmitted in the step S73A or step S76A of FIG. 82.

FIG. 83 is the XML message of the example of an authentication ticket issue request from the client to the Join merge provider.

As shown in FIG. 83, the issue request of authentication ticket 500 from the client (Web portal for example) to the Join merge provider 13A includes the user name in the tag <Name></Name> and the password corresponding to the user name in the tag <passwd></passwd>.

The Join merge provider 13A receives the issue request of the authentication ticket 500 that contains the user name and password from the client (Web portal for example).

FIG. 84 is the XML message of an authentication ticket issue request from the Join merge provider to the sub provider.

As shown in FIG. 84, the Join merge provider 13A transmits the issue request of the authentication ticket 600 certifying the user in the sub provider 14 and containing the user name and password included in the issue request of the authentication ticket 500 transmitted from the client (Web portal, for example) as it is, to the sub provider 14.

FIG. 85 is the XML message of an authentication ticket issue response to the Join merge provider from the sub-sub provider.

As shown in FIG. 85, the authentication ticket issue response to the Join merge provider 13A from the sub-sub provider includes the authentication ticket ID 610 of the authentication ticket 600 created in the sub-sub provider in the tag <authTicket></authTicket>.

When the authentication has been succeeded, the sub-sub provider creates the authentication ticket 600 that certifies the user in the sub-sub provider and the authentication ticket issue response including the authentication ticket ID 610 of the authentication ticket 600 and transmits the same to the Join merge provider 13A.

FIG. 86 is the XML message of an authentication ticket ID confirmation request from the Join merge provider to the sub-sub provider.

As shown in FIG. 86, the authentication ticket ID confirmation request from the Join merge provider 13A to the sub-sub provider includes the authentication ticket ID 610 of the authentication ticket 600 that certifies the user in the sub-sub provider acquired from the sub-sub provider shown in FIG. 85 in the tag <authTicket></authTicket>.

FIG. 87 is the XML message of an authentication ticket ID confirmation response to the Join merge provider from the sub-sub provider.

As shown in FIG. 87, the confirmation response of authentication ticket ID 610 to the Join merge provider 13A from the sub-sub provider includes the name of the user in the tag <name></name>, the UID that distinguishes the user in the tag <id></id>, and the group information of group to which the user registered as the user belongs and included in the tag <id></id> of that sub-sub provider, which in turn is included in the tag <groupList></groupList>.

The sub-sub provider acquires the user information and/or the group information of the group to which the user belongs from the directory 150 and transmits the same to the Join merge provider 13A.

FIG. 88 is the XML message of an authentication ticket issue request from the Join merge provider to the main sub provider.

As shown in FIG. 88, the issue request of the authentication ticket 600 from the Join merge provider 13A to the main sub provider includes the managing ID for the authentication ticket acquisition in the tag <Name></Name> and the managing password for the authentication ticket acquisition in the tag <passwd></passwd>.

The Join merge provider 13A transmits the issue request of the authentication ticket 600 that certifies the user corresponding to the UID of the main sub provider and includes the managing ID and managing password for the authentication ticket acquisition of the main sub provider stored in the sub provider registration part 136, to the main sub provider.

FIG. 89 is the XML message of an authentication ticket issue response to the Join merge provider from the main sub provider.

As shown in FIG. 89, the authentication ticket issue response from the main sub provider to the Join merge provider 13A includes the authentication ticket ID 610 of the authentication ticket 600 crated in the main sub provider in the tag <authTicket></authTicket>.

The main sub provider creates the authentication ticket 600 that certifies the user in the sub-sub provider when the authentication has succeeded and transmits the authentication ticket issue response including the authentication ticket ID 610 of that authentication ticket 600 to the Join merge provider 13A.

FIG. 90 is the XML message of an authentication ticket issue response from the Join merge provider to the client.

As shown in FIG. 90 the authentication ticket issue response to the client (Web portal, for example) from Join merge provider 13A includes the authentication ticket ID 510 of the authentication ticket 500 created in the Join merge provider 13A in the tag <authTicket></authTicket>.

The Join merge provider 13A creates the authentication ticket 500 that certifies the user in the Join merge provider 13A explained in FIG. 78 when the authentication ticket ID 610 of the authentication ticket 600 created in the main sub provider is acquired from the main sub provider as we explained it in FIG. 89, and transmits the authentication ticket issue response including the authentication ticket ID 510 of the authentication ticket 500 to the client (Web portal, for example).

Hereinafter, the processing of the Join merge provider 13A and the sub provider 14 for the case the confirmation request of the authentication ticket ID 510 transmitted it in the authentication ticket issue response has been transmitted from the client (application, for example).

FIG. 91 is the flowchart of an authentication ticket ID confirmation processing in the Join merge provider.

In the Step S80A, the XML processing part 131 of the Join merge provider 13A receives the confirmation request of the authentication ticket ID 510 from the client (application, for example).

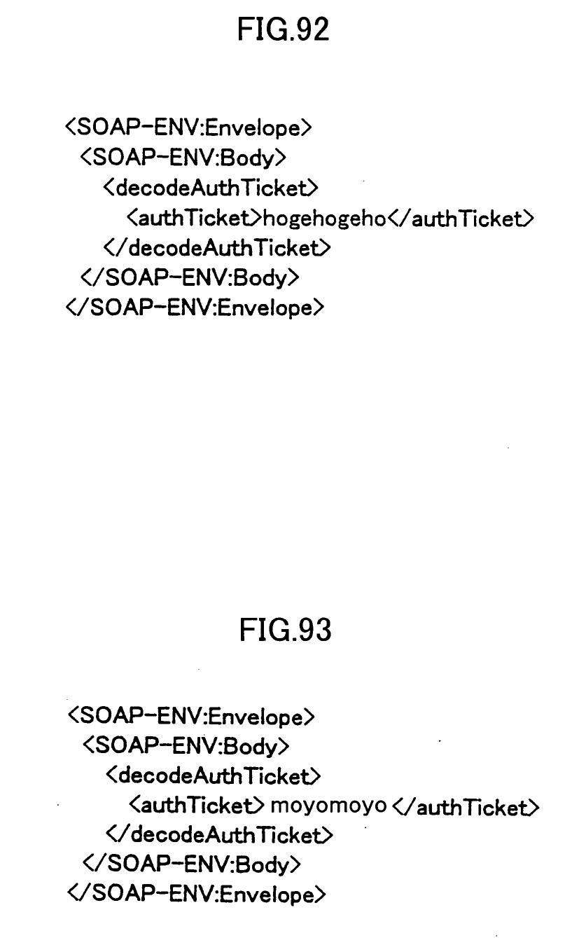

The example of the authentication ticket ID confirmation request from the client (application for example) to the Join merge provider 13A will be described later by using FIG. 92.

Following the step S80A, the process proceeds to the step S81A, and the authentication ticket managing part 139 acquires the authentication ticket ID 510 included in the confirmation request of the authentication ticket ID 510 received it the step S80A.

Following the step S81A, the process proceeds to the step S82A, and the authentication ticket managing part 139 determines whether or not the authentication ticket ID 510 acquired in the step S81A is a valid authentication ticket ID 510.

When it is determined it is the valid authentication ticket ID 510 (YES in step S82A), the process proceeds to the step S83A, while when it is determined it is not the valid authentication ticket ID 510 (NO in step S82A), the process proceeds to the step S87A.

In the Step S83A, the authentication ticket managing part 139 gives the authentication ticket ID 610 of the authentication ticket 600 of the main sub provider included in the authentication ticket 500 of the Join merge provider 13A and the sub provider name of the main sub provider to the sub provider calling part 134.

Following the step S83A, the process proceeds to the step S84A and the merge provider XML processing part 135 creates the authentication ticket ID confirmation request including the authentication ticket ID 610 to the main sub provider, by using authentication ticket ID 610 of the authentication ticket 600 of the main sub provider acquired via the sub provider calling part 134, and transmits the same to the main sub provider.

The example of the authentication ticket ID confirmation request from the Join merge provider 13A to the main sub provider will be described later by using FIG. 93.

Following the step S84, the process proceeds to the step S85 and the sub provider calling part 134 receives the confirmation response of the authentication ticket ID 610 from the main sub provider via the merge provider XML processing part 135.

The example of the authentication ticket ID confirmation response to the Join merge provider 13A from the main sub provider will be described later by using FIG. 94.

Following the step S85A, the process proceeds to the step S86A and the sub provider calling part 134 determines whether or not the user information is included in the confirmation response of the authentication ticket ID 610 received in the step S85A.

When it is determined that the user information is contained (YES in step S86A), the process proceeds to the step S88A, while when it is determined that the user information is not contained (NO in step S86A), the process proceeds to the step S87A.

In the step S87A, the XML processing part 131 of the Join merge provider 13A creates the response indicating that the confirmation of the authentication ticket ID 510 has failed and transmits the same to the client (application for example).

In the step S88A, the sub provider calling part 134 acquires, by using the UID, which is the distinction information distinguishing the users contained in the user information and acquired in the step S86A, the UID of the same user from the integrated directory.

Following the step S88A, the process proceeds to the step S89A and the sub provider calling part 134 acquires the session ticket ID 310 of the session ticket 300 of each of the sub providers 14 managed in the session managing part 137 and the sub provider name.

Following the step S89A, the process proceeds to the step S90A, and the merge provider XML processing part 135 acquires the UID identifying the user and the session ticket ID 310 of the session ticket 300 of the sub provider 14 from the sub provider calling part 134, and creates the acquisition request of the group to which the user belongs and transmits the same to each of the sub providers 14 as explained in Example 4.

Following the step S90A, the process proceeds to the step S91A and the sub provider calling part 134 receives the group acquisition response to the acquisition request of the group from each of the sub providers 14 via the merge provider XML processing part 135.

Following the step S91A, the process proceeds to the step S92A, and the merge processing part 133 merges the user information acquired in the step S85A and the group information of the group to which the user belongs, the user being the one contained in the group acquisition response acquired in step the S91A.

Following the step S92A, the process proceeds to the step S93A and the XML processing part 131 of the Join merge provider 13A creates the authentication ticket ID confirmation response including the user information and the group information of the group to which the use belongs and merged in the step S92A and transmits the same to the client (application, for example)

The example of the authentication ticket ID confirmation response from the Join merge provider 13A to the client will be describes later by using FIG. 95.

FIG. 92 is the XML message of an authentication ticket ID confirmation request from the client to the Join merge provider.

As shown in FIG. 92, the authentication ticket ID confirmation request to from the client (application, for example) to the Join merge provider 13A includes the authentication ticket ID 510 of the authentication ticket 500 that certifies the user in the Join merge provider 13A in the tag <authTicket></authTicket>.

The Join merge provider 13A receives the confirmation request of the authentication ticket ID 510 that includes the authentication ticket ID 510 of the authentication ticket 500 and certifies the user in the Join merge provider 13A from the client (application, for example).

FIG. 93 is the XML message of an authentication ticket ID confirmation request from the Join merge provider to the main sub provider.

As shown in FIG. 93, the authentication ticket ID confirmation request from the Join merge provider 13A to the main sub provider includes the authentication ticket ID 610 of the authentication ticket 600 that certifies the user in the main sub provider in the tag <authTicket></authTicket>.

Because the Join merge provider 13A manages the authentication ticket 600 of the main sub provider in the form included in the authentication ticket 500 of that Join merge provider 13A, as explained in FIG. 78, it is possible to acquire the authentication ticket ID 610 of the authentication ticket 600 of the main sub provider based on the authentication ticket ID 510 of the authentication ticket 500 of the Join merge provider 13A included in the authentication ticket confirmation request transmitted from the client (application, for example) and include this authentication ticket ID 610 to the XML message.

FIG. 94 is the XML message of an authentication ticket ID confirmation response from the main sub provider to the Join merge provider.

As shown in FIG. 94, the confirmation response of the authentication ticket ID 610 from the main sub provider to the Join merge provider 13A includes the name of the user in the tag <name></name>, the UID of the user registered to the main sub provider as the user of the main sub provider in the tag <id></id>, and the group information of the group in the main sub provider to which the user belongs in each of the tags <item></item> included in the tag <groupList></groupList>.

The main sub provider acquires the user information and the group information of the group to which that user belong from the directory 150 and transmits the same to the Join merge provider 13A.

FIG. 95 is the XML message of an authentication ticket ID confirmation response from the Join merge provider to the client.

As shown in FIG. 95, the Join merge provider 13A stores the name of the user in the tag <name></name>, the UID of the user in the main sub provider in the tag <id></id> and the group information of the group to which that same user belongs and acquired from each of the sub providers 14 in one or more tags <item></item> included in one tag <groupList></groupList>, and transmits the same to the client.

Because the Join merge provider 13A can acquire the UID that distinguishes the user from the main sub provider as explained in FIG. 94, it is possible to acquire the UID of the same user from the integrated directory 180 by using that UID and to acquire the group information from each of the sub providers 14 about the groups in which the same user is registered as the user of the sub providers 14 by using the acquired UID and the session ID 310 of the session ticket 300 of sub provider 14.

For example, G:WinNT4:group1 and G:WinNT4:group2 stored in the tag <item></item> of FIG. 95 are the group information of the group to which the user 3238994209 (yamada), registered to the WinNT authentication directory provider 7 as the user thereof, belongs. Further, G:Local:group1 and G:Local:group2 stored in the tag <item></item> of FIG. 95 are the group information of the group to which the user 3238994209 (yamada), registered to the Local authentication directory provider 8 as the user thereof, belongs.

The Join merge provider 13A can merge these group information and provide to the client.

As explained with Example 5, the user is certified as the user of the main sub provider by merely transmitting the user name and password once to the Join merge provider 13A for authentication even in the case that sub provider 14 requires the authentication, and it is possible to acquire the group information of the groups to which the same user belongs from all of the registered sub providers 14.

In the explanation of Example 5, explanation has been made of the case in which the authentication ticket ID 510 and/or the authentication ticket ID 610 are transmitted and received between the Join merge provider 13A and the sub provider 14 and between the Join merge provider 13A and the client. However, this does not limit the present invention this enforcement and it is also possible to transmit and receive the authentication ticket 500 and/or the authentication ticket 600. This applies also to the cases described below.

Furthermore, the Join merge provider 13A can designate plural main sub providers.

By storing the managing ID and the managing password for acquisition of the authentication ticket of the sub-sub provider in the sub provider registration part 136, the Join merge provider 13A can designate the sub-sub provider as the new main sub provider.

For example, the Join merge provider 13A uses, when a managing ID and a managing password of a sub-sub provider are registered newly in the sub-provider registration part 136, this sub-sub provider as the new main sub provider, and acquires the authentication ticket 600 and/or the authentication ticket ID 610 certifying the user in that main sub provider from the main sub provider by using the foregoing managing ID and the managing password.

The Join merge provider 13A transmits the authentication ticket ID confirmation request to the main sub provider by using the authentication ticket ID 610 thus acquired, and acquires the UID of the main sub provider from the main sub provider.

The Join merge provider 13A registers the authentication ticket 600 thus acquired and certifying the user in the main sub provider and the UID of the main sub provider in the integrated directory 180.

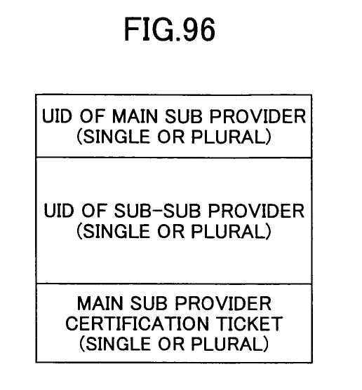

FIG. 96 is the concept diagram of the data managed in the integrated directory.

As shown in FIG. 96, the integrated directory 180 manages by integrating the UIDs of one or more main sub providers and one or more sub-sub providers and the authentication tickets of one or more main sub providers

The Join merge provider 13A can manage by designating plural main sub providers.

The difference between the main sub provider and the sub-sub provider is that whether or not the managing ID and the managing password are registered in sub provider registration part 136.

For example, in the case a new sub provider 14 is added to the Join merge provider 13A,

the new sub provider 14 becomes a main sub provider when the managing ID and the managing password are registered in the sub provider registration part 136. When the managing ID and the managing password are not registered to the sub provider registration part 136, on the other hand, the new sub provider 14 becomes a sub-sub provider.

By using such a construction, the client can choose the main sub provider and selectively permit the user and/or the user group registered to that main sub provider to use the service that the client provides.

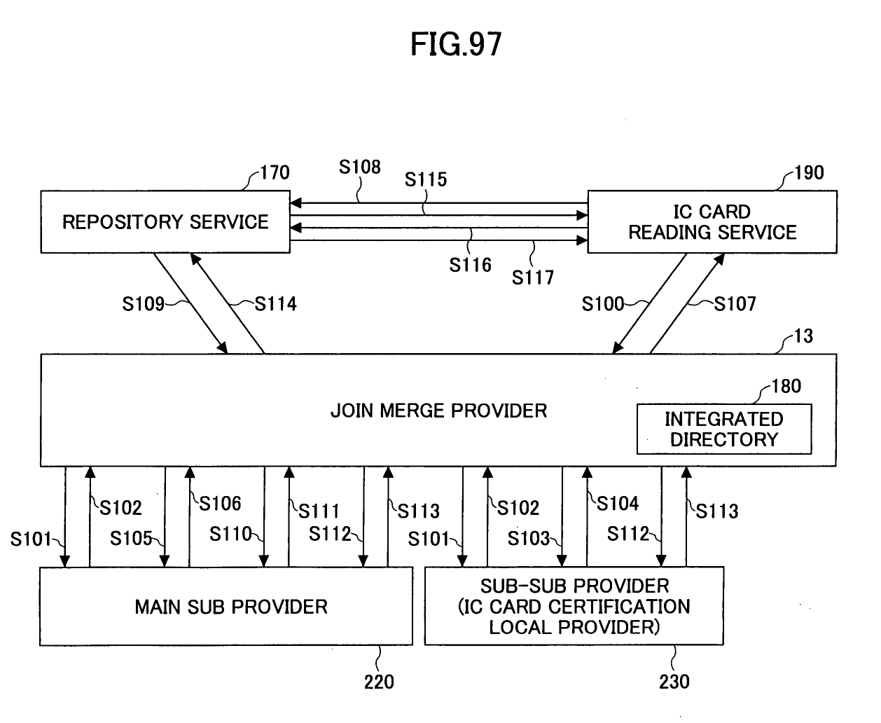

Hereinafter, the example for the case of introducing the Join merge provider 13A will be explained with reference to FIG. 97.

FIG. 97 is a diagram for explaining the example of conducting the authentication of a user by reading an IC card by utilizing the Join merge provider and acquires the document accumulated in the repository service.

In the step S100, the IC card reading service 190 give the user name and password read from the IC card to Join merge provider 13A.

Following the step S100, the process proceeds to the step S101 and the Join merge provider 13A transmits the issue request of the authentication ticket 600 that contains the user name and password acquired in the step S100 to the main sub provider 220 and to the IC card authentication Local provider 230, which is a sub-sub provider.

The IC card authentication Local provider 230 forming a sub-sub provider carries out the authentication by using the above-mentioned user name and the password and issues the authentication ticket 600 in the case that the authentication has succeeded.

Following the step S101, the process proceeds to the step S102, and the IC card authentication Local provider 230, which is a sub-sub provider, issues the authentication ticket issue response including the authentication ticket ID 610 of authentication ticket 600 and transmits the same to the Join merge provider 13A. Further, the main sub provider 220 issues the authentication ticket issue response indicating that the authentication has failed and transmits the same to the Join merge provider 13A.

Following the step S102, the process proceeds to the step S103 and the Join merge provider 13A transmits the confirmation request of the authentication ticket ID 610 to the IC card authentication Local provider 230 by using the authentication ticket ID 610 of the authentication ticket 600.

Furthermore, it is possible to construct such that the Join merge provider 13A transmits the confirmation request of the authentication ticket ID 610 to all of the registered sub providers subjected to the management.

Following the step S103, the process proceeds to the step S104 and the IC card authentication Local provider 230 transmits the confirmation response of the authentication ticket ID 610 including the UID of the user who has succeeded in the authentication to the Join merge provider 13A.

The join merge provider 13A acquires the UID of the main sub provider for the same user from the integrated directory 180 based on the UID included in the acquired authentication ticket confirmation response.

Following the step S104, the process proceeds to the step S105 and the Join merge provider 13A transmits the issue request of the authentication ticket 600 of the user corresponding to the UID of the main sub provider to the main sub provider 220, by using the managing ID and the managing password of the main sub provider for creation of the authentication ticket.

The main sub provider 220 carries out the authentication of the user corresponding to that UID and by using the managing ID and the managing password, and when the authentication has succeeded, the main sub provider 220 issues the authentication ticket 600.

Following the step 105, the process proceeds to the step S106, and the main sub provider 220 creates the authentication ticket issue response including the authentication ticket ID 610 of the authentication ticket 600 and transmits the same to the Join merge provider 13A.

Following the step S106, the process proceeds to the step S107 and the Join merge provider 13A creates, upon acquisition of the authentication ticket issue response including the authentication ticket ID 610 from the main sub provider 220, the authentication ticket 500 certifying the user in the Join merge provider 13A and transmits the authentication ticket issue response including the authentication ticket ID 510 of the authentication ticket 500 thus created to that IC card reading service 190.

Following the step S107, the process proceeds to the step S108 and the IC card reading service 190 transmits the issue request of the session ticket 700 containing the authentication ticket ID 510 acquired in the step S107 and permits the use of the service provided by the repository service to the repository service 170.

Following the step S108, the process proceeds to the step S109 and the repository service 170 transmits, in order to confirm whether or not the issue request of the session ticket 700 that received in the step S108 is the request from a valid user, the authentication ticket ID confirmation request including the authentication ticket ID 510 to the Join merge provider 13A, by using that authentication ticket ID 510 included in the issue request of the session ticket 700.

Following the step S109, the process proceeds to the step S110 and the Join merge provider 13A transmits the confirmation request of the authentication ticket ID 610 acquired from the main sub provider 220 in the step S106 based on the authentication ticket ID 510 contained in the authentication ticket ID confirmation request acquired in the step S109, to the main sub provider 220.

Following the step S110, the process proceeds to the step S111 and the main sub provider 220 transmits the authentication ticket confirmation response including the UID of the user corresponding to the authentication ticket ID 610 included in the confirmation request of the authentication ticket ID 610 to the Join merge provider 13A.

The Join merge provider 13A acquires the UID of the same user from the integrated directory 180 based on the UID included in the authentication ticket confirmation response thus acquired.

Following the step S111, the process proceeds to the step S112 and the Join merge provider 13A transmits the acquisition request of the group information of the group to which the user corresponding to the UID belongs and including therein the UID of the user registered to the main sub provider 220 as the user of the main sub provider 220 and the session ticket ID 310 of the session ticket 300 of the main sub provider 220, to the main sub provider 220.

Alternatively, the Join merge provider 13A may transmit the acquisition request of the group information for the group to which the user corresponding to the UID belongs and including therein the UID of the user registered to the IC card authentication Local provider 230 as the user of the IC card authentication Local provider 230 and the session ticket ID3 10 of the session ticket 300 of the authentication Local provider 230, to the IC card authentication Local provider 230.

Following the step S112, the process proceeds to the step S113 and the Join merge provider 13A and/or the IC card authentication Local provider 230 creates the acquisition response including the group information of the group to which the user corresponding to the UID belongs, the UID being the one included in the acquisition request of the group information for the group to which the user belongs, to Join merge provider 13A.

Following the step S113, the process proceeds to the step S114 and the Join merge provider 13A merges the user information acquired in the step S11 and/or the group information of the group to which the user belongs and acquired in the step S113, and creates the authentication ticket ID confirmation response including the merged information, and transmits the same to the repository service 170.

Following the step S114, the process proceeds to the step S115 and the repository service 170 creates, in the case there exists a group permitted to use the service provided by the repository service 170 in the groups acquired in the step S114, creates the session ticket 700 permitting the use of the service and transmits the issue response of the session ticket including the session ticket ID710 of the session ticket 700 to the IC card reading service 190.

Following the step S115, the process proceeds to the step S116 and the IC card reading service 190 transmits the acquisition request of the document including the session ticket ID 710 of the session ticket 700 thus acquired to the repository service 170.

Following the step S116, the process proceeds to the step S117 and the repository service 170 determines whether or not the session ticket ID 710 included in the acquisition request of the document acquired in the step S116 is the session ticket ID710 of a valid session ticket 700. In the case it is determined that the session ticket ID 710 is a valid session ticket ID 710, the repository service 170 transmits the acquisition response of the document including the designated document to the IC card reading service 190.

By introducing Join merge provider 13A the user is certified by the IC card authentication Local provider 230, for example, by just passing the IC card. Thus, as long as he or she is the same user, the user can use the repository service 170 that permits the use thereof only to the users of main sub provider 220.

### EXAMPLE 6

Hereinafter, the information (configuration information) related to the construction of the Join merge provider 13A and the sub provider 14 is managed outside the Join merge provider 13A will be described.

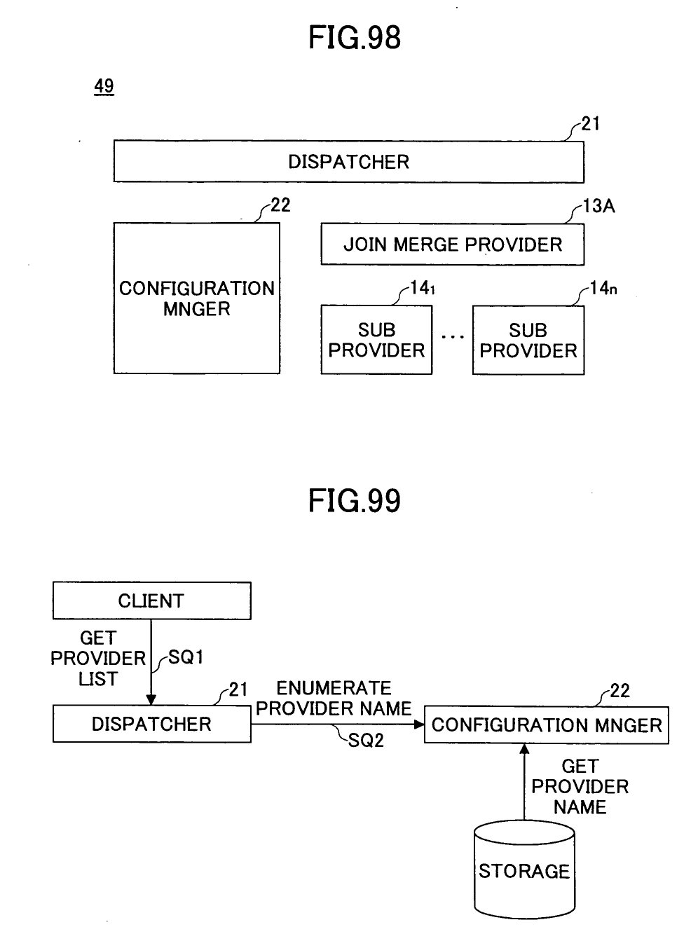

FIG. 98 is another diagram explaining the construction of the UCS. For the sake of simplicity of explanation, the explanation below with reference to FIG. 98 assumes that the Join merge provider 13A and all of the sub providers 14 are included in the UCS49A as in the case of FIG. 61. As noted before, some or all of the sub providers 14 may be included in other fusion machine 120, and the like.

The UCS 49A shown in FIG. 98 includes a dispatcher 21, a configuration manager 22, the Join merge provider 13A and the sub providers 14₁-14ₙ.

The dispatcher 21 receives the request from the client and distributes the request to the configuration manager 22, the Join merge provider 13A, and the like, and further transmits the processing result that the configuration manager 22 or the Join merge provider 13A has processed according to the distributed request, to the client.

It should be noted that the configuration manager 22 is the managing part managing the construction of the Join merge provider 13A and the sub providers 14₁-14ₙ and holds the construction information in the storage part.

Here, it should be noted that the Join merge provider 13A and the sub provider 14 are identical to those explained with reference to Example 4 or Example 5.

Hereinafter, the example of the provider list acquisition sequence will be explained with reference to FIG. 99, wherein it should be noted that FIG. 99 is a diagram for explaining the example of the provider list acquisition sequence.

As shown in FIG. 99, the client transmits, in the example of adding a new provider as the sub provider 14 of the Join merge provider 13A, the provider list acquisition request including the getProviderList method of the dispatcher 21, to the dispatcher 21 (Sequence SQ1).

The dispatcher 21 that has received the provider list acquisition request calls the enumerateProviderName method of the configuration manager 22 (Sequence SQ2).

The configuration rations manager 22 that has been subjected to the call of the enumerateProviderName method acquires the provider name, and the like, from the storage part and returns the same to the dispatcher 21 as the provider list.

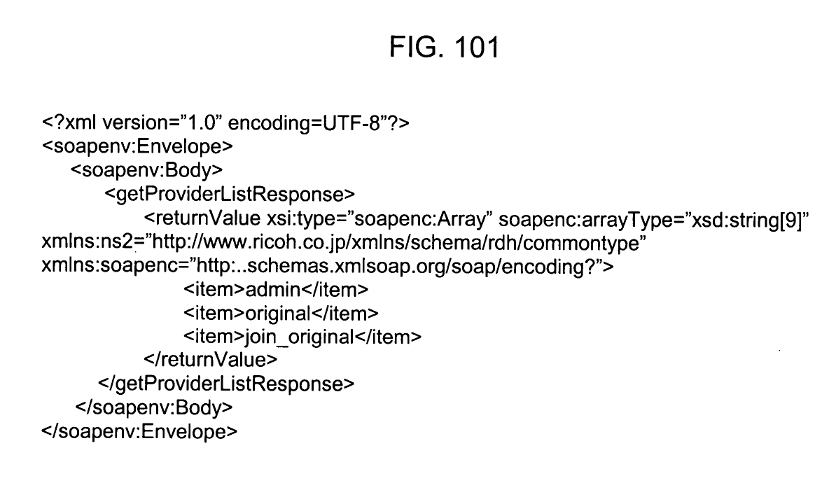

The dispatcher 21 creates the provider list acquisition response including the provider list and transmits the same to the requesting client. The example of the provider list acquisition response will be explained later with reference to FIG. 101.

For example, by conducting the processing shown in FIG. 99, the client displays the list of the providers and the user can select the provider to be added newly from the list of the providers as the sub provider 14 of the Join merge provider 13A.

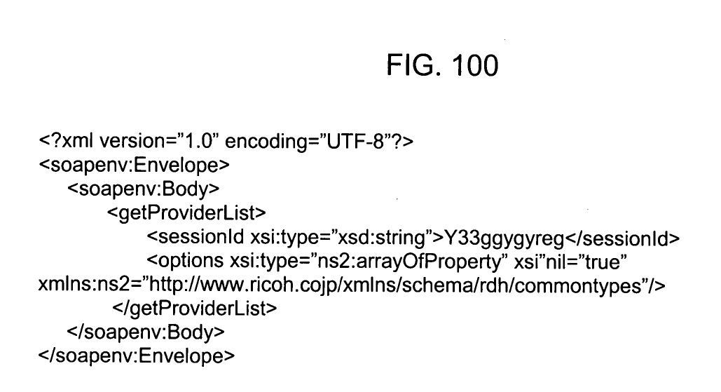

Hereinafter, the example of the provider list acquisition request will be shown with reference to FIG. 100, wherein FIG. 100 is an example of the the XML message of a provider list acquisition request from the client to the dispatcher.

As shown in FIG. 100, it can be seen that the getProviderList method is included in the provider list acquisition request.

Hereinafter, an example of the provider list acquisition response will be described with reference to FIG. 101, wherein FIG. 101 is an example of the XML message of the provider list acquisition response from the dispatcher to the client.

As shown in FIG. 101, the name of the provider (or the identifier distinguishing the provider) is stored in the tag of <item></item>.

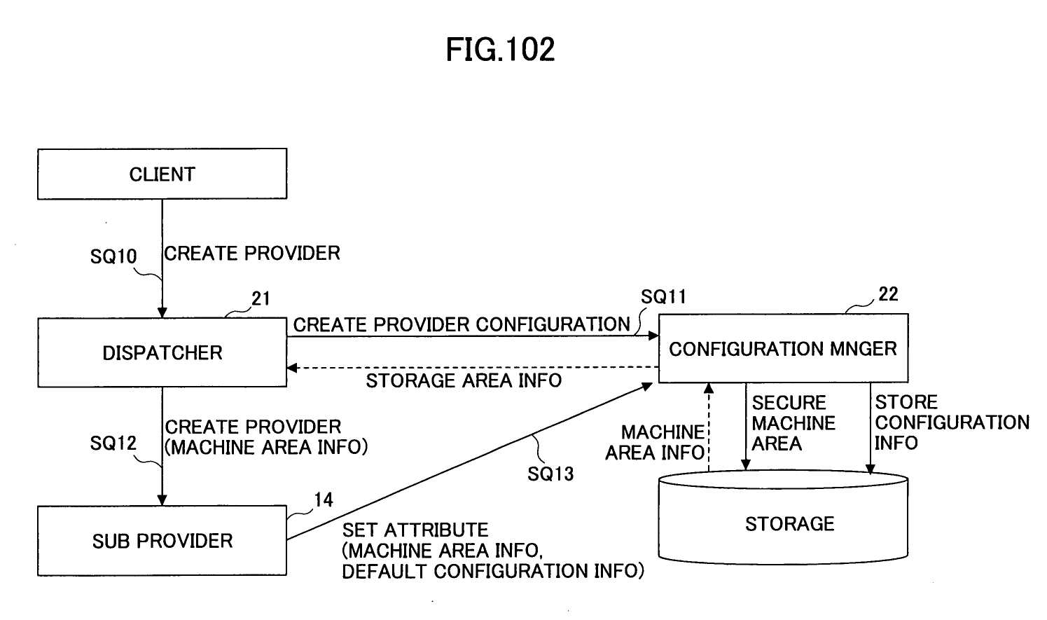

Next, an example of the sub provider addition sequence will be explained with reference to FIG. 102, wherein FIG. 102 is a diagram explaining the example of the sub provider addition sequence.

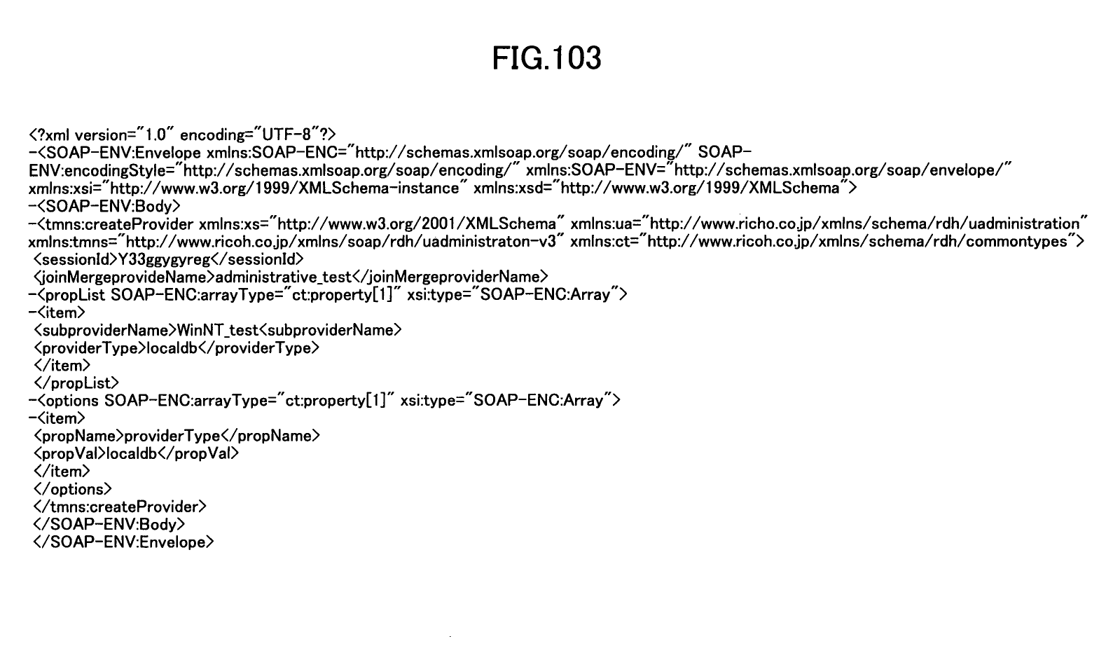

When the user has selected the provider to be added from the provider list as shown in FIG. 102 by using a GUI (Graphical User Interface) to be described later, the client transmits the sub provider addition request including the createProvider method of dispatcher 21 to the dispatcher 21 (sequence SQ10). Here, the example of the sub provider addition request will be shown later with reference to FIG. 103. While being omitted in FIG. 102, the sub provider addition request includes the information as to what sub provider 14 is to be added to what Union merge providers 13.

The dispatcher 21 that has received the sub provider addition request calls the createProviderConfiguration method of the configuration manager 22 (sequence SQ11).

The configuration manager 22 called by the createProviderConfiguration method secures a new region in the storage part for storing the construction information and returns the storage area information regarding that region (head address, and the like of the newly secured region) to the dispatcher 21.

The dispatcher 21 that has thus acquired the storage area information calls the createProvider method of the sub provider 14 to be added while using the storage area information as the argument (Sequence SQ12).

The sub provider 14 having the createProvider method thus called calls the setAttribute method of the configuration manager 22 (Sequence SQ13) while using the storage area information provided as the argument of the createProvider method and further the default construction information of the identifier, the name of the sub provider 14, and the like, as the argument.

The configuration manager 22 having the setAttribute method thus called stores the construction information including the default construction information of the sub provider 14 given as the argument of the setAttribute method in a corresponding storage region based on the storage area information given as the argument of the setAttribute method.

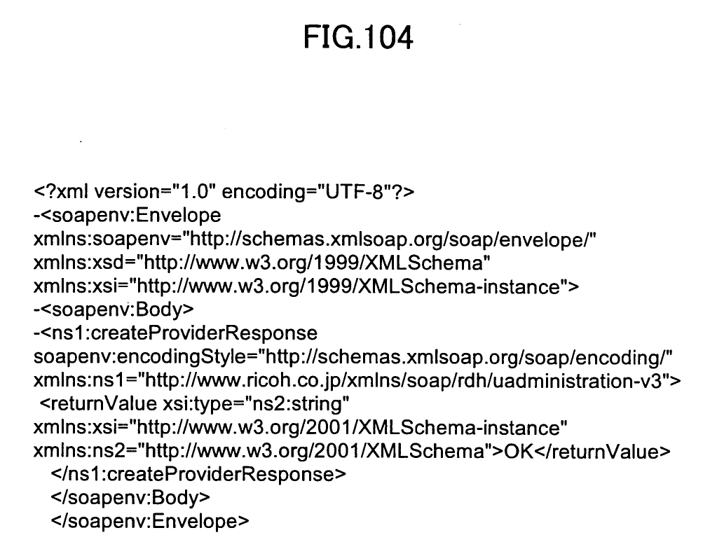

The dispatcher 21 received the information indicating that the construction information has been stored from the configuration manager 22 creates the sub provider addition response including the information indicating that the addition of the provider has completed normally, and transmits the same to the requesting client. The example of the sub provider addition response will be shown later with reference to in FIG. 104.

By conducting the processing shown in FIG. 102, it is possible to add a new provider as the sub provider 14 of the Join merge provider 13A.

Hereinafter, the example of the sub provider addition request will be explained with reference to FIG. 103, wherein FIG. 103 is the XML message of a sub provider addition request from the client to the dispatcher.

As shown in FIG. 46, the sub provider addition request includes the createProvider method. Further, the identifier or the name of the Join merge provider is included in the tag <JoinMergeproviderName></JoinMergeproviderName> as, the argument of the createProvider method. Also, the identifier or the name of the sub provider to be newly added is included in <subproviderName></subproviderName> of the <item></item> tag.

Hereinafter, the example of the sub provider addition response will be explained with reference to FIG. 104, wherein FIG. 104 is the XML message of a sub provider addition response from the dispatcher to the client.

As shown in FIG. 104, the tag <returnValue></returnValue> of the sub provider addition response includes the information representing whether or not the addition of the sub provider has been successful (O.K. in the example of FIG. 104).

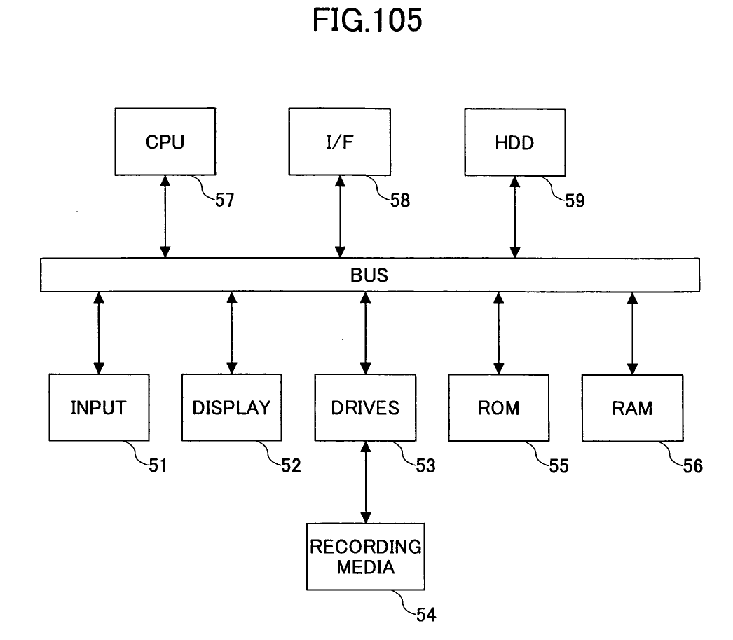

Hereinafter, an example of the hardware construction of the client will be explained with reference to FIG. 105, wherein FIG. 105 is the hardware construction diagram of a client.

The hardware construction of the client shown in FIG. 105 is formed of an input device 51, a display device 52, a drive device 53, a recording medium 54, a ROM55, a RAM56, a CPU57, an interface device 58 and a HDD59 connected with each other by a bus.

The input device 51 is formed of a keyboard, mouse, and the like operated by the user of the client and is used for inputting the various operational signals to the client. On the other hand, the display device 52 is formed of a display, and the like, used by the user of the client and is used for displaying various information. The interface device 58 is an interface connecting the client to the network 5, and the like.

For example, the application program, and the like used for implementing the processing in the client is provided to the client by the recording medium 54 of the CD-ROM, and the like, or downloaded through the network 5. The recording medium 54 is set to the drive device 53 and the application program is installed to the HDD 59 from the recording medium 54 through the drive device 53.

The ROM 55 stores the data, and the like. The RAM56 reads the application program, and the like, from the HDD 59 at the time of the activation of the client and holds the same. The CPU57 carries out the processing according to the application program, and the like, read out to the RAM 56 and held therein. Further, the HDD 59 stores the data, files, and the like.

Although the foregoing explanation has been made by using the fusion machine 120 as an example of the apparatus on which the Join merge provider 13A and/or the sub provider 14 are mounted, it is also possible to construct so as to be mounted on a PC (personal computer) shown in FIG. 105.

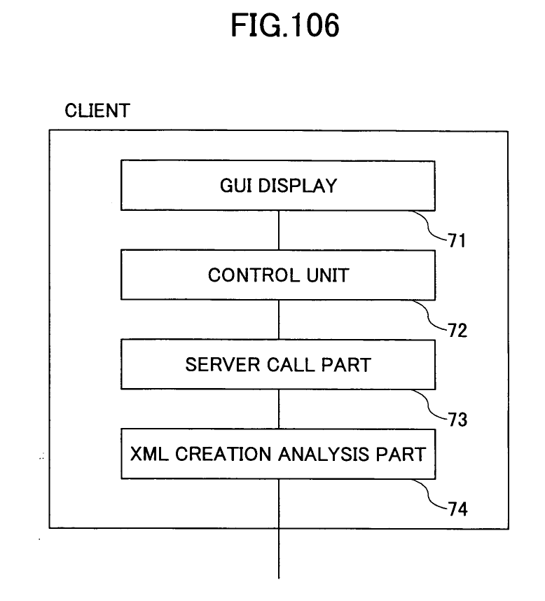

Hereinafter, an example of the function of the client will be explained with reference to FIG. 106, wherein FIG. 106 is a functional block diagram of a client.

Below, an example of the function of the client will be described with reference to FIG. 106 wherein FIG. 106 is the functional exploded diagram of the client.

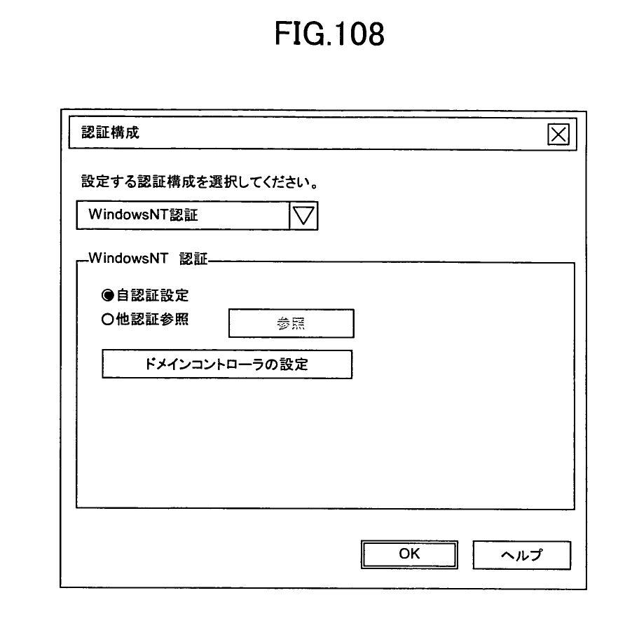

As shown in FIG. 108, the client includes the GUI display part 71, a control unit 72, a server calling part 73 and a XML generation analysis part 74.

The GUI display part 71 is the display part creating GUI to be describes later and displaying the same in the display, and the like, of the client. The control unit 72 is the control unit that controls the overall processing of the client. The server calling part 73 is the calling part that calls the server including the Join merge provider 13A, and the like. Further, the XML generation analysis part 74 generates the XML and transmits the same to the server and further analyzes the XML message received from the server and acquires the data, and the like included in the XML message.

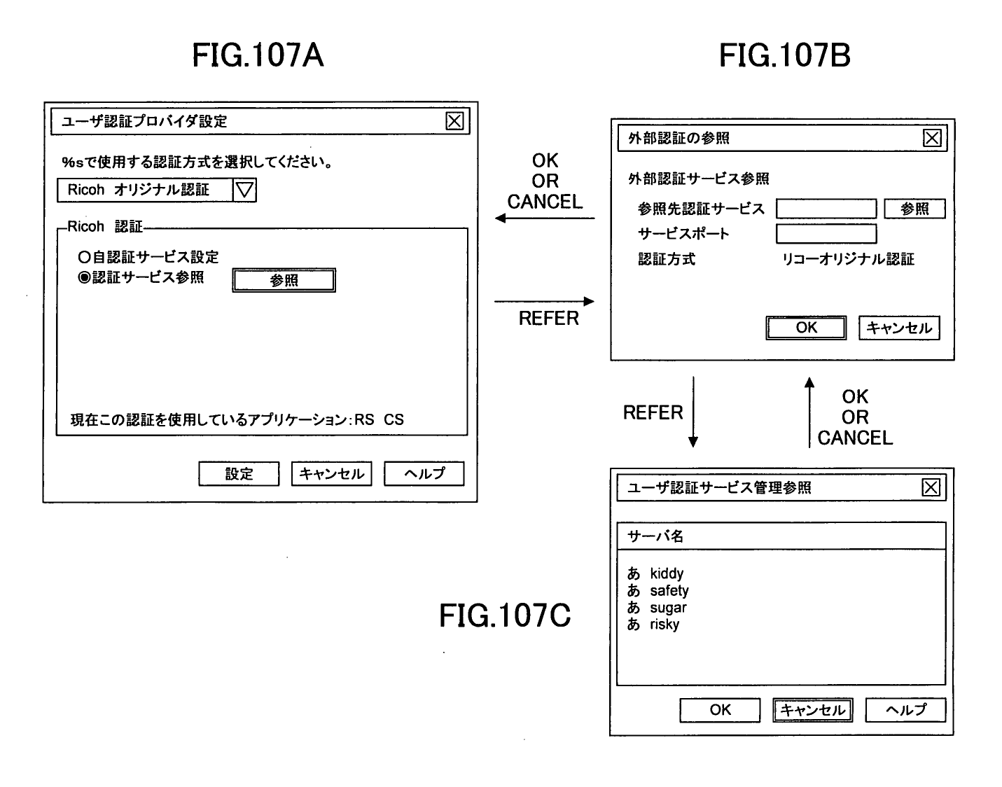

Hereinafter, an example of the GUI for setting up the provider in the client will be explained with reference to FIGS. 107A-107C, wherein FIGS. 107A-107C are the diagrams showing the GUI regarding the setting up of the provider in the client.

The client creates, when the provider list acquisition response shown in FIG. 101 is received, the user authentication provider setting screen that contains the list of the providers in the drop down menu as shown in FIG. 107A based on the list of the providers included in the provider list acquisition response and displays the same.

It should be noted that the content of the group box displayed under the drop down menu of the user authentication provider setting screen shown in FIG. 107A changes by the provider which the user has selected from the drop down menu.

For example, when the user has selected “authentication service reference” and clicked the “reference” button in FIG. 107A, the client displays the reference screen for the external authentication as shown in FIG. 107B. Here, it should be noted that the external authentication is the authentication that carries out the actual authentication (the ID password analyzing part 143 and the authentication ticket managing part 144 in the example of FIGS. 73A-73C), by using an server, and the like as the authentication engine.

When the user has clicked the “reference” button in FIG. 107B, the client displays the user authentication service management reference screen as shown in FIG. 107C.

Hereinafter, another example of the GUI for setting up the client will be shown in FIG. 108, wherein FIG. 108 is the second diagram showing the GUI for setting up the provider in the client.

In FIG. 108, an example screen is shown for the case in which the user has chosen the Windows (trade mark) the NT authentication in the drop down menu. It should be noted that the “setting of domain controller” button of FIG. 51 becomes effective only in the case the user has selected “self authentication setting”.

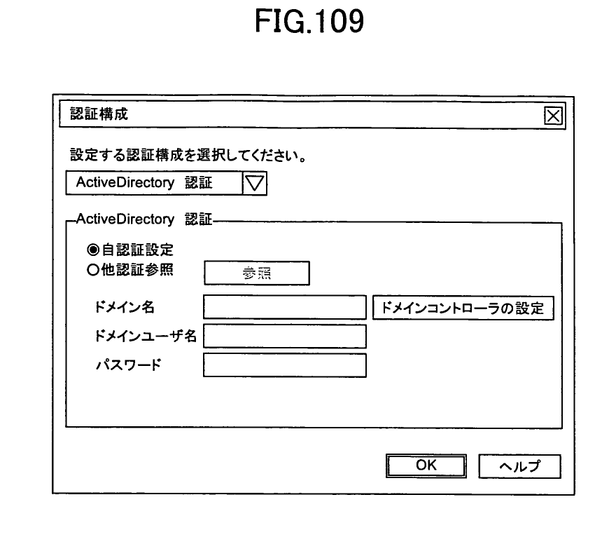

Hereinafter, the example other GUI for setting up the provider in the client will be shown in FIG. 109, wherein FIG. 109 is the third diagram showing the GUI for setting up the provider in the client.

In FIG. 109, an example screen for the case that the user has selected the ActiveDirectory (trade mark) authentication in the drop down menu. Here, it should be noted that the “setting of the domain controller” button of FIG. 109 becomes effective only in the case that the user has selected “the self authentication setting”.

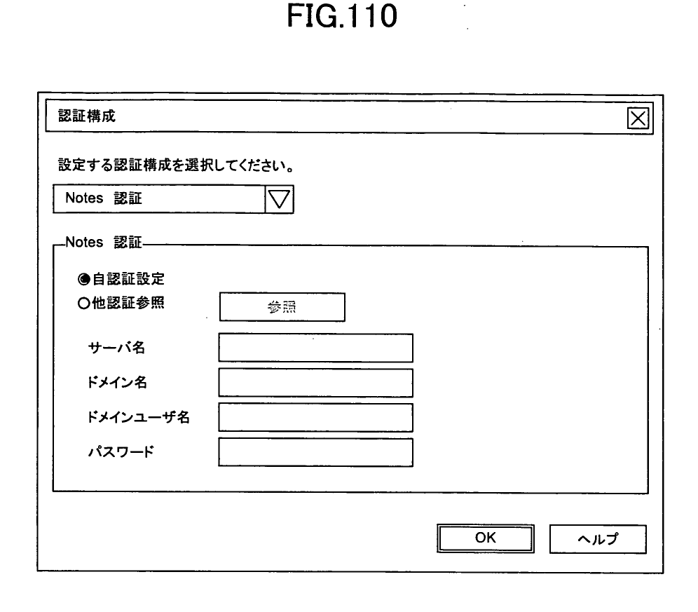

Hereinafter, a further example of the GUI for setting up the provider in the client will be shown in FIG. 110, wherein FIG. 110 is the fourth diagram showing the GUI for setting the provider in the client.

FIG. 110 shows an example screen for the case the user has selected the Notes (trade mark) authentication in the drop down menu.

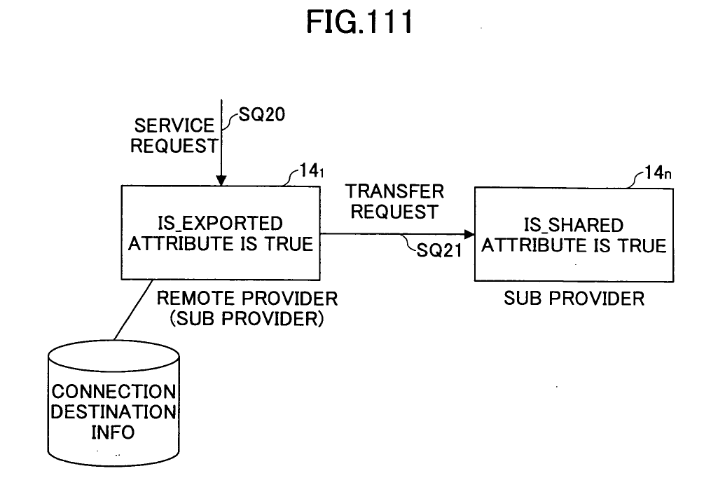

Hereinafter, the example of a remote provider will be explained with reference to FIG. 111, wherein FIG. 111 is a diagram explaining the example of a remote provider.

For example, in the case the Join merge provider 13A and/or the sub provider 14 has the “is_exported” attribute set to TRUE in the definition file, it is possible to conduct the processing as a remote provider as will be describe later. Here, the remote provider is the provider not having an authentication engine for itself in the case the provider is an authentication provider and carries out the processing according to the request from the client by utilizing the authentication engine of other providers as noted before. Here, the definition file is included in the configuration manager 22, and the like, for example.

For example, the sub provider 14, determines whether or not the “is_exported” attribute is TRUE when it receives the use request of the service (authentication service, for example) from the client or the Union merge provider 13 (sequence SQ20), by referring to the definition file etc.

When it is determined that the “is_exported” attribute is TRUE, the sub provider 141 acquires the connection destination information stored in the registry, and the like, assuming that the sub provider 14₁ itself is a remote provider, and requests transfer of the service use request to the connection destination (Sequence SQ21).

The sub provider 14n that has received the use request of the service determines whether or not the “is_shared” attribute is TRUE by referring to the definition file.

When it is determined that the “is_shared” attribute is TRUE, the sub provider 14n carries out the processing according to the use request for the service and returns the result of the processing to the remote provider (sub provider 14₁).

When the remote provider (sub provider 14₁) receives the processing result from the sub provider 14ₙ, the sub provider 141 applies a post-processing to the result of processing according to the needs and returns the result thus added with the post-processing to the requesting original client or the Join merge provider 13A.

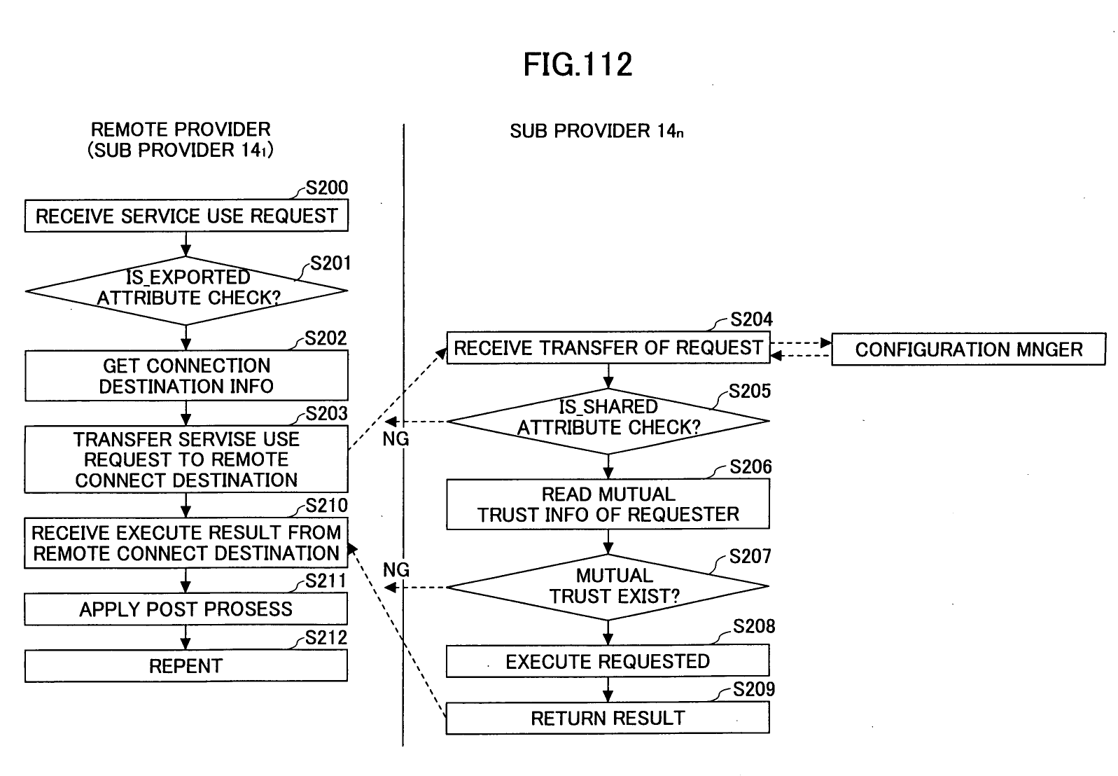

Hereinafter, the example of processing of a remote provider will be explained with reference to FIG. 112, wherein FIG. 112 is a diagram explaining an example of the processing related to a remote provider.

In the Step S200, the sub provider 14, receives the use request of the service from the client or the Join merge provider 13A.

Following the step S200, the process proceeds to the step S201, and the sub provider 14₁ determines whether or not the “is_exported” attribute is TRUE by referring to the definition file. When it is determined that the “is_exported” attribute is TRUE, the sub provider 141 proceeds to the step S202, while when it determined that the “is_exported” attribute is FALSE, determination is made whether or not the “is_shared” attribute is real. For the sake of simplification of explanation, the processing for the case in which “is_exported” attribute is FALSE is omitted in FIG. 112.

In the step S202, sub provider 141 acquires the connection destination information stored in a registry, and the like based on the judgment that there exists a remote provider.

Following the step S202, the process proceeds to the step S203 and the sub provider 141 forwards the use request for the service received in the step S200 to the connection destination acquired in the step S202.

Following the step S203, the process proceeds to the step S204 and the sub provider 14ₙ of the connection destination receives the forwarded use request of the service from the remote provider.

Following the step S204, the process proceeds to the step S205 and the sub provider 14ₙ of the connection destination determines whether or not the is_shared attribute is TRUE by referring to the definition file. When it is determined that the “is_shared” attribute is TRUE, the sub provider 14ₙ of the connection destination proceeds to the step S206 and returns NG to the remote provider when it is determined that the “is_shared” attribute is FALSE.

In step S206, the sub provider 14, of the connection destination reads out the mutual trust relationship of the request source remote provider from the configuration manager 22.

Following the step S206, the process proceeds to the step S207 and the sub provider 14ₙ of the connection destination determines whether or not there is mutual trust relationship to between the own sub provider 14n and the request source remote provider. When it is determined that there exists no mutual trust relationship between the own sub provider 14ₙ and the request source remote provider, the process proceeds to the step S208 and the sub provider 14ₙ of the connection destination returns NG to the request source remote provider.

In the step S208, the sub provider 14n of the connection destination carries out the processing according to the needs.

Following step S208, the process proceeds to the step S209 and the sub provider 14ₙ of the connection destination returns the result of the processing to the request source remote provider.

Following the step S209, the process proceeds to the step S210 and the remote provider receives the result of processing from the sub provider 14n of the connection destination.

Following the step S210, the process proceeds to the step S211, and a remote provider adds a necessary post-processing to the processing result received in the step S210.

Following the step S211, the process proceeds to the step S212, and the remote provider returns the processing result added with a necessary post-processing in the step S211 to the request source client or the Join merge provider 13A.

While explanation has been made in Example 6 for the case of adding a sub provider 14, the same procedure can be applied also to the case of registering a sub provider 14 where there is no registered sub provider 14.

### EXAMPLE 7

Hereinafter, another example of holding and managing the information (configuration information) related to the construction of the Join merge provider 13A and the sub providers 14 in the configuration manager 22 outside the Join merge provider 13A as in the case of Example 6 will be described.

In Example 7, the explanation will be made for the case of using a Join merge provider (idJoin merge provider), which does not have the integrated directory 180 in the Join merge provider 13A, as explained in Example 4 and Example 5.

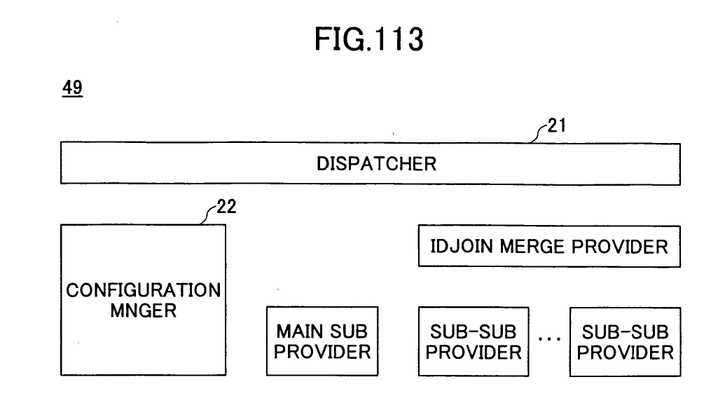

FIG. 113 is a further diagram explaining the construction of the UCS. In FIG. 113, the explanation will be made on the assumption that all of the idJoin merge provider, the main sub provider and the sub-sub providers are included in the UCS49A for the sake of simplicity. Further, a part or all of the main sub provider and/or the sub-sub provider may be included in other fusion machine 120.

The UCS 49A shown in FIG. 113 includes the dispatcher 21, the configuration manager 22, the idJoin merge provider, the main sub provider and at least one sub-sub provider.

The dispatcher 21 receives the request from the client and distributes the request to the configuration manager 22, the idJoin merge provider, and the like, and further transmits the processing result that the configuration manager 22 or the idJoin merge provider has processed according to the distributed request, to the client.

It should be noted that the configuration manager 22 is the managing part managing the construction of the idJoin merge provider and the sub providers 14₁-14ₙ and holds the construction information in the storage part.

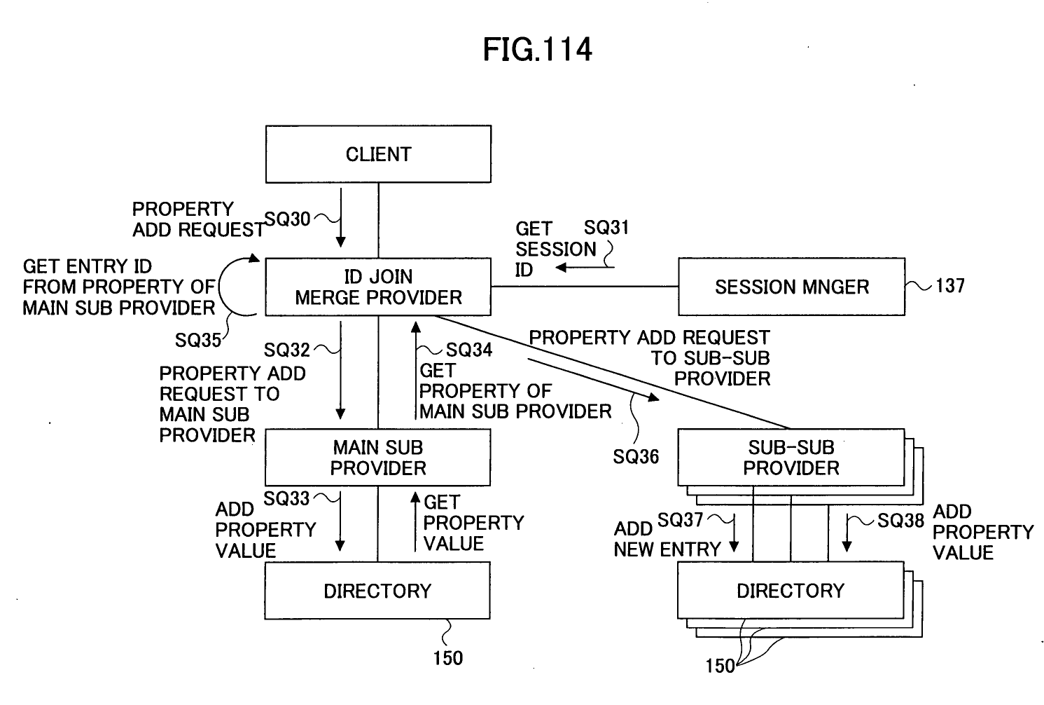

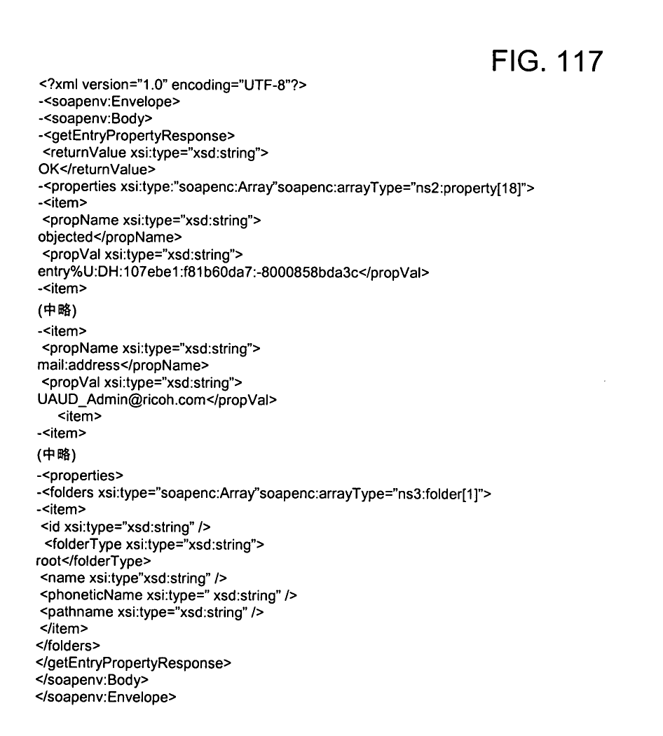

Hereinafter, the example of the processing that the idJoin merge provider, the main sub provider and the sub sub provider will be explained with reference to FIGS. 114-119, wherein FIG. 114 is a diagram for explaining the example of the property adding sequence.

As shown in FIG. 114, the client transmits a property adding request to the idJoin merge provider via the dispatcher 21 (Sequence SQ30).

The idJooin provider that has received the property adding request acquires the session ID of the main sub provider and the sub sub provider from the session managing part 137, and the like, in the idJoin merge provider (Sequence SQ31)

The idJoin merge provider then transmits the property adding request including the session ID of the main sub provider acquired in the sequence SQ31 to the main sub provider (sequence SQ32).

The main sub provider then adds the property value to the directory 150 based on the acquired property adding request (sequence SQ33).

Also, the main sub provider acquires all the properties from the directory 150 and provides the same to the idJoin merge provider (sequence SQ34).

The IdJoin merge provider acquires the entry ID that distinguishes the user or group from all the properties of the main sub providers thus acquired (sequence SQ35), and transmits the property adding request that contains the session ID of the sub-sub provider acquired in the sequence SQ31 and the entry ID acquired in the sequence SQ35 to the sub-sub provider (Sequence SQ36).

The sub-sub provider adds, when the entry corresponding to the entry ID included in the acquired property adding request is not existing in the directory 150 of that sub-sub provider, the entry to the directory 150 (Sequence SQ37), while when the entry corresponding to the entry ID is existing in the directory 150 of this sub-sub provider, the sub-sub provider adds the property value to this entry (Sequence SQ38).

By conducting such a processing shown in FIG. 114, it becomes possible to add the property to the entry that the entry ID agrees, even in the case the Join merge provider 13A does not have the integrated directory 180.

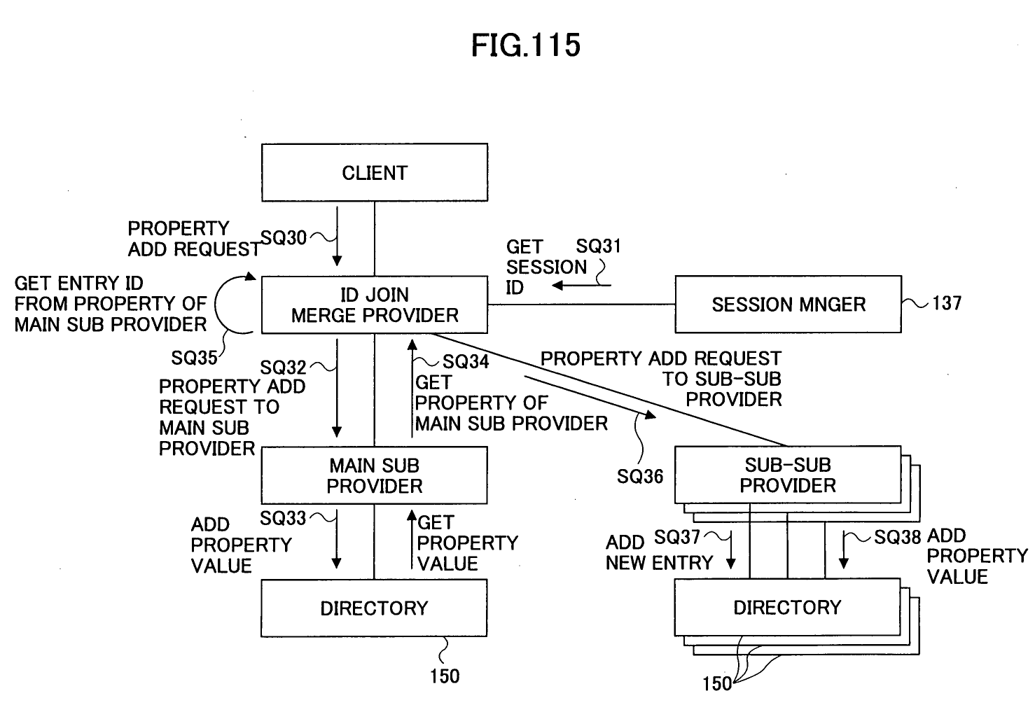

Hereinafter, the example of the property acquisition sequence will be explained by using FIG. 115, wherein FIG. 115 is a diagram explaining the example of the property acquisition sequence.

As shown in FIG. 115, the client

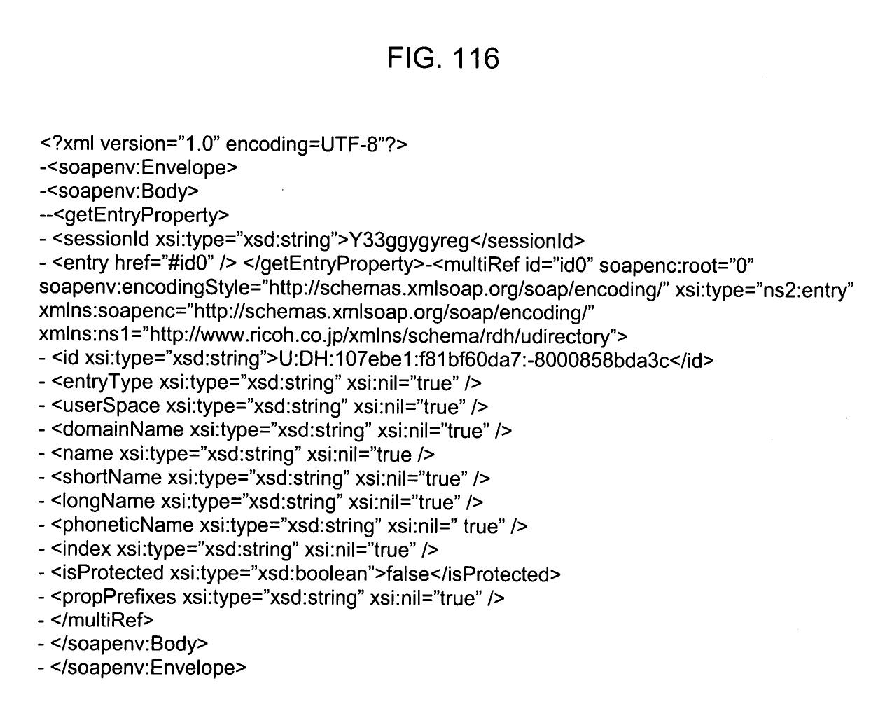

transmits the property acquisition request to the idJoin merge provider via the dispatcher 21 (Sequence SQ40), wherein the example of the property acquisition request will be explained later in FIG. 116.

The IdJoin merge provider that has received the property acquisition request acquires the session ID of the main sub provider and the sub-sub provider from the session managing part 137 inside the idJoin merge provider (Sequence SQ41).

The IdJoin merge provider transmits the property acquisition request including the session ID of the main sub provider acquired in the sequence SQ41 to the main sub provider (Sequence SQ42).

The main sub provider acquires the value of the corresponding property from the directory 150 based on the acquired property acquisition request and provides the same to the idJoin merge provider (Sequence SQ43).

Also, the main sub provider acquires all the properties from the directory 150 and provides the same to the idJoin merge provider (sequence SQ44).

The idJoin merge provider acquires the entry ID that distinguishes the user or group

from all the properties of the main sub provider thus acquired (Sequence SQ45), transmits the property acquisition request that includes the session ID of the sub-sub provider acquired in the sequence SQ41 and the entry ID acquired in the sequence SQ45 to the sub-sub provider (Sequence SQ46).

The sub-sub provider acquires the property value from the entry corresponding to the entry ID contained in the acquired property acquisition (sequence SQ47) and provides the same to the idJoin merge provider.

The idJoin merge provider merges the property of the main sub provider acquired in the sequence SQ43 and the property of each of the sub-sub providers acquired in the sequence SQ47 and creates a property acquisition response including the property of the result, and transmits the same to the client via the dispatcher 21 (Sequence SQ48). The example of the property acquisition response will be explained in FIG. 69 later.

By conducting such a processing shown in FIG. 115, it becomes possible to acquire the property of the entry that the entry ID agrees even in the case the Join merge provider 13A does not have the integrated directory 180.

Hereinafter, the example of the property acquisition request will be explained with reference to FIG. 116, wherein FIG. 116 is a diagram showing the example of the property acquisition request.

Further, the example of the property acquisition response is shown in FIG. 69, wherein FIG. 69 is the diagram showing the example of the property acquisition response.

It should be noted that the tag <propVal></propVal> of FIG. 69 includes o the mail address of the user as the property value, for example.

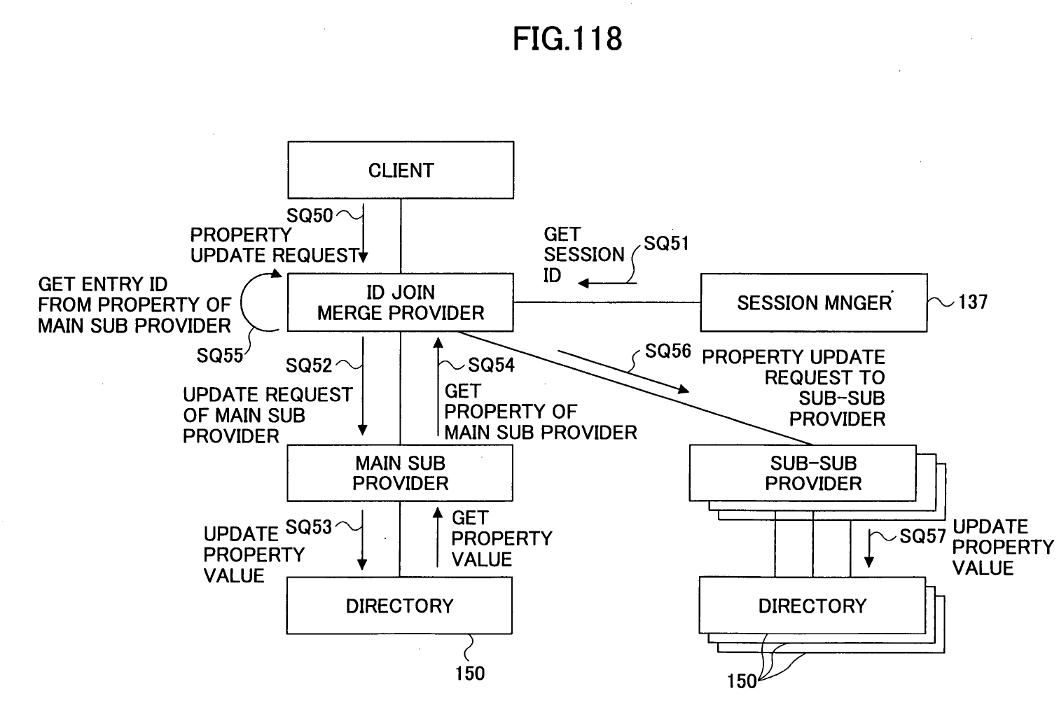

Hereinafter, the example of the property updating sequence will be explained by using FIG. 118, wherein FIG. 118 is a diagram for explaining the example of the property updating sequence.

As shown in FIG. 118, the client transmits the updating request of the property to the idJoin merge provider via the dispatcher 21, and the like (Sequence SQ50).

The idJoin merge provider that has received the updating request of the property acquires the session ID of the main sub provider and the sub-sub providers from the session managing part 137, and the like provided inside the idJoin merge provider (Sequence SQ51).

The idJoin merge provider transmits the updating request of the property including the session ID of the main sub provider acquired in the sequence SQ51 to the main sub provider (Sequence SQ52).

The main sub provider carries out the updating of the property value to the directory 150 based on the updating request of the acquired property (sequence SQ53).

Also, the main sub provider acquires all the properties from the directory 150 and provides the same to the idJoin merge provider (sequence SQ54).

The idJoin merge provider acquires the entry ID that distinguishes the user or group from all the properties of the main sub providers thus acquired (sequence SQ55), and transmits the update request for the properties including the session ID of the sub-sub provider acquired in the sequence SQ51 and the entry ID acquired in the sequence SQ55 to the subs-ub provider (sequence SQ56).

The sub-sub provider updates, in the event there exits the entry corresponding to the entry ID included in the acquired updating request for the property in the directory 150 of that sub-sub provider, the property value of that entry (sequence SQ57).

By conducting such a processing shown in FIG. 118, it becomes possible to update the property of the entry that the entry ID agrees even in the case the Join merge provider 13A does not hold the integrated directory 180.

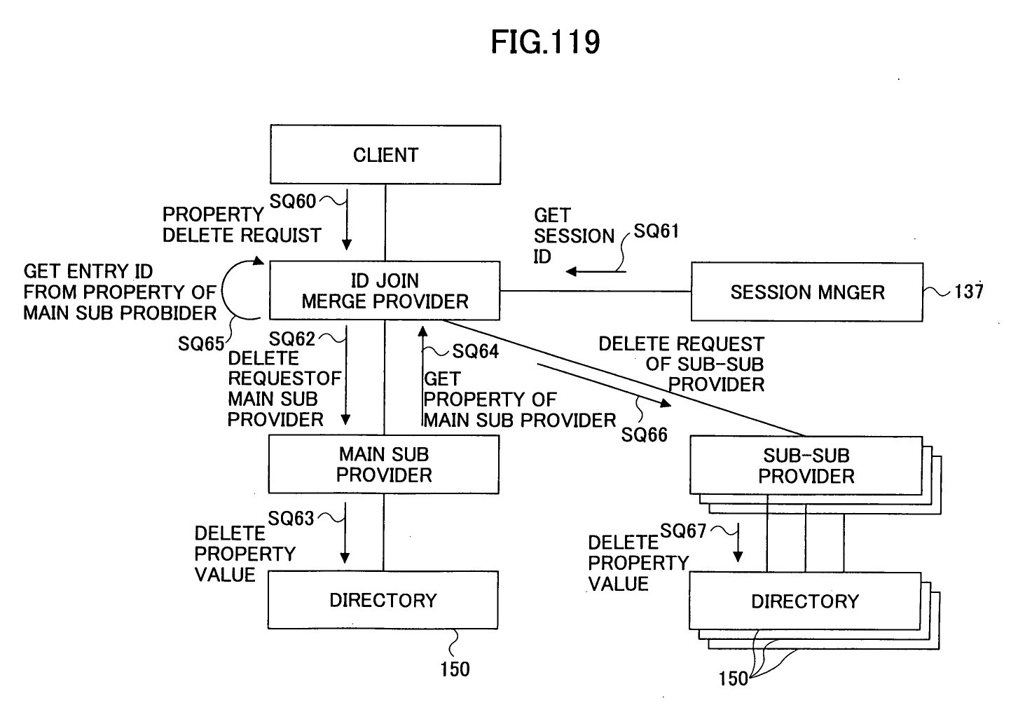

Hereinafter, the example of the property elimination sequence will be explained by using FIG. 119, wherein FIG. 119 is a diagram explaining the example of the property elimination sequence.

As shown in FIG. 119, the client transmits the property elimination request to the idJoin merge provider via the dispatcher 2, and the like (sequence SQ60).

The idJoin merge provider thus received the property elimination request acquires the session ID of the main sub provider and also the sub-sub provider from the session managing part 137, and the like, inside the idJoin merge provider (Sequence SQ61).

The idJoin merge provider transmits the property elimination request including the session ID of the main sub provider acquired in the sequence SQ61 to the main sub provider (sequence SQ62).

The main sub provider eliminate the value of the corresponding property of the directory 150 based on the property elimination request thus acquired (sequence SQ63).

Further, the main sub provider acquires all the properties from the directory 150 and provides the same to the idJoin merge provider (sequence SQ64).

The idJoin merge provider acquires the entry ID that distinguishes the user or group from all the properties of the main sub providers thus acquired (Sequence SQ65), transmits the property elimination request containing the session ID of the sub-sub provider acquired in the sequence SQ61 and the entry ID acquired in the sequence SQ65 to the sub-sub provider (sequence SQ66).

The sub-sub provider then eliminates the property value of the entry corresponding to the entry ID included the acquired property elimination request (sequence SQ67).

By conducting the processing shown in FIG. 119, it becomes possible to eliminate the property of the entry that the entry ID agrees even in the case the Join merge provider 13A does not hold the integrated directory 180.

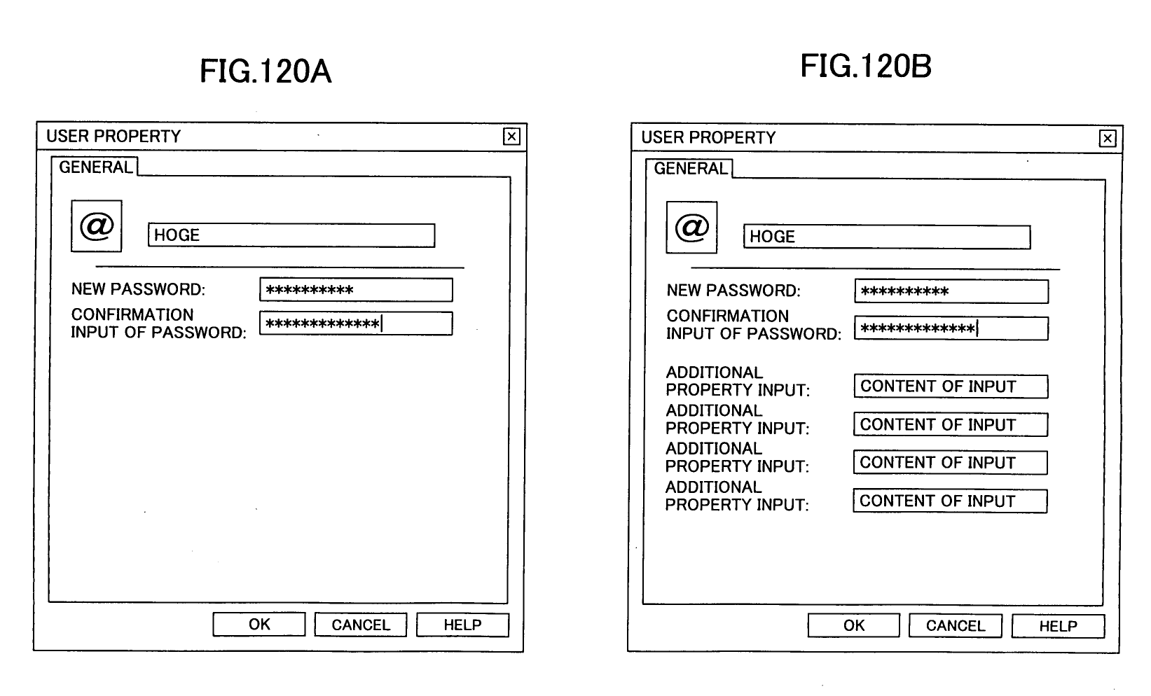

Hereinafter, the examples of the GUI in the client for the case the idJoin merge provider is applied to the fusion machine 120 with reference to FIGS. 120A and 120B, wherein FIGS. 120A and 120B are the diagrams showing the example of the GUI in the client for the case the idJoin merge provider is applied to the fusion machine, and the like.

FIG. 120A is an example of the GUI in a client before applying the idJoin merge provider to the fusion machine 120, and the like, while FIG. 120B is an example of the GUI in the client after applying the idJoin merge provider to the fusion machine 120, and the like.

In FIG. 120B, it is becomes possible to add the property value of the entry that the entry ID agrees,

Further, the present invention is not limited to the embodiments described heretofore, but various variations and modifications may be made without departing from the scope of the invention.

The present invention based on the Japanese priority applications No. 2003-017922 filed on Jan. 27, 2003, No. 2003-017923 filed on Jan. 27, 2003, No. 2004-11068 filed on Jan. 19, 2004 and No. 2004-11069 filed on Jan. 19, 2004, the entire contents of which are incorporated herein by reference.

1. A merge information providing apparatus having merge user information providing means, said merge user information providing means comprising plural user information providing means providing information regarding a user as subordinate user information providing means,
said merge information providing apparatus acquiring said information regarding said user from said user information providing means and providing said acquired information regarding said user with merging.

2. The merge information providing apparatus of as claimed in claim 1, wherein said merge information providing apparatus comprises:
user information acquisition means for acquiring said information regarding said user from said user information providing means; and
user information merging means for merging said information regarding said user acquired in said user information acquisition means.

3. The merge information providing apparatus as claimed in claim 2, wherein said user information acquisition means acquires said information regarding said user from said user information providing means by using first use permission information permitting the use of said user information providing means.

4. The merge information providing apparatus as claimed in claim 3, further comprising use permission information acquisition means for acquiring said first use permission information from said user information providing means.

5. The merge information providing apparatus as claimed in claim 1, further comprising use permission information creation means for creating second use permission information that permits the use of said merge user information providing means.

6. The merge information providing apparatus of the claim 5, wherein said use permission information creation means creates said second use permission information including said first use permission information by using said first use permission information.

7. The merge information providing apparatus as claimed in claim 1, further comprising setting means for setting up said subordinate user information providing means according to a request.

8. A merge information providing apparatus having merge user information providing means, said merge user information providing means comprising plural user information providing means providing information regarding a user and further providing an authentication service regarding said user as subordinate user information providing means,
said merge information providing apparatus acquiring said information regarding said user from said user information providing means and providing said acquired information regarding said user with merging.

9. The merge information providing apparatus as claimed in claim 8, further comprising:
user information acquisition means for acquiring said information regarding said user from said user information providing means; and
user information merging means for merging said information regarding said user acquired in said user information acquisition means.

10. The merge information providing apparatus as claimed in claim 9, wherein aid user information acquisition means acquires said information regarding said user from said user information providing means by using first use permission information permitting the use of said user information providing means.

11. The merge information providing apparatus as claimed in claim 10, further comprising use permission information acquisition means for acquiring said first use permission information from said user information providing means.

12. The merge information providing apparatus as claimed in claim 8, further comprising use permission information creation means for creating second use permission information that permits the use of said merge user information providing means.

13. The merge information providing apparatus as claimed in claim 12, wherein said use permission information creation means creates said second use permission information including said first use permission information by using said first use permission information.

14. The merge information providing apparatus as claimed in claim 8, further comprising setting means for setting up said subordinate user information providing means according to a request.

15. The merge information providing apparatus as claimed in claim 8, further comprising authentication information acquisition means for acquiring first authentication information certifying authentication of said user in said user information providing means, from said user information providing means.

16. The merge information providing apparatus as claimed in claim 15, further comprising second authentication information creation means for creating second authentication information containing therein said first authentication information and certifying authentication authentication of said user in said merge user information providing means by using said first authentication information.

17. The merge information providing apparatus as claimed in claim 8, further comprising user distinction information acquisition means for acquiring user distinction information that distinguishes said user from said user information providing means.

18. The merge information providing apparatus as claimed in claim 17, wherein said user distinction information acquisition means acquires said user distinction information from said user information providing means by using first authentication information included in said second authentication information.

19. An information providing apparatus having user information providing means for providing information regarding a user,
said user information providing means providing information regarding a designated user in response to a request from a merge user information providing means, said merge user information providing means comprising said user information providing means and other user information providing means as subordinate user information providing means, to said merge user information providing means.

20. The information providing apparatus as claimed in claim 19, wherein said user information providing means further comprises user information saving means for saving said information regarding said user.

21. The information providing apparatus as claimed in claim 19, wherein said information regarding said user is user information and/or group information of a group to which said user belong, and wherein said group information includes user information and/or group information of other user information providing means.

22. The information providing apparatus having user information providing means providing information regarding a user and further a an authentication service regarding said user,
said user information providing means providing information regarding a designated user in response to a request from a merge user information providing means, said merge user information providing means comprising said user information providing means and other user information providing means as subordinate user information providing means, to said merge user information providing means.

23. The information providing apparatus as claimed in claim 22, wherein said user information providing means further comprises user information saving means for saving said information regarding said user.

24. The information providing apparatus as claimed in claim 22, wherein said information regarding said user is user information and/or group information of a group to which said user belongs, and wherein said group information includes user information and/or group information of other user information providing means.

25. A managing apparatus, comprising:
a merge information providing apparatus having merge user information providing means, said merge user information providing means comprising plural user information providing means providing information regarding a user as subordinate user information providing means, and
setup request transmission means for transmitting a request regarding a set up of said subordinate user information providing means,
said merge information providing apparatus acquiring said information regarding said user from said user information providing means and providing said acquired information regarding said user with merging.

26. The managing apparatus as claimed in claim 25, further comprising:
user information acquisition means for acquiring said information regarding said user from said user information providing means; and
user information merging means merging said information regarding said user acquired in said user information acquisition means.

27. The managing apparatus as claimed in claim 26, wherein said user information acquisition means acquires said information regarding said user from said user information providing means by using first use permission information permitting the use of said user information providing means.

28. The merge information providing apparatus as claimed in claim 27, further comprising use permission information acquisition means for acquiring said first use permission information from said user information providing means.

29. The managing apparatus as claimed in claim 25, further comprising use permission information creation means for creating second use permission information that permits the use of said merge user information providing means.

30. The managing apparatus of the claim 29, wherein said use permission information creation means creates said second use permission information including said first use permission information by using said first use permission information.

31. The managing apparatus as claimed in claim 25, further comprising setting means for setting up said subordinate user information providing means according to a request.

32. A managing apparatus, comprising:
a merge information providing apparatus having merge user information providing means, said merge user information providing means comprising plural user information providing means providing information regarding a user and further providing an authentication service regarding said user as subordinate user information providing means; and
setup request transmission means for transmitting a request regarding setting up of said subordinate user information providing means,
said merge information providing apparatus acquiring said information regarding said user from said user information providing means and providing said acquired information regarding said user with merging.

33. The managing apparatus as claimed in claim 32, further comprising:
user information acquisition means for acquiring said information regarding said user from said user information providing means; and
user information merging means for merging said information regarding said user acquired in said user information acquisition means.

34. The managing apparatus as claimed in claim 33, wherein said user information acquisition means acquires said information regarding said user from said user information providing means by using first use permission information permitting the use of said user information providing means.

35. The managing apparatus as claimed in claim 34, further comprising use permission information acquisition means for acquiring said first use permission information from said user information providing means.

36. The managing apparatus as claimed in claim 32, further comprising use permission information creation means for creating second use permission information that permits the use of said merge user information providing means.

37. The managing apparatus as claimed in claim 36, wherein said use permission information creation means creates said second use permission information including said first use permission information by using said first use permission information.

38. The managing apparatus as claimed in claim 32, further comprising setting means for setting up said subordinate user information providing means according to a request.

39. The managing apparatus as claimed in claim 32, further comprising authentication information acquisition means for acquiring first authentication information certifying authentication of said user in said user information providing means, from said user information providing means.

40. The managing apparatus as claimed in claim 39, further comprising second authentication information creation means for creating second authentication information containing therein said first authentication information and certifying authentication of said user in said merge user information providing means by using said first authentication information.

41. The managing apparatus as claimed in claim 32, further comprising user distinction information acquisition means for acquiring user distinction information that distinguishes said user from said user information providing means.

42. The managing apparatus as claimed in claim 41, wherein said user distinction information acquisition means acquires said user distinction information from said user information providing means by using first authentication information included in said second authentication information.

43. The managing apparatus as claimed in claim 42, further comprising setting screen display means for displaying a screen for setting said merge user information providing means and said subordinate user information providing means.

44. A merge information providing method in merge user information providing means, said merge user information providing means comprising plural user information providing means providing information regarding a user as subordinate user information providing means, said method comprising the steps of:
acquiring information regarding said user from user information providing means; and
providing said acquired information regarding said user with merging.

45. A merge information providing method in merge user information providing means, said merge user information providing means comprising plural user information providing means providing information regarding a user as subordinate user information providing means and further an authentication service regarding said user, said method comprising the steps of:
acquiring said information regarding said user from said user information providing means; and
providing said information regarding said user with merging.

46. An information providing method in user information providing means, said user information providing means providing information regarding a user, said method comprising:
a user information offer providing step for providing, in response to a request from a merge user information providing means comprising said user information providing means and other user information providing means as subordinate user information providing means, information regarding a designated user to said merge user information providing means.

47. An information providing method in user information providing means, said user information providing means providing information regarding a user and an authentication service regarding said user, said method comprising:
a user information providing step for providing, in response to a request from a merge user information providing means, said merge user information providing means comprising said user information providing means and other user information providing means as subordinate user information providing means, information regarding a designated user to said merge user information providing means.

48. A managing method in merge user information providing means, said merge user information providing means comprising plural user information providing means providing information regarding a user as subordinate user information providing means, said method comprising the steps of:
acquiring said information regarding said user from said user information providing means;
providing said acquired information regarding said user with merging; and
transmitting a set up request requesting for a set up of said subordinate user information providing means.

49. A managing method in merge user information providing means, said merge user information providing means comprising plural user information providing means providing information regarding a user and an authentication service regarding said user as subordinate user information providing means, said method comprising the steps of:
acquiring said information regarding said user from said user information providing means;
providing said acquired information regarding said user with merging; and
transmitting a set up request regarding a set up of said subordinate user information providing means.

50. A computer-implemented method for providing merge information in merge user information providing means, said merge user information providing means comprising plural user information providing means providing information regarding a user as subordinate user information providing means, said method comprising the steps of:
acquiring information regarding said user from user information providing means; and
providing said acquired information regarding said user with merging.

51. A computer-implemented method of providing merge information in merge user information providing means, said merge user information providing means comprising plural user information providing means providing information regarding a user as subordinate user information providing means and further an authentication service regarding said user, said method comprising the steps of:
acquiring said information regarding said user from said user information providing means; and
providing said information regarding said user with merging.

52. A computer-implemented method of information in user information providing means, said user information providing means providing information regarding a user, said method comprising:
a user information offer providing step for providing, in response to a request from a merge user information providing means comprising said user information providing means and other user information providing means as subordinate user information providing means, information regarding a designated user to said merge user information providing means.

53. A computer-implemented method of providing information in user information providing means, said user information providing means providing information regarding a user and an authentication service regarding said user, said method comprising:
a user information providing step for providing, in response to a request from a merge user information providing means, said merge user information providing means comprising said user information providing means and other user information providing means as subordinate user information providing means, information regarding a designated user to said merge user information providing means.

54. A computer-implemented method of managing in merge user information providing means, said merge user information providing means comprising plural user information providing means providing information regarding a user as subordinate user information providing means, said method comprising the steps of:
acquiring said information regarding said user from said user information providing means;
providing said acquired information regarding said user with merging; and
transmitting a set up request requesting for a set up of said subordinate user information providing means.

55. A computer-implemented method of managing in merge user information providing means, said merge user information providing means comprising plural user information providing means providing information regarding a user and an authentication service regarding said user as subordinate user information providing means, said method comprising the steps of:
acquiring said information regarding said user from said user information providing means;
providing said acquired information regarding said user with merging; and
transmitting a set up request regarding a set up of said subordinate user information providing means.

56. A processor-readable medium storing program code for providing merge information in merge user information providing means, said merge user information providing means comprising plural user information providing means providing information regarding a user as subordinate user information providing means, said method comprising the steps of:
acquiring information regarding said user from user information providing means; and
providing said acquired information regarding said user with merging.

57. A processor-readable medium storing program code for providing merge information in merge user information providing means, said merge user information providing means comprising plural user information providing means providing information regarding a user as subordinate user information providing means and further an authentication service regarding said user, said method comprising the steps of:
acquiring said information regarding said user from said user information providing means; and
providing said information regarding said user with merging.

58. A processor-readable medium storing program code for providing information in user information providing means, said user information providing means providing information regarding a user, said method comprising:
a user information offer providing step for providing, in response to a request from a merge user information providing means comprising said user information providing means and other user information providing means as subordinate user information providing means, information regarding a designated user to said merge user information providing means.

59. A processor-readable medium storing program code for providing information in user information providing means, said user information providing means providing information regarding a user and an authentication service regarding said user, said method comprising:
a user information providing step for providing, in response to a request from a merge user information providing means, said merge user information providing means comprising said user information providing means and other user information providing means as subordinate user information providing means, information regarding a designated user to said merge user information providing means.

60. A processor-readable medium storing program code for managing in merge user information providing means, said merge user information providing means comprising plural user information providing means providing information regarding a user as subordinate user information providing means, said method comprising the steps of:
acquiring said information regarding said user from said user information providing means;
providing said acquired information regarding said user with merging; and
transmitting a set up request requesting for a set up of said subordinate user information providing means.

61. A processor readable medium for storing program code for managing in merge user information providing means, said merge user information providing means comprising plural user information providing means providing information regarding a user and an authentication service regarding said user as subordinate user information providing means, said method comprising the steps of:
acquiring said information regarding said user from said user information providing means;
providing said acquired information regarding said user with merging; and
transmitting a set up request regarding a set up of said subordinate user information providing means.

62. A merge information providing apparatus having merge user information providing means, said merge user information providing means comprising plural user information providing means providing user information regarding a user as subordinate user information providing means,
said merge information providing apparatus acquiring user information regarding a user registered to the user information providing means of which use is permitted and the same user registered to other user information providing means, without distinguishing the user by the user whether or not the use of said information providing means is permitted, said merge information providing apparatus providing said acquired information regarding said user with merging.

63. The merge information providing apparatus as claimed in claim 62, comprising:
distinction information managing means for managing distinction information that distinguishes said user registered to said user information providing means;
user information acquisition means for acquiring said user information regarding said user from said user information providing means; and
user information merging means merging said user information regarding said user acquired in said user information acquisition means.

64. The merge information providing apparatus as claimed in claim 62, wherein said distinction information managing means provides said distinction information of said same user to said user information acquisition means in response to a request from said user information acquisition means.

65. The merge information providing apparatus as claimed in claim 62, wherein said user information acquisition means acquires said user information regarding said user from said user information providing means by using permission information that permits the use of said distinction information and said user information providing means.

66. The merge information providing apparatus as claimed in claim 62, further comprising set up means for setting up said subordinate user information providing means according to a request.

67. A merge information providing apparatus having merge user information providing means, said merge user information providing means comprising plural user information providing means providing user information regarding a user and an authentication service regarding said user as subordinate user information providing means,
said merge information providing apparatus acquiring user information regarding a user registered to the user information providing means of which use is permitted and/or authentication is made therein and the same user registered to other user information providing means, without distinguishing the user by whether or not the use of the user information providing means is permitted and/or the authentication is made, said merge information providing apparatus providing said acquired information regarding said user with merging.

68. The merge information providing apparatus as claimed in claim 67, comprising:
distinction information managing means for managing distinction information that distinguishes said user is registered to said user information providing means;
user information acquisition means for acquiring said user information regarding said user from said user information providing means; and
user information merging means merging said user information regarding said user acquired in said user information acquisition means.

69. The merge information providing apparatus as claimed in claim 68, wherein said distinction information managing means provides said distinction information of said same user to said user information acquisition means according to a request from said user information acquisition means.

70. The merge information providing apparatus as claimed in claim 68, wherein said user information acquisition means acquires said user information regarding said user from said user information providing means by using permission information that permits the use of said distinction information and said user information providing means.

71. The merge information providing apparatus as claimed in claim 67, further comprising set up means for setting up said subordinate user information providing means according to a request.

72. A merge information providing apparatus having merge user information providing means, said merge user information providing means comprising main user information providing means and sub user information providing means providing user information regarding a user and an authentication service regarding said user as subordinate user information providing means,
said merge information providing apparatus acquiring user information regarding a user registered to the user information providing means of which use is permitted and/or authentication is made therein and the same user registered to other user information providing means, without distinguishing the user by whether or not the use of the user information providing means is permitted and/or the authentication is made, said merge information providing apparatus providing said acquired information regarding said user with merging.

73. The merge information providing apparatus as claimed in claim 72, further comprises authentication information acquisition means for acquiring first authentication information that certifies said user in said main user information providing means from said main user information providing means.

74. The merge information providing apparatus as claimed in claim 73, further comprising second authentication information creation means for creating second authentication information that certifies said user in said merge user information providing means and including said first authentication information, by using said first authentication information acquired in said authentication information acquisition means.

75. The merge information providing apparatus as claimed in claim 74, further comprising second authentication information providing means for providing said second authentication information to a client requesting said authentication.

76. The merge information providing apparatus as claimed in claim 72, further comprising set up means for setting up said subordinate user information providing means according to a request.

77. An information providing apparatus having user information providing means, said user information providing means providing information regarding a user,
said user information providing means providing information regarding said user corresponding to said distinction information that distinguishes said user registered to said information providing means and/or other user information providing means to merge user information providing means in response to a request from said merge user information providing means, said merge user information providing means including said user information providing means and other user information providing means as subordinate user information providing means.

78. The information providing apparatus as claimed in claim 77, further comprising user information providing means for saving said information regarding the said user.

79. The information providing apparatus as claimed in claim 77, wherein said information regarding said user is user information and/or group information of a group to which said user belongs, said group information including user information and/or group information of other user information providing means.

80. An information providing apparatus having user information providing means, said user information providing means providing information regarding a user and an authentication service regarding said user,
said user information providing means comprising user information providing means for providing, in response to a request from merge user information providing means, said merge user information providing means comprising said user information providing means and other user information providing means as subordinate user information providing means, information regarding a user corresponding to distinction information that distinguishes said user registered to said user information providing means and/or other user information providing means, to said merge user information providing means.

81. The information providing apparatus as claimed in claim 78, wherein said user information providing means further comprising user information saving means for saving said information regarding to said user.

82. The information providing apparatus as claimed in claim 80, wherein said information regarding said user comprises user information and/or group information about a group to which said user belongs, said group information including user information and/or group information of other user information providing means.

83. A managing apparatus, comprising:
merge information providing apparatus having merge user information providing means, said merge user information providing means comprising plural user information providing means providing user information regarding a user as subordinate user information providing means; and
setup request transmission means for transmitting information regarding set up of said subordinate user information providing means,
said merge information providing apparatus acquiring user information regarding a user registered to the user information providing means of which use is permitted and the same user registered to other user information providing means, without distinguishing the user by the user information providing means of which use is permitted, said merge information providing apparatus providing said acquired information regarding said user with merging.

84. The managing apparatus as claimed in claim 83, comprising:
distinction information managing means for managing distinction information that distinguishes said user is registered to said user information providing means;
user information acquisition means for acquiring said user information regarding said user from said user information providing means; and
user information merging means merging said user information regarding said user acquired in said user information acquisition means.

85. The managing apparatus as claimed in claim 83, wherein said distinction information managing means provides said distinction information of said same user to said user information acquisition means in response to a request from said user information acquisition means.

86. The managing apparatus as claimed in claim 83, wherein said user information acquisition means acquires said user information regarding said user from said user information providing means by using permission information that permits the use of said distinction information and said user information providing means.

87. The managing apparatus as claimed in claim 83, further comprising set up means for setting up said subordinate user information providing means according to a request.

88. The managing apparatus as claimed in claim 83, further comprising setup screen display means for displaying a screen for setting up said merge user information providing means and said subordinate user information providing means.

89. A managing apparatus, comprising:
a merge information providing apparatus having merge user information providing means, said merge user information providing means comprising plural user information providing means providing user information regarding a user and an authentication service regarding said user as subordinate user information providing means; and
setup request transmission means for transmitting information regarding to set up of subordinate user information providing means,
said merge information providing apparatus acquiring user information regarding a user registered to the user information providing means of which use is permitted and/or authentication is made therein and the same user registered to other user information providing means, without distinguishing the user by whether or not the use of the user information providing means is permitted and/or the authentication is made, said merge information providing apparatus providing said acquired information regarding said user with merging.

90. The managing apparatus as claimed in claim 89, comprising:
distinction information managing means for managing distinction information that distinguishes said user is registered to said user information providing means;
user information acquisition means for acquiring said user information regarding said user from said user information providing means; and
user information merging means merging said user information regarding said user acquired in said user information acquisition means.

91. The managing apparatus as claimed in claim 90, wherein said distinction information managing means provides said distinction information of said same user to said user information acquisition means according to a request from said user information acquisition means.

92. The managing apparatus as claimed in claim 90, wherein said user information acquisition means acquires said user information regarding said user from said user information providing means by using permission information that permits the use of said distinction information and said user information providing means.

93. The managing apparatus providing apparatus as claimed in claim 89, further comprising set up means for setting up said subordinate user information providing means according to a request.

94. The managing apparatus as claimed in claim 89, further comprising setup screen display means for displaying a screen for setting up said merge user information providing means and said subordinate user information providing means.

95. A managing apparatus, comprising:
a merge information providing apparatus having merge user information providing means, said merge user information providing means comprising main user information providing means and sub user information providing means providing user information regarding a user and an authentication service regarding said user as subordinate user information providing means; and
setup request transmission means for transmitting information regarding set up of said subordinate user information providing means,
said merge information providing apparatus acquiring user information regarding a user registered to the user information providing means of which use is permitted and/or the authentication is made therein and the same user registered to other user information providing means, without distinguishing the user by whether or not the use of the user information providing means is permitted and/or the authentication is made, said merge information providing apparatus providing said acquired information regarding said user with merging.

96. The managing apparatus as claimed in claim 95, further comprises authentication information acquisition means for acquiring first authentication information that certifies said user in said main user information providing means from said main user information providing means.

97. The managing apparatus as claimed in claim 96, further comprising second authentication information creation means for creating second authentication information that certifies said user in said merge user information providing means and including said first authentication information, by using said first authentication information acquired in said authentication information acquisition means.

98. The managing apparatus as claimed in claim 96, further comprising second authentication information providing means for providing said second authentication information to a client requesting said authentication.

99. The managing apparatus as claimed in claim 95, further comprising set up means for setting up said subordinate user information providing means according to a request.

100. A merge user information providing method in merge user information providing means, said merge user information providing means comprising plural user information providing means providing information regarding a user as subordinate user information providing means, comprising the steps of:
acquiring information regarding a user registered to said user information providing means of which use is permitted and the same user registered to other user information providing means, without distinguishing said user by whether or not the use of said user information providing means is permitted; and
providing said acquired information regarding said user with merging.

101. A merge user information providing method in merge user information providing means, said merge user information providing means comprising plural user information providing means providing information regarding a user and an authentication service regarding said user as subordinate user information providing means, comprising the steps of:
acquiring information regarding a user registered to said user information providing means of which use is permitted and/or authentication has been made and the same user registered to other user information providing means, without distinguishing said user by whether or not the use of said user information providing means is permitted; and
providing said acquired information regarding said user with merging.

102. A merge user information providing method in merge user information providing means, said merge user information providing means comprising main user information providing means and sub user information providing means providing information regarding a user and an authentication service regarding said user as subordinate user information providing means, comprising the steps of:
acquiring information regarding a user registered to said user information providing means of which use is permitted and/or authentication has been made and the same user registered to other user information providing means, without distinguishing said user by whether or not the use of said user information providing means is permitted; and
providing said acquired information regarding said user with merging.

103. An information providing method in user information providing means, said user information providing means providing information regarding a user, comprising the step of:
providing, in response to a request from merge user information providing means, said merge user information providing means comprising said user information providing means and other user information providing means as subordinate information providing means, information regarding a user corresponding to distinction information registered to said user information providing means and/or other user information providing means for distinguishing said user to said merge user information providing means.

104. An information providing method in user information providing means, said user information providing means providing information regarding a user and an authentication service regarding said user, said method comprising the step of:
providing, in response to a request from merge user information providing means, said merge user information providing means comprising said user information providing means and other user information providing means as subordinate information providing means, information regarding a user corresponding to distinction information registered to said user information providing means and/or other user information providing means for distinguishing said user, to said merge user information providing means.

105. A managing method in merge user information providing means, said merge user information providing means comprising plural user information providing means providing information regarding a user as subordinate user information providing means, comprising the steps of:
acquiring information regarding a user registered to said user information providing means of which use is permitted and the same user registered to other user information providing means, without distinguishing said user by whether or not the use of said user information providing means is permitted;
providing said acquired information regarding said user with merging; and
transmitting a request regarding setup of said subordinate information providing means.

106. A managing method in merge user information providing means, said merge user information providing means comprising plural user information providing means providing information regarding a user and an authentication service regarding said user as subordinate user information providing means, comprising the steps of:
acquiring information regarding a user registered to said user information providing means of which use is permitted and/or authentication has been made and the same user registered to other user information providing means, without distinguishing said user by whether or not the use of said user information providing means is permitted;
providing said acquired information regarding said user with merging; and
transmitting a request regarding setup of said subordinate information providing means.

107. A managing method in merge user information providing means, said merge user information providing means comprising main user information providing means and sub user information providing means providing information regarding a user and an authentication service regarding said user as subordinate user information providing means, comprising the steps of:
acquiring information regarding a user registered to said user information providing means of which use is permitted and/or authentication has been made and the same user registered to other user information providing means, without distinguishing said user by whether or not the use of said user information providing means is permitted;
providing said acquired information regarding said user with merging; and
transmitting a request regarding setup of said subordinate information providing means.

108. A computer-implemented merge user information providing method in merge user information providing means, said merge user information providing means comprising plural user information providing means providing information regarding a user as subordinate user information providing means, comprising the steps of:
acquiring information regarding a user registered to said user information providing means of which use is permitted and the same user registered to other user information providing means, without distinguishing said user by whether or not the use of said user information providing means is permitted; and
providing said acquired information regarding said user with merging.

109. A computer-implemented merge user information providing method in merge user information providing means, said merge user information providing means comprising plural user information providing means providing information regarding a user and an authentication service regarding said user as subordinate user information providing means, comprising the steps of:
acquiring information regarding a user registered to said user information providing means of which use is permitted and/or authentication has been made and the same user registered to other user information providing means, without distinguishing said user by whether or not the use of said user information providing means is permitted; and
providing said acquired information regarding said user with merging.

110. A computer-implemented merge user information providing method in merge user information providing means, said merge user information providing means comprising main user information providing means and sub user information providing means providing information regarding a user and an authentication service regarding said user as subordinate user information providing means, comprising the steps of:
acquiring information regarding a user registered to said user information providing means of which use is permitted and/or authentication has been made and the same user registered to other user information providing means, without distinguishing said user by whether or not the use of said user information providing means is permitted; and
providing said acquired information regarding said user with merging.

111. A computer-implemented information providing method in user information providing means, said user information providing means providing information regarding a user, comprising the step of:
providing, in response to a request from merge user information providing means, said merge user information providing means comprising said user information providing means and other user information providing means as subordinate information providing means, information regarding a user corresponding to distinction information registered to said user information providing means and/or other user information providing means for distinguishing said user to said merge user information providing means.

112. A computer-implemented information providing method in user information providing means, said user information providing means providing information regarding a user and an authentication service regarding said user, said method comprising the step of:
providing, in response to a request from merge user information providing means, said merge user information providing means comprising said user information providing means and other user information providing means as subordinate information providing means, information regarding a user corresponding to distinction information registered to said user information providing means and/or other user information providing means for distinguishing said user, to said merge user information providing means.

113. A computer-implemented managing method in merge user information providing means, said merge user information providing means comprising plural user information providing means providing information regarding a user as subordinate user information providing means, comprising the steps of:
acquiring information regarding a user registered to said user information providing means of which use is permitted and the same user registered to other user information providing means, without distinguishing said user by whether or not the use of said user information providing means is permitted;
providing said acquired information regarding said user with merging; and
transmitting a request regarding setup of said subordinate information providing means.

114. A computer-implemented managing method in merge user information providing means, said merge user information providing means comprising plural user information providing means providing information regarding a user and an authentication service regarding said user as subordinate user information providing means, comprising the steps of:
acquiring information regarding a user registered to said user information providing means of which use is permitted and/or authentication has been made and the same user registered to other user information providing means, without distinguishing said user by whether or not the use of said user information providing means is permitted;
providing said acquired information regarding said user with merging; and
transmitting a request regarding setup of said subordinate information providing means.

115. A computer-implemented managing method in merge user information providing means, said merge user information providing means comprising main user information providing means and sub user information providing means providing information regarding a user and an authentication service regarding said user as subordinate user information providing means, comprising the steps of:
acquiring information regarding a user registered to said user information providing means of which use is permitted and/or authentication has been made and the same user registered to other user information providing means, without distinguishing said user by whether or not the use of said user information providing means is permitted;
providing said acquired information regarding said user with merging; and
transmitting a request regarding setup of said subordinate information providing means.

116. A processor-readable medium storing a program code for providing merge user information in merge user information providing means, said merge user information providing means comprising plural user information providing means providing information regarding a user as subordinate user information providing means, comprising the steps of:
acquiring information regarding a user registered to said user information providing means of which use is permitted and the same user registered to other user information providing means, without distinguishing said user by whether or not the use of said user information providing means is permitted; and
providing said acquired information regarding said user with merging.

117. A processor-readable medium storing program code for providing merge user information in merge user information providing means, said merge user information providing means comprising plural user information providing means providing information regarding a user and an authentication service regarding said user as subordinate user information providing means, comprising the steps of:
acquiring information regarding a user registered to said user information providing means of which use is permitted and/or authentication has been made and the same user registered to other user information providing means, without distinguishing said user by whether or not the use of said user information providing means is permitted; and
providing said acquired information regarding said user with merging.

118. A processor-readable medium for providing merge user information in merge user information providing means, said merge user information providing means comprising main user information providing means and sub user information providing means providing information regarding a user and an authentication service regarding said user as subordinate user information providing means, comprising the steps of:
acquiring information regarding a user registered to said user information providing means of which use is permitted and/or authentication has been made and the same user registered to other user information providing means, without distinguishing said user by whether or not the use of said user information providing means is permitted; and
providing said acquired information regarding said user with merging.

119. A processor-readable medium for providing information in user information providing means, said user information providing means providing information regarding a user, comprising the step of:
providing, in response to a request from merge user information providing means, said merge user information providing means comprising said user information providing means and other user information providing means as subordinate information providing means, information regarding a user corresponding to distinction information registered to said user information providing means and/or other user information providing means for distinguishing said user to said merge user information providing means.

120. A processor-readable medium storing program code for providing information in user information providing means, said user information providing means providing information regarding a user and an authentication service regarding said user, said method comprising the step of:
providing, in response to a request from merge user information providing means, said merge user information providing means comprising said user information providing means and other user information providing means as subordinate information providing means, information regarding a user corresponding to distinction information registered to said user information providing means and/or other user information providing means for distinguishing said user, to said merge user information providing means.

121. A processor-readable medium for managing in merge user information providing means, said merge user information providing means comprising plural user information providing means providing information regarding a user as subordinate user information providing means, comprising the steps of:
acquiring information regarding a user registered to said user information providing means of which use is permitted and the same user registered to other user information providing means, without distinguishing said user by whether or not the use of said user information providing means is permitted;
providing said acquired information regarding said user with merging; and
transmitting a request regarding setup of said subordinate information providing means.

122. A processor-readable medium for managing in merge user information providing means, said merge user information providing means comprising plural user information providing means providing information regarding a user and an authentication service regarding said user as subordinate user information providing means, comprising the steps of:
acquiring information regarding a user registered to said user information providing means of which use is permitted and/or authentication has been made and the same user registered to other user information providing means, without distinguishing said user by whether or not the use of said user information providing means is permitted;
providing said acquired information regarding said user with merging; and
transmitting a request regarding setup of said subordinate information providing means.

123. A processor-readable medium for managing method merge user information providing means, said merge user information providing means comprising main user information providing means and sub user information providing means providing information regarding a user and an authentication service regarding said user as subordinate user information providing means, comprising the steps of:
acquiring information regarding a user registered to said user information providing means of which use is permitted and/or authentication has been made and the same user registered to other user information providing means, without distinguishing said user by whether or not the use of said user information providing means is permitted;
providing said acquired information regarding said user with merging; and
transmitting a request regarding setup of said subordinate information providing means.
